(19) United States
(12) Patent Application Publication
(10) Pub. No.: US 2024/0233187 A1
(43) Pub. Date: Jul. 11, 2024

(54) Color Calibration Systems and Pipelines for Digital Images

(71) Applicants: Nicholas R Spiker, Seattle, WA (US); Alexander Gaura, Highland Lakes (WA); Brennen Duran, Sun City, AZ (US); Kal Karel Lambert, Hammond, OR (US); Dominique Zosso, Bozeman, MT (US); Roxana B. Bujack, Los Alamos, NM (US)

(72) Inventors: Nicholas R Spiker, Seattle, WA (US); Alexander Gaura, Highland Lakes (WA); Brennen Duran, Sun City, AZ (US); Kal Karel Lambert, Hammond, OR (US); Dominique Zosso, Bozeman, MT (US); Roxana B. Bujack, Los Alamos, NM (US)

(73) Assignee: Sun's Arrow Research, Inc., Hammond, OR (US)

(21) Appl. No.: 18/529,862

(22) Filed: Dec. 5, 2023

Related U.S. Application Data
(63) Continuation-in-part of application No. 17/581,976, filed on Jan. 23, 2022, now Pat. No. 11,893,758.
(63) Continuation-in-part of application No. 17/968,771, filed on Oct. 18, 2022.
(60) Provisional application No. 63/256,995, filed on Oct. 18, 2021.
(60) Provisional application No. 63/606,066, filed on Dec. 4, 2023.
(60) Provisional application No. 63/460,004, filed on Apr. 17, 2023.

(51) Int. Cl. G06T 7/90; G01J 3/42; G06T 7/80; G06T 11/00; H04N 17/00; H04N 17/02; H04N 23/10; H04N 23/84

(52) U.S. Cl. CPC G06T 7/90; G01J 3/42; G06T 7/80; G06T 11/001; H04N 17/002; H04N 17/02; H04N 23/10; H04N 23/84; G06T 2200/24; G06T 2207/10036; G06T 2207/20081; G06T 2207/30088; G06T 2207/30252; G06T 2210/04

(57) ABSTRACT

Spectral color remastering systems for color and value management in digital optical devices, including cameras and displays. The systems incorporate a spectral color reference target device with reflective color patches and a database of factory spectral scans unique to each reference target patch. The colored patches are arranged in a pattern on a surface visible to the optical device. The system is equipped with automated instructions for locating the patches, analyzing the color and tone of each patch, and for calculating a “relative color profile” specific to the ambient illumination. The reference target device may also include emissive color patches for making an “absolute color profile”. The systems are supplied with executable machine-readable software and/or firmware that may be implemented in the optical device, in the color reference target device, in a cloud assistant, in a smartphone configured to be compatible with other system elements, or as distributed instruction sets in the elements of the systems. The systems automatically receive a digital image of the color reference target device captured and sent by the optical device, locate the reference target within the received digital image, record the digital image channel values for each color patch, and compare those values with the colors in the reference database before generating an relative and absolute color profile unique to the optical device. A key feature of the systems is the capacity to capture a full spectrum as a spectral power distribution (SPD) or to fit a spectral color profile using either of a smoothing regularization and upsampling, optionally augmented by AI-driven upsampling. This capability enhances the accuracy of scene relighting and color matching. In other embodiments, the systems are configured to calculate changes from one type of illumination to another, from one camera to another, or from one time to another, as is useful in a wide range of photographic, cinematographic, and engineering applications. The systems also may include wireless links and tools for remastering color on contoured shaded surfaces, as is useful to impart a more accurate 3D appearance to digital images (broadly including video clips and motion pictures).

### CROSS-REFERENCE TO RELATED APPLICATIONS

This application is a continuation-in-part of U.S. patent application Ser. No. 17/581,976, filed 23 Jan. 2022, now U.S. Pat. No. ______.

This application is a continuation-in-part of U.S. patent application Ser. No. 17/968,771, filed 18 Oct. 2022, and which claims priority under 37 USC § 112(e) to U.S. Prov. Pat. No. 63/256,995, filed Oct. 18, 2021.

This application further claims priority under 37 USC § 112(e) to U.S. Prov. Pat. No. 63/460,004, filed 17 Apr. 2023, and to U.S. Prov. Pat. No. 63/606,066, filed 4 Dec. 2023.

All said related applications are incorporated by reference herein in entirety for all purposes.

### FIELD OF THE DISCLOSURE

The present disclosure generally relates to capture, transmission and display of digital color imagery. More specifically, the present disclosure relates to tools and systems for color remastering of images and for using color and tonal information for augmented reality sensing as for controlling machinery and for synesthesia.

### BACKGROUND

Literature references cited in this filing are abbreviated by first author's name in capital letters followed by an underscore, followed by a year of publication, and may be retrieved as a full citation from the information disclosure document (IDS) that accompanies this filing.

Color management, remastering and remastering are interlocked processes for managing digital image capture and display across a wide range of use cases. For example, virtually all consumer products have color in printed, painted or plastic parts and rely on some sort of reproducible color management for consumer branding in manufacturing. House painting is a well established industry in which color management has long relied on swatch samples to achieve customer satisfaction. The transition to digital mastering of color has been problematic, for example Pantone was unable to transfer its color catalog of patches to digitally defined color coordinants simply because the limited digital color space available in the most widely used digital color scheme (sRGB) contains only about 35% of the colors detectable by the human eye.

Color is often also a cue to depth perception and material identification, and thus has a profound effect on cognition and learning. The psychobiology of color is revealing: the optic nerve connects first to the limbic system at the lateral geniculate nucleus, which is associated with the thalamus, hypothalamus and amygdala, before entering the visual cortex. Outputs from the visual cortex are returned directly to the cortical structures associated with raw emotions such as fight or flight. This is a well-established neural pathway and is discussed in HANSEN_2006 and HURLBERT 2005 with more recent updates such as ALBERS_2022 (preprint), WEDGE-ROBERTS_2022, and CONWAY 2023.

Color grading is another use case. In the entertainment industry, films are typically produced with multiple cameras, and colors and lighting are manually graded in separately spliced clips or shots so as to have a uniform continuity of “look”. In other examples, products such as televisions compete based on their capacity to display evocative color and radiance. Color is also important in scientific research, such as earth and celestial sciences, and thus color information can be defined broadly as including “multispectral,” “hyperspectral” and “impossible” domains, as well as the smaller visual color domain familiar to the human eye.

Machine vision and rendering also have unsolved problems, including clipping, noise, flicker, banding, twinkle, depth of field, metamerism, vignetting, and color-adulteration, for example, only some of which can be addressed by use of adjustable apertures, refinements in sensor technology, circular polarization, pattern retarders, new generations of display monitors, and improvements as are still needed in machine interfaces. While Artificial Intelligence has advanced in the last year from LLM to a more comprehensive approach to AGI that addresses perceptual data generally, including color and vision, the basic problems of remastering and remastering have been addressed only in the conventional colorspace of RGB and XYZ. This raises a long term question as to whether individuals exposed only to color screens and not to nature and direct social interaction will have the same behavioral responses as humans raised in a rural environment.

Another basic problem of interest is the opportunity to merge machine vision and human vision, which have overlapping and non-overlapping capabilities. “Augmented Reality” is a hybrid of “Virtual Reality” and the “Ground Truth Reality” that we sense around us. Machine vision capabilities can complement human vision. Human vision is remarkable for its illusions: the “Retinex Theory” first posited by Land in 1971, the “Checker Shadow” illusion, chromatic adaptation, chromatic induction, spreading effects, the “dress illusion”, the “Fechner Color Effect”, afterimages, rod and cone saturation, and the evidence that much of each visual field is not recognized point by point like a bitmap, but is instead constructed en masse, like a controlled hallucination, from a few bits of visual data that are tagged as interesting based on a person's experience, much in the same way that Gaussian splat is used to fill in a point scaffold. Non-linear color model discrepancies in human vision have been demonstrated in a recent paper by BUJACK_2022, for example and color scientists consistently outscore lay persons in differentiating color. Unlike machine vision, color to the human eye is experience-based and is highly subjective.

As currently practiced, color management systems for displaying colors and value rely on a digital color standard established in 1931 by the Commission Internationale de l′éclairage (International Commission on Illumination), known as the CIE 1931 standard, as updated in 1996 by Microsoft to limit the number of colors that can be emitted at a pixel by reducing all displayable video color to mixtures three primaries termed the “RGB cube”. Numerous automated systems have been developed to calibrate “tristimulus” display devices to the CIE 1931 standard and to Microsoft's sRGB gamut (STOKES_1996). A remastering process is either accomplished using a spectrophotometer and a software package programmed to generate a profile electronically, or by using known LUT values that are “close enough” to the target in mind, but color itself has been redefined. The need to adjust color output from raw machine sensors to a human visual space that is electronically displayable requires significant distortions of the incident spectral power distribution as captured by the camera, as has been discussed in a body of literature such as KIRK 2022.

In the case of cameras, the remastering process may involve taking a photograph of a known target color, manually measuring color patches and comparing them to a reference set, and developing a profile, generally a 3×3 matrix, that remasters the color mathematically and electronically. Current systems do not exist to provide an end-to-end automated system for calibrating optical devices that can remaster color, depth, and contoured shading in real time as lighting conditions shift.

In addition, the reference color sets currently in use are limited to color intensities below 250 nits, whereas newer displays and sensors are capable of displaying and measuring color intensities of up to or beyond 2000 nits. Current relative color reference profiles make no attempt to routinely standardize the absolute color output or sensitivity of the optical devices and displays. It has been pointed out that the human eye is relatively unresponsive to color differences above 800 nits, but this is based on an RGB cube model that compresses color to a whitepoint at a first vertex of the RGB cube and to a blackpoint at a second vertex of the cube, and hence may be invalid. Other models treat luminance as a dependent variable. overlooking its primary role in establishing mood by emphasizing chromaticity.

Relative color reference profiles are typically recorded as chromaticity coordinants, a set of comma separated numbers that convey the amounts of three primary parameters to be used to generate a likeness of the scene-referred color. This is flatly unacceptable for a list of reasons and discards the bulk of the color data that the optical device is capable of recording. Luminance is often compressed, for example by summing Bayer green mosaic outputs (U.S. Pat. No. 9,025,896 and US. Pat. Appl. No 20230254593). There has been a fear that the volume and bandwidth of data needed for spectral power distribution (SPD) will overwhelm the computing power and memory resources of optical devices, but this perceived limitation is on track to be obsolete. The limits of the RGB colorspace are readily exploded by the tools and systems disclosed here. In fact, color science is has been impeded by U.S. Pat. No. 9,230,299, a heavily litigated case that teaches green compression in a process that mimics the JPEG Y′RbCr decorrelation as limiting color to the RGB cube, not a true lossless compression.

Advances in user interface tools also provide increasing flexibility in color remastering, allowing greater creative license. This is especially true with the advent of AGI. The power of these tools have been limited by the poor color depth and luminance data exported from current optical devices and displayable on current color monitors. During the past two decades, monitor radiance has increased ten-fold, with no corresponding improvements in color fidelity because color LED screens (and sensors) have not moved from RGB.

Therefore, what is needed are color remastering tools, devices and systems that provide an end-to-end integrated system for standardizing and expanding the capabilities of optical devices and displays without the limitations of existing techniques. This is especially true for SPD data. A containerized *.VSF format has the potential to displace RGB as the commercial standard. These disruptive technologies are targeted to a range of human and machine visual systems including all forms of visual communication, scientific investigation, cultural appreciation, and virtual and augmented reality, including applications in treatment of depression, hyperactivity and anxiety.

### SUMMARY

A smart color standardization system, kit and devices for use with digital images, image software and/or firmware, and a pigment-based or color-based database that includes a color target “tool” as part of a “direct scene referred” color and luminance mastering approach. The color reference target device may be provided with a series of what are termed “pigment patches”, but may also include active emission surfaces such as generated by diffuse LED or electrochromic lighting at one or more intensities. The pigment patches may include the brightest spectral neutral whites relevant to the medium (print or display) and the darkest possible black. Image radiance and luminance are calibrated and remastered in a single step. This defines the “dynamic range” or “tone curve” of the image capture system and display, and presages ongoing improvements in high dynamic range (HDR) image capture and display. The pigment patches may include a 50% reflectance patch and a standard grey LAB space patch (i.e., 18% reflectance), but also colored and white emitters (having radiance measured in nits, W/m² or cd/m²) having ranges from 300 to 3000 or 10000 candelas/m², what would be termed “glare” if the light is white. A roughly equivalent range is 20 to 2500 nits for the best currently available OLED displays.

In embodiments of a remastering kit and system, the color target may also include a fluorescent indicator for determining the amount of UV light in a scene, which is readable via the software, and an infrared indicator for determining the level of infrared contamination, which is readable via the software. This information substitutes for or supplements readings taken with a spectrophotometer.

Also useful is a color patch termed here a “fugitive indicator”, as is sensitive to UV degradation, weathering and other damage that limits the useful life of the entire color target. The fugitive indicator patch changes color when exposed to excessive UV light, chemicals, and/or temperatures, in order to provide an indication of the current degradation state of the other patches on the reference target device and allows the software to calculate a color shift in the other color patches for additional color accuracy over the target lifetime. The fugitive indicator is readable via software provided with the remastering kit. Similarly, it will be understand that use of electrochromic patches may require a strategy to detect aging of the redox dyes.

Preferably, spectral neutral white and black patches are arranged in the center and at the corners of the color target for software vignette correction. There may be both temporal and spatial protocols for presenting sample patches to a camera for remastering and calculation of device color profiles.

In yet other implementations, the color target may also include pigment patches configured to reveal visual metamerismic lighting conditions. These split pigment patches may be used to provide a photographer a quick human eye visual indication of the characteristics of current lighting conditions without the need for any electronic equipment. Split pigment patches also allow a user to quickly assess the level of deviation from the standard observer color model (known as a Luther-Ives condition) by comparing how the split patches appear with the naked eye.

In other implementations, a simple white balance uses the fifty percent reflectance patch, but can be supplemented by radiant patches for extended remastering of dynamic range. The color target may also include a LAB 50 (18% reflectance) patch for establishing an exposure value readout (as commonly requested in industry).

Illumination results in a change of color captured by the camera. Switching camerasd, optical filters, and other optical front end modifications are detected in the standardization process. The pigment patches are configured to be read by machine vision in order to perform functions on digital data from the image, thereby standardizing and optionally remastering the color of the image prior to downstream grading and color adjustment for subsequent printing or display. What is true of still photography is equally applicable to cinematography, in which image streams are created and displayed using video processes.

Manufacturing conditions for the color target tools are engineered for color fidelity, traceability and durability. The color target tool substrate may comprise a rigid black material with paint adhesion properties. To achieve paint adhesion, the color target tool may include a sanded, roughened surface, and an adhesion promoter. In one implementation, the pigment patches are arranged in a grid pattern. An anti-reflective (AR) coating is typically applied. To further protect the color target tool, it may also include a protective coat. For accurate viewing in different light angles, the color target tool may have a non-reflective matte finish. Because each color target tool is scanned individually and tracked by a serial number, some lot to lot variation is acceptable and is compensated for during post manufacture remastering.

Several species of color targets are described here. The first uses a hard backing with reflective patches, the second uses a housing with internal electronics. The electronics provide for incorporation of a spectrophotometer, a radio, a processor, and multiple emissive color targets, for example. Labelling allows the user to access detailed information about the electronic color target from a cloud host or laptop, and a network that includes the user, the camera, the cloud, and a display device is described, for example. These networks may also include smartphones and computing devices such as laptops, for example. Where the color target tool is an electronic device, the internal circuits are subject to quality control inspection and may include failsafe (also termed “watchdog”) circuitry that periodically verifies performance. Systems that use color targets and electronic remastering circuitry are also subject to quality control in manufacture and assessment of field performance.

Investigation of color target form factors have yielded new use cases. A wearable color target has been developed. An invisible color target has been developed. An interactive color target has been developed. A machine-to-machine interface for system color and value remastering has been realized. The device as currently described displays limited use of robotics, but in future embodiments, includes a capacity to reposition itself so as to be most accurate and to function as an intermediary between one or more system components. Unlike the AI chips in newer televisions and smartphone, the data provided here is calibrated and traceable data. By embedding the remastering transforms with the raw image, a lossless process is achieved.

Innovatively, shadowing of colored contours is calibrated, as has been overlooked in the construction of machine training models for color and value remastering. The geometry of the color target has evolved from a flat plate with flat matte color reference patches to a contoured surface of defined 3D geometry so that the play of light across a colored surface teaches the visual processor units (VPUs) about how color and shading interrelate, how color gradations provide depth information, and how to model surface rendering when color and light interact with 3D solids. Transparency has also been addressed in selected use cases. The AI interpretations are more convincing and accurate than raytracing alone.

The color target tools are constructed of a durable material to extend the life of the target beyond conventional color target lifetimes—as enables use in extreme environments such as underwater filming or space exploration. With a capacity to extend to HDR remastering, a whole new range of color remastering target tool applications is enabled.

Preferably, color target tools further includes indicia mapping the color target to a database of patch information so that automated machine vision and remastering regimens are executable on command. “Walk-up” remastering of cameras to monitors is described. Remastering is no longer a process applied to individual components of a digital image management system, but instead is a system function applied as a unitary process across devices and networks. A record of each color target and accompanying standard remastering data (a “certificate”) is accessible using cloud services. Devices that are co-calibrated retain their shared remastering in a digital library that may be activated when the devices are in proximity, for example when a camera is near a monitor (as may be detected by BT or Wi-Fi radio). In various implementations, the identifying indicia may be a computer readable optical code, such as a barcode, QR code, or round code. But radio identifiers may also be employed for simplicity and “hands-free” directness. This addresses the problem of back legacy compatibility of newer equipment: older monitors may require individual profiles that would not be suitable for newer monitors. Because devices have IP addresses and Radio Unit identifiers, lookup of the right remastering ODT for a monitor is a near instantaneous process. Precise mapping of the color target surface patches allows the system to map each patch to a reference database. In addition to FFT bullseyes as “fiducials” or “registration indicia”, as we demonstrated in U.S. Ser. No. 17/581,976, now U.S. Pat. No. ______, the color target tool preferably includes fine alignment marks that can be visually highlighted using Gaussian image scanning so as to precisely map the exposed surface and orientation of the color patches. The fine alignment marks are arranged in a white-red-green-blue diamond pattern and may be positioned between the pigment patches to aid in orientation discovery and to detect distortion (distortion such as when used with fisheye, cylindrical, or hemispherical lenses). This analysis and mapping is provided in software or firmware in the camera or in an accessory computing device used for image analysis following capture of the color target image. In another embodiment, a close array of fine alignment marks may be applied. Radio equivalents of alignment indicia may also be used, including range finding. LIDAR, MIMO, and time-of-flight indicia, for example. Local fine mapping using UWB transceivers is demonstrated over ten meters to have sufficient precision to map out the color target array presented to the camera, and can be used to provide an annotated image for expedient processing after image capture.

Multi-exposure mapping of 3D space is becoming increasingly popular and important in techniques such as NERF and Gaussian Splat. The precision of these techniques, which may rely on time-of-flight (TOF) of reflected light or LIDAR, demonstrates that precise localization of color target patches is achievable with or without fine alignment mapping if the appropriate software is available in the camera or in a host computing device.

As generally operated, software or firmware as part of a color management system consists of processor-executable instructions that are configured to capture, read and parse a digital image from a digital negative. The bullseye fiducials are detected by Fast Fourier Transform (FFT) on data from the image, are read as a spiral having the same geometric frequency as the bullseye indicia and are padded to match the dimensions of the image. The FFT amplifies the frequency domain of the bullseye so that it can be precisely mapped on the image, identifying and localizing the reference target device and color patches in the image. The software is configured to establish areas where the bullseye indicia are located on the image and to rough in the location of the color remastering information, including color patches but also any QR codes or other identifying labelling. The software is also preferably configured to filter noise and dot size to produce sharp visible spots used for initial crop and transformation of the image so as to isolate the target tool outline and layout from the image background.

Where variable luminance greyscale emissive patches are used in combination with reflective greyscale patches, a dynamic range or tone curve may be constructed. In some instances, this information is critical to de-log the digital image received from the camera. Log compression has become commonplace in the industry, but de-logging is a needed step to perform proper color remastering.

The processor-executable instructions are also preferably configured to read indicia identifying the specific color target “serial number” so as to access a specific device profile based on reference data specific to that particular color target. In various implementations, a code, such as Aztec code, Round Code, Bar Code, QR Code, etc. may be used for optical identification marking. Aztec codes are compact, reliable, and in the public domain. The code may be used as a key for higher level encryption as well. Radio indentification codes may also be used.

In one alternative implementation, the smart digital color remastering system may comprise a color target tool and a camera. The color target tool is a color target with a plurality of unique colored patches arranged in such a way that they can be read out easily by accompanying image software installable on a local device such as a camera, smartphone, laptop, or accessible remotely via a cloud assistant. On the face of the color target, an optical identification marking may be provided along with the color patches, enabling a computer having access to the image and a compatible instruction set to identify and differentiate each specific color target individually, and to assess color fidelity and lighting by comparing factory reference color information with the color information collected on site (from a current image of the color target). A digital database of color reference data recorded under standardized lighting conditions is compared with patch colors as captured under ambient local lighting. Shifts in the apparent color will be noted that correlate with the scene illumination. The color profile generated by the system takes account of the differences (4E) in color of the reference color target patches versus the observed patch colors under local “ambient” conditions to solve for (a) the sensitivity of the camera device sensor to different parts of the light spectrum, (b) the shape and intensity of the spectral power distribution of incident light on scene, and (c) any anapochromaticity of the optical system used to capture or render the image for processing. For best results, these steps must occur while the digital image is in a RAW form as output by the camera color sensor. Data obtained after extensive post-capture processing may not contain sufficient information to reconstruct the lighting conditions at the time the image was captured.

To read a color target tool, an alignment algorithm is provided in the machine vision package of instructions, such that the captured image of a specific color target can be recognized, the patch locations parsed, and consensus color values for each colored patch recorded from the image. Ideally, values of each individual colored patch are read by the system as output in RAW form from the color sensors of the optical device. Some optical devices have three basic sensors for red, green and blue, other devices include a sensor for yellow (RYGB), and yet other devices have five, nine or sixteen independent sensors configured to collect different parts of the illuminant spectrum. We term these camera sensor outputs as “channels” and their sensitivities must be calibrated for accurate color rendering. To achieve this, the system is configured to compare the observed color of a particular color target to the known factory color values and generate a “matrix transform function” termed a “input device profile” (IDT). The profile is a matrix transform and an associated “color fit” algorithm or profile connection space (PCS) is generated to convert from a device-native RAW output under existing scene lighting conditions to a standardized lighting condition corresponding to the lighting used when the factory reference color patch data was collected. All data is kept unaltered and the PCS and IDT are stored as metadata with the RAW image file, such as by containerizing the digital image data. Advantageously, by this method step, color grading and editing in post-production can be performed scientifically and reproducibly regardless of the camera equipment used or the local lighting conditions. Advantageously, the IDT profile and PCS are valid for any image subsequently captured under the same conditions by the same optical device. Color and value data are not lost or flattened in this process. As currently practiced, each raw image or stream of images is packaged with the calculated color management data as metadata. As introduced here, a file format is created, termed the *.VSF format, that is containerized, and contains the raw bitmap, an IDT, identifying information such as place time, user, camera, and user annotations, and optionally includes active PCS content for color management in post-processing.

Compression is also provided. Bit depth of color is generally greater than 8-bit word for three channels RGB or RYB, but added color fidelity is achieved with a luminance byte and a transparency byte, optionally including some hyperchromic spectral power data. Compression by matrix transform is stored with the file so that it can be reversed if needed.

In more complex digital color remastering systems, multiple devices are linked to a network having digital image resources. The network may include radio or optical communication channels. The devices combine to generate IDT profiles relative to a scene and may store the IDT and a PCS with a digital file of the image in a container that is forwarded for post-processing or for archiving. The devices may contain machine-to-machine image interfaces and may interact with a cloud component or a local SoC (system on a chip) that includes a VPU or GPU with gaussian splat technology for dressing 3D scaffolds with color, intensity, transparency and opacity for rendering life-like images, for example. The system may be configured to re-light all or a selected part of the image in a new illuminant or to render all or a part of the image with a substitute observer (sensor sensitivity). Cutouts for composite image assembly with optional transparency are fully developed post-process functions and work with both still images and video clips. RISC, ARM and x86 instruction sets are programmed in Python, Rust, OpenCV, JVM, Julia, Lua, Pytorch, C++ and ProLog, for example, without limitation thereto.

The improved color, value encoding systems and tools for digital images are an advance in the art. Current standards are so obsolete relative to the newer technologies that errors result when stored data is accessed. An industry standard is best judged by its elegance as a coding tool, and the standards proposed here meets those requirements.

Surprisingly, the code allows the user to see the image without need for machine execution. Another criterion of success is lossless capture, efficient compression and transfer of data, where existing standards fare poorly and surrender a great deal of lost color information. And finally, colorspaces as currently captured in existing image formats are limited in definition and capabilities, as has led to widespread color profile misunderstandings and misuse. Color that is converted to RGB is compressed, whether admitted or not. The lost color information in existing archived image data such as JPEG can never be recovered, but some efforts to re-imagine that lost information can be scientifically guided using the principles and mathematics we have developed. The need for an improved seamlessly upgradeable open file standard for digital storage of image formatting is at a critical point in its history. This new standard paves the way to a clean “future-proof” and robust digital image storage format over visible and hyperspectral spectral domains.

The elements, features, steps, and advantages of the invention will be more readily understood upon consideration of the following detailed description of the invention, taken in conjunction with the accompanying drawings, in which presently preferred embodiments of the invention are illustrated by way of example.

It is to be expressly understood, however, that the drawings are for illustration and description only and are not intended as a definition of the limits of the invention. The various elements, features, steps, and combinations thereof that characterize aspects of the invention are pointed out with particularity in the claims annexed to and forming part of this disclosure. The invention does not necessarily reside in any one of these aspects taken alone, but rather in the invention taken as a whole.

### BRIEF DESCRIPTION OF THE DRAWINGS

The patent or application file contains at least one drawing executed in color. Copies of this patent or patent application publication with color drawing(s) will be provided by the Office upon request and upon payment of the necessary fee.

The teachings of the present invention are more readily understood by considering the drawings, in which:

FIG. 1A is a geodesic map 1 of a color cloud that corresponds generally to the limits of human visual capability and encloses a smaller machine colorspace that establishes the limits of what colors optical devices can display. As can be seen, only about 35% of the colors perceptible by the human eye can be mapped to the RGB colorspace.

FIG. 1B is a map of the LMS colorspace 3 in two dimensions. Whereas the sRGB primaries can generate about 35% of the color gamut of the human perceptual color capacity, as shown, six primaries stimulate about 95% of our trichromatic color gamut.

FIG. 2 is a two-dimensional map of the CIE 1931 color system showing the human visual color space with the updated 2006 2° Standard Observer. It shows a slice through the color cloud of FIG. 1 corresponding to the sRGB cube 6.

FIG. 3 is a linear equation 1 that derives a numerical expression for a color from the inherent reflectivity of a surface (R, “reflectant”), the spectral power function of the incident light (I, “illuminant”), and a spectral sensitivity weighting (S). The combination of radiant and emitted light from a surface (L, luminance) incorporates not only the chromaticity of the light, but also the power of each fraction of the exitant spectrum from a surface.

FIG. 4 illustrates a durable color reference target device 40 as part of a color remastering system.

FIGS. 5A and 5B illustrates an exemplary QR code patch 50a and a “round code” 50b as codes for computer optical identification of individual color target tools.

FIG. 6 illustrates another view of color target 40, where selected pigment patches are identified according to their individual properties.

FIG. 7 illustrates a color target tool 40 in a context of use.

FIG. 8A demonstrates the automation of initial steps of the color remastering process. FIG. 8B is an image of an FFT process intermediate.

In FIG. 9A, continued automated processing is illustrated. FIG. 9B shows an initial transformation applied to registration marks on the color target.

FIG. 10 illustrates a distortion map created using pixel shifts and channel mixing of the pigment fine alignment markings 45 of the color target tool. This is sufficient to track the patches of the color array and to sample colors needed for remastering.

FIG. 11 illustrates a distortion polynomial and shows how the remastering target overcomes the distortion using fine alignment markings 45t.

FIG. 12 illustrates the color sampling process for color target tool 1200.

FIG. 13A is a schematic representation of the principal components of light as emitted by a radiant light source, as reflected from a color target tool, and as enters a machine vision optical device with color sensor. In FIG. 13B, a human eye is substituted for the camera optics and the electronic sensor of machine vision.

FIG. 14 shows a set of spectral curves 1400 for four standard light sources as defined by International Authorities and superimposes on those curves the limited spectral window (dark solid line 1401) that defines the window of sensitivity that the human eye is capable of interpreting as color.

FIGS. 15A and 15B demonstrate the contrast in information density between Cartesian coordinates of a colorspace (FIG. 15A) and spectral power distributions (SPDs, FIG. 15B).

FIG. 16 offers an innovation 1600 that unlocks the potential of spectral data. The ‘electronic color target’ 1601 is transformed into an digital processing center capable of generating emissive colors (as needed for today's brighter screens), capable of transmitting data by radio (given the difficulties of wired connections), and communicating with the cloud 1000 and sharing all the resources of the cloud. The smart color target includes reflective color targets 1602 (as an array) and emissive color targets 1604 (dashed line), enabling both relative and absolute calibrations over the visible spectrum and up to radiant intensities of 2000 nits (FIG. 41) as currently practiced, or higher.

FIG. 17 is a block diagram of a system and circuitry 1700 incorporating a smart color target device 1601 with communications and computing capability for color calibratioh and remastering of digital images in combination with a camera 1715 and cloud host 1000.

FIG. 18A is a block diagram of a color remastering system. The color target (FIG. 18B, 1601) is termed here a “Type K” color target array because it has both reflective color targets and emissive color targets (emission targets).

Shown in FIGS. 19A and 19B are radio accessories with Wi-Fi rabbit ears for forming a local area network (LAN) with the camera 1715.

FIG. 20 is a block diagram of a wireless system 2000 for distributing image files through a network.

FIG. 21 is an exemplary color target device 2100 with multiple patches 2101 disposed on an exterior surface of a housing.

FIG. 22 is a view of a composite system 2200 of another embodiment, in which camera 1670 comprises a color sensor 1670s configured to output RAW images 2224 to a smart color target 2250.

FIG. 23 is a view of another system or apparatus 2300 that encapsulates a cloud assistant component 1001 as described in U.S. Prov. Pat. Appl. Ser. No. 63/460,004, titled “Color Transform, Methods, Apparatus and Systems”, which is incorporated in full by reference for all that it teaches.

FIG. 24 is a more detailed workflow or “pipeline” 2400 showing image processing using the hardware and code blocks that support Eq. (1). This exemplary image processing sequence is generally automated by the system according to logic in firmware or software.

FIG. 25 is an exploded view of a simple “pendant” 2500 that can be pinned on an actor's pocket or lapel, inconspicuously mounted against the background of a scene. The device is also useful in calibrating luminous radiance, the tricky secondary illumination that causes the reflected glow of one object to light up the back of another object.

FIG. 26A shows a fully assembled pendant 2500 in partial perspective view.

FIG. 26B shows that the contoured surface of chrome ball 2580 is helpful in identifying specular reflective sources, while substituting a white ball provides a soft contour for assessing shadows and highlights. Flesh toned balls may be made to order, and provide guidance in assessing lighting angles and even makeup.

FIG. 26C is an alternate perspective view of the pendant 2500, demonstrating that the light follows the motion of the pendant.

FIG. 26D is an underside view and shows the pocket clip 2596 and the battery case lid 2597.

FIGS. 26E and 26F are front and back views of the pendant.

FIG. 27 is another view of pendant 2500, but at an oblique side angle so as to expose the ray trace patterns of the LED emissions against a white ball or mirror ball 2580.

FIGS. 28A and 28B describe two basic classes of electrochromic devices 2810 and 2820.

FIG. 29 presents another form factor for a pendant 2900.

FIG. 30 is a view of a color target device having a disk-shaped body with center handle. Reflective color patches are arrayed as a “color wheel” around the disk. The device may include a scanning spectrophotometer and radio to help detect incident light quality and spectral power distribution profile.

FIGS. 31A and 31B are other embodiments of an electronic color target wheel 3100 and are designed for sophisticated color management of colored shading and contours. FIG. 31B shows the center dome removed and a handhold 3122 in the center of the wheel.

FIGS. 32A through 32B show a simple tablet with internal electronics for use as a color target and color management device. FIG. 32B shows the reverse side of the color target, which includes an OLED monitor 3250 enabled to display photographs or video taken by a remote camera.

FIGS. 33A and 33B are perspective and elevation views of a color target device with hinged cover.

FIGS. 34A, 34B, 34C and 34D add another innovation in color target tablets 3400. In addition to the emissive color patches 3432, each of the reflective “patches” 3431 is modified as a spheric so that R(λ) and I(λ) are dynamic for luminosity.

FIG. 35A is plan view of a machine vision device 3500 with hexagonal body 3501. FIG. 35B shows two paired HDMI ports 3511, 3512 and a single USB-C port 3513. FIG. 35C is an exploded view of the clamshell construction. FIG. 35D is a perspective view of the full assembly. FIGS. 35E and 35F open the housing shell 3501 more fully to show details of assembly.

FIG. 36 is a detail view of an OEM spectrophotometer 3510 that plugs into the circuit board and includes a lens that extends through the top cover.

FIGS. 37A, 37B and 37C are a more detailed look at the diffuser box circuits 3550.

Per FIGS. 38A and 38B, miniature OLED screens are used to generate a diffuse light for the emissive color targets.

FIG. 39 demonstrates that luminance and emissive linearity is achieved from 20 nits to 2000 nits or more.

FIG. 40 is a schematic of an electronic color target device 4000 with quality VPU or CPU 4001 and supporting device hardware and circuitry.

FIG. 41 is another block diagram that shows a system 4100 with color target 4101, a plurality of cameras, and a cloud host. Smart target device circuitry 4102 is described in functional blocks of an image transform workflow plus the hardware useful to receive raw data and output color remastered images. This essentially is an exercise of Eq. 1 using the SPD as IR(λ) and the camera or LMS sensitivity as S(λ).

FIG. 42 is a first view of a wireless system for distributing image files through a network, the network having computing resources for performing radiographic remastering on image data received from one or more cameras. Device 4201 is termed a “networking accessory” device or apparatus and is both a hub and a color target or image management device. Related devices disclosed in this paper are 1601, 3000, 3100, 3200, 3300, 3400, 3500, 4000, 4101 and 4201, for example. By packaging the electronics for file and container communications functions and some color process functions in the networking accessory device, the device can serve multiple cameras, and can also participate in cloud-sourcing of image transform functions and remastering.

FIG. 43 is an alternate view of a wireless system 4300 in which a radio adaptor 4301 is included to enable cameras 4310 not equipped with radio transceivers to send and receive image-related data.

FIG. 44 illustrates that a color target hub (e.g., 1601, 3200, 3300) may operate cooperatively with a mobile hotspot such as a smartphone 999, 4410 in delivering images to the cloud 1000 and receiving back matrix expressions, commands, and color profiled images as coordinated cloud host. The cloud host or mobile hotspot may supply a user interface, or the color target/remastering hub may supply the user interface. Information may be transmitted in the form of glyphoptic code or radio signal.

The drawing figures are not necessarily to scale. Certain features or components herein may be shown in somewhat schematic form and some details of conventional elements may not be shown in the interest of clarity, explanation, and conciseness. The drawing figures and any text thereon are hereby made part of the specification, written description and teachings disclosed herein.

### Glossary

Unless otherwise defined, all technical and scientific terms used herein have the same meaning as commonly understood by one of ordinary skill in the art to which this invention belongs.

Certain terms are used throughout the following description to refer to particular features, steps or components, and are used as terms of description and not of limitation. As one skilled in the art will appreciate, different persons may refer to the same feature, step or component by different names. Components, steps or features that differ in name but not in structure, function or action are considered equivalent and not distinguishable, and may be substituted herein without departure from the invention. Certain meanings are defined here as intended by the inventors, i.e., they are intrinsic meanings. Other words and phrases used herein take their meaning as consistent with usage as would be apparent to one skilled in the relevant arts. The following definitions supplement those set forth elsewhere in this specification.

In case of a conflict of meanings, the present specification, including definitions, will control.

A “spectral power distribution” (SPD) describes the power of light per unit area per unit wavelength of an illumination (radiant exitance), or more generally, the per-wavelength contribution to any radiometric quantity (radiant energy, radiant flux, radiant intensity, radiance, irradiance, or luminosity).

Use of Spectral Power Distribution (SPD) in Calculations is described as follows: The integration of Spectral Power Distribution (SPD) information into calculations, whether for Input Device Transform/Output Device Transform (IDT/ODT) or illuminants, significantly enhances accuracy and fidelity in the imaging pipeline. SPD data for illuminants provide detailed insights into light emissions at each wavelength. In the case of absolute IDTs, SPD data describes the specific wavelength responses of the optical device, offering an in-depth profile of both the light source's color characteristics and the optical device's spectral response. For relative IDTs, the approach involves recording the SPD responses of both the illuminant and the optical device. This thorough incorporation of spectral data ensures a more accurate and faithful representation of colors, as perceived and captured by the imaging system. Furthermore, it facilitates the accurate capture of illuminants and enables precise relighting operations to be applied.

“Real colors” are any colors that the human eye is capable of perceiving. “Apovisual colors”, on the other hand, are any colors that lie outside the range of human vision. While apovisual colors can be represented by a color profile, they cannot be displayed to the viewer since they are not physically possible to perceive.

“Colorspace” denotes a three-dimensional mathematical model for mapping digital values in an image to defined colors on the output media or display by use of numerical coordinates. Most colorspace models are in reference to the 1931 XYZ model defined by the International Commission on illumination (CIE) based on a standard observer. The standard observer is an average of many photoptic individuals' observations of color appearance derived from matching the visible range of monochromatic (single wavelength) light to a mixture of three fixed monochromatic light sources. In short this allows for consistent reproduction of color on any profiled media or display. The 1931 standard observer has been replaced several times over the years to reflect improvements and refinements in the understanding and quantification of human color vision. We will use the 2006 LMS model as this is the latest accepted standard that maps precisely to the primary color receptors (cones) in the human eye, even though most color management tools to date still use the CIE 1931 XYZ model as a profile connection colorspace. For example a photograph printed with a profile on paper viewed under a defined illuminant will exactly match a profiled display using the same specified illuminant (light source) even though the underlying principles of achieving this color image are wildly different. Examples of media profiles (ink on paper) are CMY, CMYK, CMYKOG and various other inksets. Cyan, Magenta, Yellow, Black, Orange and Green have been referenced above. These capital letters are generally assigned as such in the industry as the spectral absorption curve of each of these inks roughly represents those colors when printed on white media.

Not all colorspaces can represent the entire spectrum of visible colors. This limitation leads to color clipping, where colors outside the gamut are approximated to the nearest color within the gamut. Although various methods exist to represent out-of-gamut colors as accurately as possible, this often results in a loss of detail or color accuracy. Other potential issues include artifacting and stepping (where smooth color gradients are replaced by visible color bands), impacting the overall quality and fidelity of the image.

Calculations of color that incorporate an SPD (vide supra) are more accurate and more readily transformed with fidelity to the image source. In a perfect world for imaging, the “direct scene-referred illumination” is measured and that data is appended to each image by a process of spectral rendering. This “scene-referred illumination” distinguishes the highest archival level of photography and will be referred to frequently.

For the example of “colorspace” detailed in the following we will assume a printer and paper although this can be done for any reflective media with spectrally absorptive inks. These media profiles are generated by printing many different colored patches by varying the amount of each ink used for each swatch on paper, recording these input values for each ink and measuring light reflectance across the full range of human color vision for each swatch and integrating these reflectance spectral values under the CIE LMS 2006 standard observer curve and a specified illuminant spectral curve. This illuminant can be any defined light source. Standard illuminant D50 (horizon sunlight) is most commonly used. This in turn generates three reference values (“tuples” or “coordinates”) in a profile connection space (in this case CIE LMS 2006, www.wikipedia.org/wiki/LMS_color_space) for each swatch. Using this method, a best fit solution to map between the “connection space” and output space is solved. This solution is now an output profile (ODT) which allows a color image printed on this paper supplied in CIE LMS 2006 to be accurately represented using this profile. To display colors accurately on an emissive display such as a computer monitor, a similar technique is used to generate a display color profile. For generating a display profile we assume an ‘RGB’ display which consists of three light emitting elements for each segment (pixel) arranged in an array. These are generally referred to as RGB as the spectral curves of each element roughly represent Red, Green and Blue. A range of values varying in brightness from darkest to lightest for Red is measured with the Green and Blue completely dark. The variations from input brightness to measured brightness is then saved for each input to output, which results in a ‘gamma’ curve. This is repeated for Green and Blue. Once the gamma curve has been saved for each of the three colors the spectral curve for each of the brightest values of each color is then integrated under the CIE LMS 2006 standard observer curve, which returns three values representing their position in CIE LMS 2006. These three values are generally referred to as the ‘primary coordinate’. This is then repeated for the remaining two colors to generate the display profile as a 3×3 matrix which consists of 9 numbers ‘primary coordinates’ and a gamma curve. A gamma curve is used in displays because the human eye responds in a non-linear fashion with minimal posterization. The spectral profiles can change slightly in relation to brightness but this is generally minor and is usually not taken into account. Now colors specified in LMS values can be accurately displayed. Images are never represented in profile connection spaces (LMS) as colors in the real world rarely come close to the boundary of color vision and displays are incapable of producing every monochromatic wavelength and human color vision follows a bell shaped curve for each of the Long, Medium and Short (LMS) cones with overlap (so there is no possible physical way to stimulate just the M receptor in the eye as you would also get a response from L and S).

Any values outside the possible viewable colors but representable in LMS space are sometimes called “imaginary colors” but we use a more precise term “apovisual colors”. Since displays are the most frequent device used when working with color images several ‘working colorspaces’ have been developed that accurately represent colors present in the real world. Examples of working colorspaces include Adobe RGB 1998, ProPhoto or Rec. 2020 which allow for the storage and manipulation of colors and having much less waste than LMS or XYZ. Working spaces also have a gamma curve to try and uniformly represent brightness as it appears to the human eye and not waste bits on lighter areas and posterize darker areas of an image. To display or print an image from a working space, the color values from the working space are transformed using the working space color profile to the profile connection space and then transformed to the display or media colorspace. In practice, most software combines the two profiles to generate a single transformation of the original data so that less calculations need to be done on the image data.

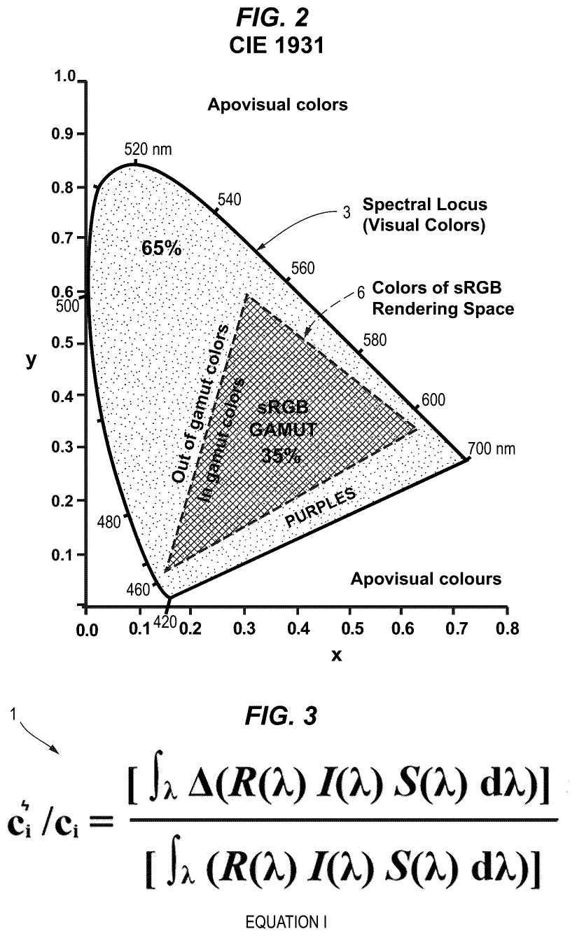

While in most instances the colorspaces are subsets of the CIE perceivable color map, it may be helpful to derive color transforms based on apovisual colors (FIG. 2) so as to increase dynamic range. Surprisingly, the smart color targets and networking accessories may display a panel of reference colors that are not limited to reference color patches prepared from pigments, but can also include reference colors displayed as monochromatic LEDs or as virtual patches on an OLED screen on the exterior surface of the accessory device. By including monochromatic LEDs as ‘training sets’ in a range of colors at or beyond the periphery of the CIE 1931 sense-able color periphery, color transforms capable of adding improved dynamic range to images are obtained. The theoretical basis of these constructs is described in LARSEN_1998, Overcoming Gamut and Dynamic Range Limitations in Digital Images, In Color and Imaging Conference (Vol. 1998(1):214-219); LARSEN_2004, High Dynamic Range Image Encodings, Publ. Anywhere Software, 28 pages. and LARSEN_1999, The LogLuv Encoding for Full Gamut, High Dynamic Range Images, Journal of Graphics Tools 3(1): 15-31; AGUSANTO_2003, Photorealistic Rendering for Augmented Reality Using Environmental Illumination. Second IEEE and ACM Intl Symp Mixed Aug Reality, Proceedings, DOI: 10.1109/ISMAR.2003.1240704. A detailed review is published by REINHARD_2010, High Dynamic Range Imaging, Acquisition, Display and Image Based Lighting, 2nd Ed. Morgan Kaufmann, Burlington MA. Until now, it has not been possible to calibrate transforms of apovisual colors using a spectrometer or to write an IDT when applying invisible colors to digital images. Devices 1601, 2500, 3000, 3100, 3200, 3300, 3400, 3500 provide tools for making this advance when combined with the systems disclosed here.

As another example of colorspace, “CIE L*A*B*” is a colorspace having four primary colors and expresses color as three values: L* for perceptual lightness and a* and b* for four unique colors of human vision: red, green, blue and yellow. CIELAB was intended as a perceptually uniform space, where a given numerical change corresponds to a similar perceived change in color. Like the CIEXYZ space it derives from, CIELAB color space is a device-independent, “standard observer” model. CIELAB is calculated reative to a reference white, for which the CIE recommends the use of CIE Standard illuminant D65. The lightness value, L* in CIELAB is calculated using the cube root of the relative luminance with an offset near black. This results in an effective power curve with an exponent of approximately 0.43 which represents the human eye's response to light under daylight (photopic) conditions. CIELAB is one of many colorspace models, none of which are considered perfect, that have been developed and tested over the past 100 years. Several variants based on cylindrical representations of angular colorspace coordinates have also been attempted, such as TM-30.

“Color Specification” refers to numerical coordinate values (also sometimes termed “tuples”) within a colorspace or selected from named, standardized physical patches supplied by companies like Pantone (Carlstadt, NJ), MacBeth and X-RITE. These specifications have a known reproducibly consistent absolute or relative color depending on the color profile. Each pixel of a digital color image file such as a TIFF, JPEG, or DNG file includes a color value that represents a human visible color value based in a color profile or look-up-table (LUT).

More generally, a “color profile” is developed for a specific image capture device, and that profile is adapted by matrix transformations to remaster or relight the image under calibrated illumination conditions defining the IDT, and is then retransformed by the ODT (Output Device Transform) as appropriate for the output display or printer, with facility to apply creative transforms at will and/or to standardize image color independently of the device on which the image is captured or the device by which the image is displayed. The “workflow” or “pipeline” of digital photography can be broken into a dual serial pipeline having an input device transform and an output device transform structured in combination with a concatenation of other transforms. Alternatively the serial dual pipeline can be condensed into a single tensor expression.

“Color remastering” refers to a process by which a transformation function is applied to raw image data to allow the image to be presented to the user in a scientifically grounded manner based on rendering intent. Absolute accuracy is one rendering intent, but photography is a creative science, and rendering is a matter of art as much as physics. As currently practiced, transformations are most basically represented by a 3×3 matrix multiplication that takes three values from the input device and returns three values for the output. The output can be a display colorspace or more commonly a universally defined standard colorspace such as CIE XYZ, Rec.709. CIE LAB or TM-30. These transformation are generally linear transformations and are reversible if known. Numerous other transformations exist that can non-uniformly remap colors (non-linear). The algorithmn for performing color remastering generates what is termed in the industry as a “color profile”, a colorspace transformation, or an IDT (Input Device Transform). The IDT is specific to input devices such as cameras or scanners and represents the transformation of the input device colors to a known colorspace. When capturing photographs or videos in RAW format, the IDT is best embedded as metadata, allowing the original image information to remain unchanged and is then used by various post-processing tools to execute the transformation on the virgin image file data so that the initial editing is lossless. Subsequent transformations may be burned into the image, and are irreversible, for example conversion to JPEG format.

When creating an IDT, there are three rendering intents, “absolute”, “relative”, and “creative”. These rendering intents shall not be confused with the rendering intents defined by the International Color Consortium (ICC) as the ICC rendering intents are defined to handle profiled source colors that map to colors outside the destination colorspace and are usually used for printed media and deviate from the initial “intent” of the color profile itself.

“Absolute rendering intent” indicates that the colors captured always produce the same visually observed color upon display. For example, a white surface illuminated with a candle will have a yellowish appearance when remastered using absolute intent.

“Relative rendering intent” indicates that the colors captured are relative to the physical color of the object being captured. The same white surface lit with the same candle will appear white when remastered with a relative profile.

“Creative rendering intent” describes a process by which any combination of methods are used to generate a profile based on the creative intent of the profile designer. Most cameras are supplied with creative rendering intent profiles by default.

In practice users may desire accurate colors instead of creative manipulations of color values provided by the camera manufacturers. To deliver accurate absolute and relative IDT's to the end user one must know the response characteristics of the camera and the characteristics of the scene illuminant. Various means have been developed but these have historically proven difficult, time consuming and require extensive knowledge of color management to use. The smart color target device or system 1601 has the computational power to generate accurate absolute calibrations and relative color IDT's quickly and easily. This capacity has numerous applications: from matching one camera output to another camera output, or to using relative intent IDT's for reproducing colors from a specific scene later on different footage. or to shooting in an easily accessed illuminant with the intent of transforming the illuminant to something less accessible in post-processing. For example if a user wanted to save a sunset ‘look’, the user can generate a relative intent IDT, store the IDT in system memory, and apply this sunset IDT to other images shot under different lighting to match that sunset scene.

Relevant art related to color correction and conversion is found in US Pat. Publ. No. US2013/0342557 to Finlayson, US2016/0224861 to Vogh, for example, US2016/0356651 to Vogh, and US2016/0261772 to McElvain, for example. A tutorial is provided by ROWLANDS_2020 Color Conversion Matrices in Digital Cameras. Opt Engineering. DOI: 10.1117/1.OE.59.11.110801). A comprehensive background of the non-patent literature related to color calibration of imaging devices and displays is provided in U.S. Pat. No. 9,894,340 to Holub. Contributions by Spiker are described in U.S. patent Ser. No. 17/581,976.

“Input transform (IDT)” is a formal definition of a matrix transform that maps the colors in a RAW image to known human-visible colors. This ensures that images can be captured and viewed consistently, regardless of the camera or display being used. There are three types of IDT's for visible light color images:

“Absolute profile” calibrates the spectral locus so as to always produces the same visual color when displayed. An image displayed with an absolute IDT will appear identical to the scene it represents when viewed side by side. For example, an absolute IDT will show a white surface illuminated by a candle as having a yellowish appearance. It is important to note that there can only be one absolute IDT per camera.

“Relative IDT” is based on the scene being captured and how the colors would appear when illuminated by a specific “destination illuminant”, such as D65, Std. A, Shade, or F2. An illuminant can also be measured or calculated, such as a blackbody radiator. When rendering a relative IDT, a destination illuminant must be specified. Relative IDTs are invariant of the lighting and will produce the same colors regardless of the light source used to illuminate the scene. For example, a white surface lit with a candle will appear white in the destination illuminant when using a relative IDT. Relative IDTs work by mapping the colors in the scene to how they would appear when illuminated by the destination illuminant.

“Creative IDT” is a special category designed to achieve a specific “look” and may use any combination of methods to generate an IDT based on the creative intent of the profile designer. Chromatic adaptations, or “white balanced” IDT's, also fall under creative intent as they are not based on scene measurements of color. Creative IDTs are created by manufacturers and users who want to achieve a certain look or effect in their images.

An “IDT/ODT” (input device transform/output device transform), also termed a “color profile” relates to a tensor and/or a series of mathematical transformations essential for creating a spectral profile tailored to specific image capture or output devices. This spectral profile is necessary for accurate color representation in the spectral domain. It facilitates colorspace transformations and relighting, which are employed to remaster or relight images under specific, calibrated illumination conditions, as defined by the IDT and user. After the IDT (Input Device Transform) process, the data is further transformed by the ODT for its intended final output. As a working part of a digital image pipeline, using VSF (Versatile Storage Format data) digital imagery workflow, a node based pipeline encompasses the IDT, other concatenated user desired transformations and a final ODT transformation. This setup is embedded as metadata in a container that holds the digital image, and enables the standardization and accurate rendering of image color, independent of the specific devices used for capture or display.

Generally, “colorspace transforms” as a class refer to matrix transforms that transpose, invert, rotate, shrink or stretch one mappable colorspace to fit into another mappable colorspace, and can be applied to an image to reshape its coloration. In conventional use, colorspace transforms known in the art do not shift the whitepoint, so that another transform, termed a “chromatic adaptation transform” may be needed if direct scene-referred illumination data has not been preserved with the image. Commonly, transformations based on LMS (Long, Medium, Short cone response) or XYZ (CIE standardized color space) models employ a 3×3 matrix, referred here to as a “magic nine”. These 3×3 or 4×4 transformations have the capability to transpose, invert, rotate, shrink, warp or stretch one colorspace into another, thereby adjusting the relative range of data without altering the whitepoint or the overall color appearance of the image. When direct scene-referred illumination data is missing and a change in whitepoint is required, a chromatic adaptation transform becomes necessary.

To move between colorspaces, four parameters are useful: 1) the identity of the source image gamut (such as JPEG, NNG, RAW, ArriRAW, AdobeRAW, TIFF, CMYK/YCCK, ACES, JPEG, PSD, BNP, GIFF, ICO, PCX, AVI, MOV, MP2, EPS, and proprietary formats such as ARW (Sony), RedRAW, CRW/CR2 (Canon), NEF (Nikon), ORF (Olympus), RAF (Fujifilm), RW2 (Panasonic), RWL (Leica), SRW (Samsung), X3F (Foveon/Sigma), and so forth), 2) the source tone or gamma curve (typically embedded in the image and extractable from it), 3) the manufacturer's whitepoint (not typically documented), and 4) the product (output) gamut, output gamma and output whitepoint. In conventional practice, significant latitude is given to guesswork by which a trained technician manipulates sliders or knobs of a user interface of photoediting software such as Photoshop (Adobe) or DaVinci Resolve (BlackMagic) for example, to get a satisfying look-feel for the image or video clip. This explanation can be expanded to hyperdimensional colorspaces manipulable only to computers.

“Gamut” in digital imaging refers to the complete range of colors that can be represented within a given colorspace. The RGB gamut or color model, while efficient for many standard imaging applications, lacks the necessary spectral information to define the complete spectral range of a scene as would be seen by a human eye. As a result, operators and colorists find their ability to accurately relight and grade images hindered. The absence of detailed and complete scene illumination information in the system means that color transformations and adjustments may not represent the intended colors and lighting conditions of the original scene.

This limitation becomes particularly evident when attempting to achieve realistic and precise color grading and relighting effects. The three-channel RGB model fails to capture the nuances of spectral data, leading to potential inaccuracies in color reproduction, especially under varying lighting conditions where metamerism is revealed. Consequently, there is a growing need for more sophisticated color profiles and systems that can incorporate and process spectral data, thereby enhancing the fidelity and versatility of digital image processing.

“Gamma correction” or gamma encoding is a term used when representing image data as the human eye is more sensitive to changes in darker areas than lighter areas. For example the brightness value from 1% to 2% would be much more noticeable than a brightness from 98% to 99%. If images are not gamma encoded they allocate too many bits or too much bandwidth to the highlights and too few bits or too little bandwidth to the darker areas. To achieve perceptual uniformity from capture to display the incoming linear values from a camera are gamma corrected generally using an inverse logarithmic curve and upon display using a logarithmic curve. A ‘flattened log curve’ or ‘knee compression’ is most commonly used for image data that is transformed from RAW camera data as this follows a log curve but tapers off near the highlights to give a less sudden visual transition when the input values are brighter than representable in the output. Camera manufacturers have developed a broad set of proprietary gamma curves for use with their sensors, for example Log-C, C-Log, D-Log, J-Log, N-Log, S Log, V-Log, Red-Log, and so forth. Other gamma curves that are specialized for storing tonal information include ‘cine gamma’ and ‘hyper gamma’. Flattened log curves improve dynamic range (typically as measured by the number of ‘stops’) and add detail to shadows without sudden loss of highlights.

“Dynamic range” in photography refers to the range in which a camera can capture the brightest and darkest parts of a scene without clipping or losing detail. Conventionally, the brightness range is measured in ‘F/stops’ and losses of detail are noted in highlights (clipping) at higher exposures, and vice versa for underexposed shots (noise). Dynamic range is limited by the introduction of noise in relation to the largest measurable value. Noise comes from the nature of capturing and measuring an analog signal. Noise is generated on the sensor and in the amplification and readout process. Sources of noise on the sensor include dark signal non-uniformity (temperature dependent), photo response non-uniformity (fixed), photon quanta (random), and reset (random). Sources of noise on the amplification and digitization process include code transition or quantization (random), thermal (temperature dependent), interference (artifacting), and A/D mismatch (banding).

“Gamma” and “Tone Curve” refer to operations used to encode and decode image data values.

“Gamma curves” usually employ a pure logarithmic, pseudo- or semi-logarithmic function and are often weighted towards darker tones, reflecting the human eye's greater sensitivity to changes in dark tones compared to bright tones. Gamma and tone curves are versatile in their application within various workflows. For instance, within an Absolute IDT, an inverse film tone curve might be used to recover the linear values of a scene. Conversely, applying the direct (not inverse) tone curve can give an Absolute IDT image a characteristic ‘shot on film’ appearance.

The purpose of gamma encoding is usually to compress, not distort, tonal (value) information. The gamma curve modifies the allocation of bits in digital image data, assigning more bits to darker areas, where the human eye is more sensitive, and fewer to brighter areas, where sensitivity is less. This non-uniform bit distribution enhances data efficiency, reducing the amount of data needed to represent an image while maintaining uniform visual fidelity across the output range. This approach ensures a more eye-like, anthropocentric representation of image data. Standard gamma values vary based on intended use, design, and medium. A gamma power near 2.2 is commonly used in many consumer-level devices, including the sRGB standard for web images and consumer electronics. Other gamma values, like Hybrid Log-Gamma (HLG) and SMPTE ST 2084, are often used for high dynamic range (HDR) content delivery, featuring non-linear characteristics.

The gamma transformation ensures the final image appears as intended. This process involves raising the captured linear image values to the inverse power of the gamma value (input_from_device\hat{ }(1/gamma)=image). Caution is necessary with out-of-gamut colors, as they can produce negative values leading to complex, non-displayable results upon logarithmic gamma application. For display, the inverse process is applied, concisely expressed as image\hat{ }gamma=output_for_display. In certain instances, employing gamma values such as 2 and the square root of 2 can offer computational advantages and can also expedite the gamma encode/decode processes, while approximating the eye's native gamma response.

“Whitepoint” is the overall color appearance of an image, more strictly, the final chromaticity coordinates in 2006 lm or 1931 xy space of a spectrally uniform surface under a given illuminant. In terms of spectral data this is equivalent to an illuminant, representing the color “white” that is defined by the specific lighting conditions under which an image is captured.

“White Balance” is defined as follows. Without the original illuminant information, white balance can be used to manage overall color cast or appearance during chromatic adaptation. This process transforms image data into the eye's native LMS space and scales the L, M, and S values by three constants to achieve a desired whitepoint. While this aims for a specific whitepoint, it results in the loss of the original color information. Gamma curves are typically non-linear and are constructed to optimize bit distribution in a way that aligns with the human eye's perception and compresses the range of dynamic lighting so that a greater range of F-stops can be recovered. In contrast, tone curves are best thought of as the response of a medium to stimuli, such as the way film reacts to light.

“Compression” is the essential companion of digital transmission, relates to “bandwidth”, and can be lossey or lossless. For example, a log curve (such as Arri LogC) is designed to store more dynamic range with minimal loss, while a Gamma 2.4 curve is designed to encode luminance values that feel perceptually linear to the human eye and requires a larger bandwidth per image. Color compression cannot avoid color clipping of out of gamut colors but can increase posterizing as bit depth and dynamic range are decreased. JPEG is highly compressed, and relies on a LUT to define 8-bit color with minimal file size.

“Metamers” are, as a class, colors having a very similar apparent perceptual character, but produced by differing spectral power distributions of reflected light, analogous to an eigenvector of a chromaticity field. When illuminated by a defined illuminant, variously colored objects may be perceived as having a uniform color. When the illuminant is shifted, the metamers will appear as different colors. Both eye and camera are subject to metameric qualities in reflected spectral power distributions that can be revealed as identifiably distinct color reflectances by a shift in the SPD of the illuminant. In practice, camera response functions (S) are not exact linear transformations of the eye-cone response functions. Consequently, camera raw spaces are not colorimetric, so cameras exhibit metameric error. Cameras that exhibit metameric error produce different color responses to these metamers (ROWLANDS_2020). Furthermore, a notable consequence of camera metameric error is that the camera raw space gamut is warped away from the triangular shape accessible to the additive linear combinations of the three primaries. Certain regions are even pushed outside of the triangle accessible to the CIE XYZ color space. Metamerism is not just a bug, it is also a feature, and can be exploited as suggested by URBAN_2010.

A “camera” is any device capable of measuring photon amounts in angular representation over a period of time. Typically these photons are in the form of visible light but could be any form of electromagnetic radiation. For example a visible light camera consists of a light sensitive medium such as a silicon wafer (CCD or CMOS) or photographic film coupled with a device to translate angular components of the incoming light to a spatial representation. This sensitive medium is capable of measuring the amount of incoming photons at many spatial locations and storing these measurements for later representation and display. This could be a photographic print or a computer monitor display. In the case of a digital camera these measurements are generally converted to a digital representation and stored as binary data on a storage medium.

As used here, a “networking accessory” or “networking device” useful for digital photography, videography or virtual reality image capture and display may be a family of devices having the meaning of “reference target device” “color target device,” “color target hub”, a “electronic color target,” a “hub” that acts as a hotspot, or a “radio adaptor” and include electronics and instruction sets for interacting with a camera and with other system elements of a network such as a hotspot, a local computing machine, or a cloud host. In addition to file distribution and networking, however, the devices are designed to facilitate color matrix transformations, partial differential equations, neural networks, AI, and utilize processors, logic circuitry, and algorithms that are intended for what we term, “color remastering”, which relates to selected transformations of raw numerical color sensor data into color imagery that is recognizable to the human eye or to a camera “eye” or parsing functions of another machine.

Electronic color target devices are interactive networking devices that are differentiated from “color target cards” of conventional art and include one or more evenly colored exterior surfaces generally referred to as color patches, color patches, or color chips. One feature that differentiates a networking accessory for digital photography from a color target card is a capacity to network wiredly and/or wirelessly. Generally the networking device may include both a LAN radioset and a WAN radioset for communicating with the other parts of the image management and processing systems, the camera and the cloud. However, in some instances, the networking devices may have sufficient processing power to process images without direct cloud host participation, and in other embodiments, devices having LAN radios will rely on companion devices having WAN radios to enter into broader networks.

A “color target” is an arrangement of color reference patches placed in a defined geometric pattern on a surface. An early example of a color target card is the Gretag Macbeth ColorChecker. In use, the reference patches are illuminated with a light source and photographed. This allows for creation of a “color profile” or Input Device Transform (IDT) which then can be used for “color remastering” of subsequent images taken with the camera. The color patches are chosen with different spectral reflectance curves (colors) allowing for the measurement of color in multiple places within the colorspace of human vision. These multiple camera measurements of different colors can then be compared to the color reference target colors and a best fit solution can be solved to transform the camera colors to known colors within human vision. Color profiles are necessary to represent colors from a camera as each camera has a different spectral response which results in different measured values taken of the same color with different cameras. Spectral response varies from camera to camera and spectral emission curves of light sources can vary from scene to scene so measuring as many colors as practically possible allows for a closer best fit solution for the resulting IDT. In practice, cameras are typically supplied with a manufacturer's default IDT, but because this typically assumes an ideal daylight illumination, a photographer will best perform a calibration specific to the illumination as present when the photograph or video is taken.

A “glyphoptic code” denotes an optical glyph or code that contains machine readable digital information contained in a pre-defined optical pattern or format. The code may contain identifying information about the smart color target device such as those useful in bootstrapping a radio link to a networking accessory or to a cloud host. While not required, the optical code is valuable because cameras can be programmed to recognize optical codes for initial setup. The initial setup can include generating a radio link between the camera and the smart color target device by which other instructions and data are exchanged. Glyphoptic codes are exemplified by “barcodes” and “QR codes”. Also of interest is a species of glyphoptic code termed a “roundcode” (FIG. 5B).

“Computer” means a virtual or physical computing machine that accepts information in digital or similar form and manipulates it for a specific result based on a sequence of instructions.

“Computing machine” is used in a broad sense, and may include logic circuitry having a processor, programmable memory or firmware, random access memory, and generally one or more ports to I/O devices such as a graphical user interface, a pointer, a keypad, a sensor, imaging circuitry, a radio or wired communications link, and so forth. One or more processors may be integrated into the display, sensor and communications modules of an apparatus of an embodiment, and may communicate with other microprocessors or with a network via wireless or wired connections known to those skilled in the art. Processors are generally supported by static and dynamic memory, a timing clock or clocks, and digital input and outputs as well as one or more communications protocols. Computers are frequently formed into networks, and networks of computers may be referred to here by the term “computing machine.” In one instance, informal internet networks known in the art as “cloud computing” may be be functionally equivalent computing machines, for example.

A “server” refers to a software engine or a computing machine on which that software engine runs, and provides a service or services to a client software program running on the same computer or on other computers distributed over a network. A client software program typically provides a user interface and performs some or all of the processing on data or files received from the server, but the server typically maintains the data and files and processes the data requests. A “client-server model” divides processing between clients and servers, and refers to an architecture of the system that can be co-localized on a single computing machine or can be distributed throughout a network or a cloud. A typical server may define what is termed a “cloud host” when networked.

“Processor” refers to a digital device that accepts information in digital form and manipulates it for a specific result based on a sequence of programmed instructions. Processors are used as parts of digital circuits generally including a clock, random access memory and non-volatile memory (containing programming instructions), and may interface with other digital devices or with analog devices through I/O ports, for example.

“Artificial Intelligence” relates to a process by which a machine training set is introduced to a computer with a learning function or “neural network” configured so that the training set enables the computer to predict proper responses to de novo queries in what appear to be solutions to problems. More formally, AI is an iterative process where a computing machine running an algorithmic model learns heuristically from experience (i.e., from historical data in memory) as part of the model training phase; then the trained AI models predict the response or “right answer” to queries based on real-world data for various tasks such as classification, sorting, regression, definitions, relatedness and clustering. AI may mimic thinking, learning, seeing, listening, speech, and problem-solving. Multiple processors or threads may use the neural networks in multiple parallel pathways to solve problems more quickly. The field is advancing quickly and may soon outgrow this definition as artificial general intelligence emerges.

General connection terms including, but not limited to “connected,” “attached,” “conjoined,” “secured,” and “affixed” are not meant to be limiting, such that structures so “associated” may have more than one way of being associated. “Fluidly connected” indicates a connection for conveying a fluid therethrough. “Digitally connected” indicates a connection in which digital data may be conveyed therethrough. “Electrically connected” indicates a connection in which units of electrical charge are conveyed therethrough.

Relative terms should be construed as such. For example, the term “front” is meant to be relative to the term “back,” the term “upper” is meant to be relative to the term “lower,” the term “vertical” is meant to be relative to the term “horizontal,” the term “top” is meant to be relative to the term “bottom,” and the term “inside” is meant to be relative to the term “outside,” and so forth. Unless specifically stated otherwise, the terms “first,” “second,” “third,” and “fourth” are meant solely for purposes of designation and not for order or for limitation. Reference to “one embodiment,” “an embodiment,” or an “aspect,” means that a particular feature, structure, step, combination or characteristic described in connection with the embodiment or aspect is included in at least one realization of the present invention. Thus, the appearances of the phrases “in one embodiment” or “in an embodiment” in various places throughout this specification are not necessarily all referring to the same embodiment and may apply to multiple embodiments. Furthermore, particular features, structures, or characteristics of the invention may be combined in any suitable manner in one or more embodiments.

“Adapted to” includes and encompasses the meanings of “capable of” and additionally, “designed to”, as applies to those uses intended by the patent. In contrast, a claim drafted with the limitation “capable of” also encompasses unintended uses and misuses of a functional element beyond those uses indicated in the disclosure. Aspex Eyewear v Marchon Eyewear 672 F3d 1335, 1349 (Fed Circ 2012). “Configured to”, as used here, is taken to indicate is able to, is designed to, and is intended to function in support of the inventive structures, and is thus more stringent than “enabled to”.

It should be noted that the terms “may,” “can,”” and “might” are used to indicate alternatives and optional features and only should be construed as a limitation if specifically included in the claims. The various components, features, steps, or embodiments thereof are all “preferred” whether or not specifically so indicated. Claims not including a specific limitation should not be construed to include that limitation. For example, the term “a” or “an” as used in the claims does not exclude a plurality.

“Conventional” refers to a term or method designating that which is known and commonly understood in the technology to which this invention relates.

Unless the context requires otherwise, throughout the specification and claims that follow, the term “comprise” and variations thereof, such as, “comprises” and “comprising” are to be construed in an open, inclusive sense—as in “including, but not limited to.”

The appended claims are not to be interpreted as including means-plus-function limitations, unless a given claim explicitly evokes the means-plus-function clause of 35 USC § 112 para (f) by using the phrase “means for” followed by a verb in gerund form.

A “method” as disclosed herein refers to one or more steps or actions for achieving the described end. Unless a specific order of steps or actions is required for proper operation of the embodiment, the order and/or use of specific steps and/or actions may be modified without departing from the scope of the present invention.

### DETAILED DESCRIPTION

The following description is presented to demonstrate the art and uses of the inventions disclosed. Various modifications will be readily apparent to those skilled in the background arts, and the general principles may be applied to other implementations and applications without departing from the spirit and scope of the disclosures as claimed here and in succeeding patent applications. Thus, the present disclosure is not limited to the implementations shown but is to be accorded the widest scope consistent with the principles and features disclosed herein.

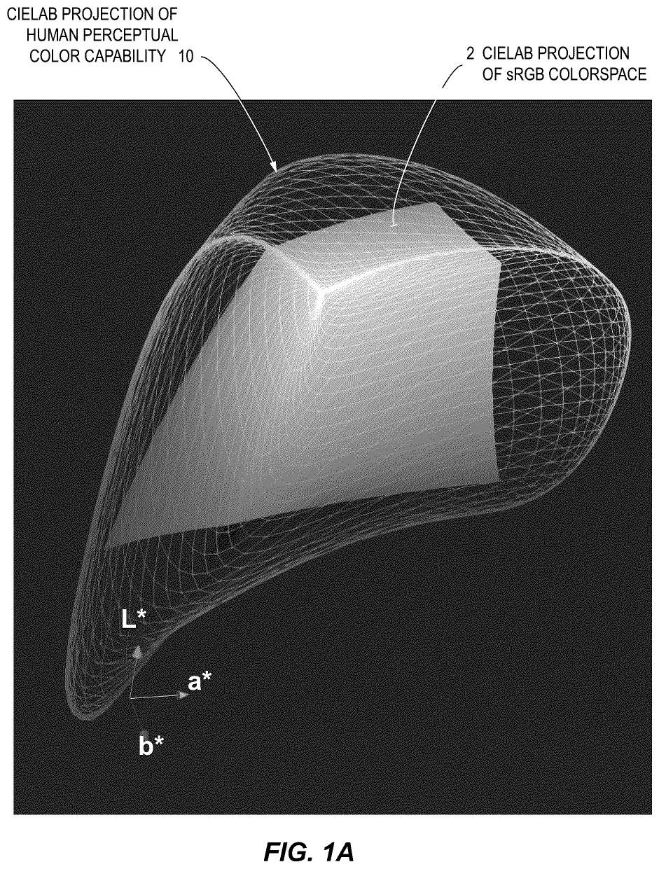

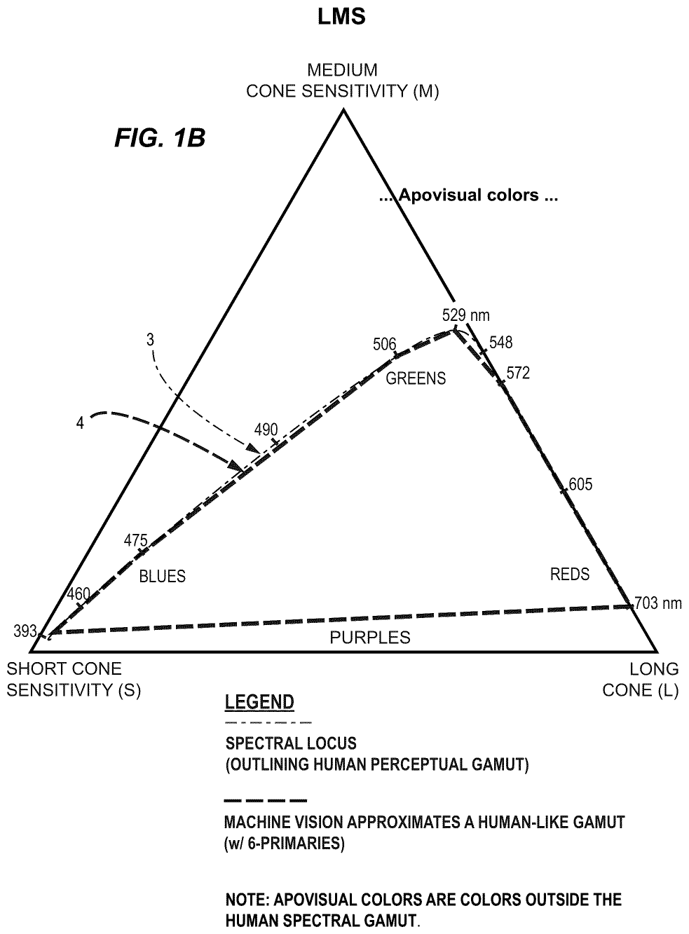

FIG. 1A is a geodesic map 1 (projected in CIELAB) of a color cloud that corresponds generally to the color sensitivity of the human visual apparatus, and encloses a machine-operable colorspace useful in operation of optical devices. The tessellation encompasses the colors that are perceptibly distinct to human photopic vision-per psychological/physiological experiments that defined the CIE 1931 XYZ colorspace. Within the tessellation is a solid geometric shape 2 (as expressed in CIE LAB) that outlines the sRGB colorspace that is in current use industry-wide by most electronic camera and display devices. The sRGB colorspace is bounded by three primaries usually given as 467, 532 and 630 nm. This map does not consider the tetrachromacy enabled by rods of the macula in low light and is not representative of the color vision possessed by other species.

This colorspace is described mathematically by a* b* coordinates such that any individual color has a set of coordinates. A third coordinate L* indicates intensity. A variety of coordinate systems, including XYZ, HSV, LUV, RGB have been in common use, and are favored conventionally because interconversions of the coordinate systems reduces to linear mathematical transformations. The geodesic corresponds to the spectral locus shown in FIG. 3, but here in three dimensions. As can be seen, only about 35% of the colors perceptible by the human eye can be mapped to the RGB colorspace.

FIG. 1B is a map of the LMS colorspace in two dimensions. Each triangular axis from 0 to 1 corresponds to a sensitivity of the three species (L, M, S) of human visual cones in the fovea; with sensitivity peaks at short (S, 420-440 nm), middle (M, 530-540 nm), and long (L, 560-580 nm) wavelengths. The dashed black curve 3 is the spectral locus of monochromatic colors from about 400 to about 700 nm. Colors inside the spectral locus, by the law of superposition, are mixtures of primary colors in various proportions. Color intensity is not represented in this graph. The red dashed line 4 indicates the range of color mixtures reproducible with a set of six primaries at about 390, 475, 500, 530, 570, and 700 nm. Whereas the sRGB primaries can generate about 35% of the color gamut of the human perceptual color capacity, six primaries stimulate about 95% of our tristimulus color gamut. It includes the spectral locus of monochromatic colors from 400 to 700 nm, highlighting the human visual gamut. Also illustrated are the “apocolors” beyond this locus.

FIG. 1B illustrates “apovisual colors” outside the spectral locus. FIG. 2 is a two-dimensional map of the CIE 1931 color system, and shows a slice through the color cloud of FIG. 1A. The spectral locus 5 from about 400 to about 700 nm is again shown, corresponding to the human visual gamut, but it should be recognized that color extends beyond that window and that a variety of species see well in the ultraviolet or infrared. We term those colors that are outside the range of typical human vision as “apovisual colors”. By tricking the sRGB colorspace 6 to allow negative numbers, purples may be represented, however a large range of yellows, greens, blues, indigos and purples are not reproducible with RGB devices. These “missing” colors are termed “out of gamut colors” and may not be “apovisual colors”; i.e., the biological eye can see them, but the sRGB modelled machine cannot capture or reproduce them.

In more detail, FIG. 2 is a slice through an XYZ colorspace in two dimensions, and demonstrates that monochromatic color forms a spectral locus (solid boundary, 3) from about 450 nm to about 700 nm, roughly conforming to the optimal color sensitivity of the human fovea. The colors were determined by testing volunteers who were asked to distinguish two color patches, such that this plot represents the range of colors that the human eye can see well enough to differentiate. Colors inside the spectral locus, by the law of superposition, are mixtures of monochromatic colors in various proportions. Color intensity is not represented in this graph. Toward the center of the graph, mixtures of colored lights tend to produce what is perceived as white or grey light.

The hatched triangle 6 inside the spectral locus is a slice of the RGB cube 22. This colorspace is described mathematically by R, G, B and L*AB coordinates such that any individual color has a set of coordinates. The added coordinate L* or V may indicate intensity (value). A variety of coordinate systems, including CAMO, HSV, LUV, RGB and so forth have been in common use, and are favored conventionally because the coordinate systems reduce the mathematical operations needed to transform the colorspace to the user's application (while also reducing the gamut). But there is a more significant observation regarding FIG. 2. The system relies on a color cloud of color coordinates to map the colors to a 2D slice or to a 3D projection. We can imagine that color instead is continuum over a spectral range and is best mapped as the integral of the entire spectral continuum, or at least the section of the spectral continuum that birds, butterflies, shrimp and humans sense (or we detect with our machines). While the color range perceptible by the human eye is limited, the range accessible to machine vision has no such limitations. However, even more importantly, when a color is represented as a coordinate tuple, the assumption is made that the color mixture as perceived is a unique color, but in fact, many mixtures of light (“metamers”) are capable of producing an identical color sensation, so by fixing a coordinate tag on a particular color in an image, an enormous amount of potentially-useful information is discarded, and we are left with a best guess as to what the true color mixture is—or was. Then when that color is transformed mathematically, the color is no longer a reversibly transformable color; the original sensor data cannot be recovered. The simplification made by reducing the color to a three, four, or five tuple coordinate has irreversibly lost color information in the original output from the machine color sensor. Thus the digital color that we display to the human eye can no longer be reliably assumed to be the color of the original scene as would have been experienced by someone who was there when the digital image was captured. This compression lossyness is even more complicated because evidence shows clearly that the human perceptual color map is non-linear. Colors in the brain cannot be extrapolated by linear matrix transforms. This dilemma has appeared to be insoluble, and some have argued that our limited electronic color palette (JPEG for example contains only 256 possible colors) is good enough, but given the intimate association of color with the human limbic system and its potential impact on science, education, social, and political interactions, we are not satisfied.

Some context is useful. FIG. 3 is a linear equation 1 that derives a numerical expression for a color from the inherent reflectivity of a surface (R, “reflectant”), the spectral power function of the incident light (I, “illuminant”), and a spectral sensitivity weighting (S). The combination of radiant and emitted light from a surface (L, luminance) incorporates not only the chromaticity of the light, but also the luminant power of each fraction of the exitant spectrum from a surface.

$$= {\int }_{λ} R ( λ ) I ( λ ) S ( λ ) d λ = {\int }_{λ} L ( λ ) S ( λ ) d λ \qquad ( Eq . 1 )$$

The precise value of c′ depends on the observer. A large body of literature exists that has attempted to reconcile this equation for both visual and machine vision. Transparency, translucency, shade, and polarization are complicating factors that will not be considered in this introduction, but here we show systems that can extend the equation to emissive light, to hyperspectral light, and to machine sensors having more than three or four color channels.

Generally \grave{c} is reported as a Cartesian tuple, most typically having x, y chromaticity and L*, Y* or V luminance. In some instances x, y, z are chromatic coordinates, and a fourth coordinate is luminance. Equation 1 resembles a mathematical expression known in the art, but is adapted here as a starting point for understanding color in the spectral domain without limits. Despite the size of the associated matrices (for example a binwise channel distribution at 5 nm per bin that covers 350 to 820 nm or more could require thousands of two-by-two multiplications and additions just to solve a single term), this computational hurdle is no longer impractical given newer GPU and VPU chips. By this approach—with modern multithreaded processors and virtually unlimited DRAM, the algorithms are a solution to a machine transformation by which digitized excitation from an optical sensor assembly is transformed into useful sensor information that can lead to “cognition”, remote actuation, statistical and analytical insight, and higher order machine logic functions as would be part of an artificial intelligence package that makes up an optical sensory interface in a machine device, optionally with synesthesia and augmented reality. By extension, these machine devices will be able to communicate with each other using optoelectronic messaging and to coordinate optical inputs with textual or voice inputs; then produce optical, textual and voice outputs in the form of a conversation.

Driverless vehicles are one machine application. Computer games have been around for a long time, but that simple “road warrior logic” is much less sophisticated than the machine vision of a driverless car, one that differentiates a wet road from a dry road, or reports a person entering a crosswalk from behind a telephone pole by scanning for an IR signature before the first part of the human is visible to LIDAR.

Inobtrusive watermarking and authentication of digital images is another application. Sorting recycled waste is also practical as machine learning progresses in analysis of material substance by optical characteristics.

Colorimetric facial recognition, biometrics and augmented reality are other use cases. Re-lighting of photographs was earlier disclosed (U.S. patent application Ser. No. 17/968,771 and U.S. Pat. Ser. No. 63/460,004 are incorporated here by reference). At image sizes of 250 KB or even 10 to 100 MB, relighting is doable for entertainment without calibration (with or without AI), but can be done as a reproducible exercise founded on solid remastering of the optics and the matrix transforms, such as is useful in cinematography. That level of biometrics also has the potential to revolutionize banking and the move toward a paperless society, without the waste of blockchaining.

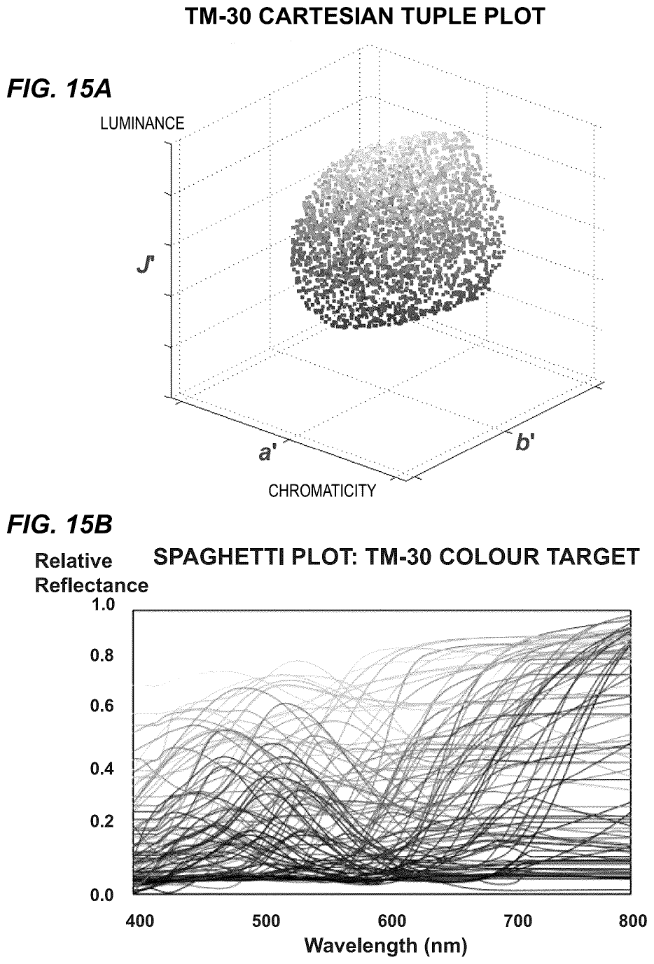

As necessary background, we have illustrated what are “spectral power distributions” (SPDs) in FIG. 15B and contrasted that with tuplized data in FIG. 15A. The spectral domain can be visualized as the spectral mixture of many superimposed beams of light as analyzed by a spectrophotometer and reported as incident power per unit wavelength per cone angle. The spectral domain is filled with mixtures of light, both visual and apovisual, so the full impact of equation 1 (FIG. 3) is to present a unified concept of machine data as a cloud of excitations, not as a set of a few tuples X, Y, Z or some look-up table with the 256 colors of the JPEG palette, for example. Wavelets and metameric mismatches have also been studied. But by calculations in which the entire color cloud is weighted, a much more scientifically accurate and realistic display can be achieved. Also, the information as displayed, unless flattened downstream from the rendering engine, retains the full spectral gamut (including luminance) so that any transforms that are applied do not lose data-achieving lossless compression. The history of the transforms is preserved in a stack in a container that encloses the original cleaned-up image.

In subsequent work, integral 1 is solved by binwise discretization using matrix algebra in combination with metameric set pruning using smoothing operations. For example, using least squares error minimization, a smoothed convolutional color space can be constructed by fitting the SPDs so as to minimize the sum of the differences (ΔE) between adjacent wavelength bins. Lagrange multipliers and gradients may also be used to fit a smoothed three-dimensional SPD contour across an image space as defined by the scene illuminant(s) and luminance. While it would be desirable to construct an SPD for each pixel, this is not practical given the cost/return. But by including luminance as a vector and four or more color channels, even 8-bit color provides lifelike quality that dramatically outmatches RGB. The diminishing return likely is reached at six or seven primary channels, but for practical reasons, a system for capturing, processing, and displaying digital color is likely optimal at 4 to 6 color channels, including luminosity, and extending luminosity to include emittance, thus increasing the impact of the newer HDR screens. Given the advances in computer technology required to master large data sets, not merely for color, but also for raytracing, layering, NERFs, and Gaussian Splat pasteups from 3D image series, as well as the pressure for 4K and 8K video streaming, it may seem surprising that even greater levels of complexity are contemplated, but as images become more lifelike, the capacity to interact with avatars activated by artificial intelligence becomes more natural, relieving a significant number of young, creative and intelligent people, mostly city women employed in massive call centers, from the large numbers of 7/24 customer service jobs that have limited their future prospects.

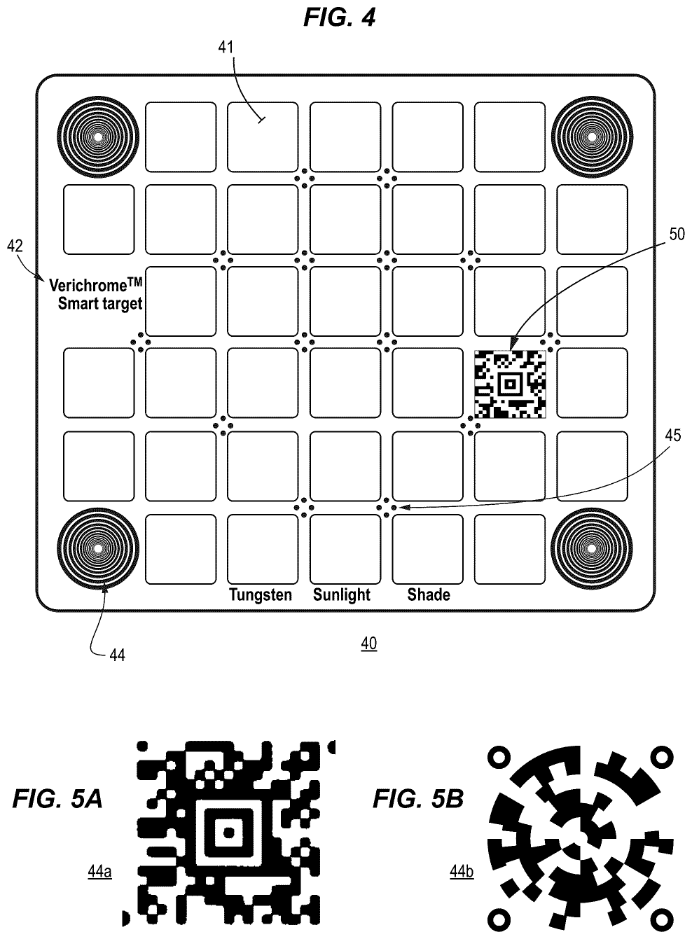

Remastering is key to any serious effort at virtual reality. In one implementation, a color remastering system comprises a durable color target tool 40 as shown in FIG. 4. The color target tool 40 includes colored pigment patches 41 as an array. A pigment database and a software package are included for use on an electronic device such as a smartphone or other system for detecting and profiling color imaged from the array. Twenty-four to ninety-nine patches have been suggested as sufficient for building a remastering color profile. Before the color target is delivered to the end customer, each target pigment patch 41 is individually scanned by a spectrophotometer (not shown) under standardized lighting conditions. For each patch of the array, a reference spectral scan is kept on a reliable online database and is accessible by the end user with global access for device and system profile generation.

The color tool 40 is thus a component of a larger system that may include a camera, a photoediting apparatus, a monitor, and an online datacenter. Smartphones may serve as intermediaries between the online datacenter and the camera, photo-editing apparatus and monitor and are supplied with “Apps” as software applications configured for coordinating system operations and doing color re-lighting.

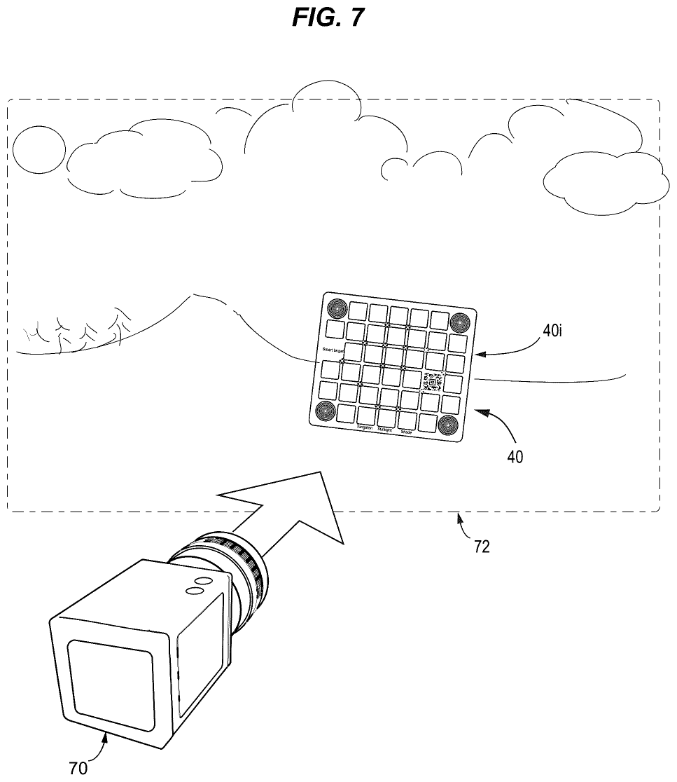

The color target pigment patches 41 are designed in such a way that the target (i.e., the array 40 of pigment patches 41) is trackable for the lifespan of the tool and is accessible in a database by a unique serial number in order to generate accurate color calculations at the end user device (such as a camera). The process is substantially automated. This allows an end user to point a camera (70, FIG. 7) at a target array of pigment patches 41 and instantly generate a scene-referred color reference profile (IDT). Once the “scene-referred reference profile” has been generated and loaded, an optical device can accurately read colors on new images, apply the IDT transform, and encode digitally accurate color images into an exported RAW, DNG, or VSP image file. As an added side benefit, the calibrated optical device also is now capable of matching paint colors and calibrating displays, and the images and software may also be used in a photo-editing apparatus to remaster or “re-light” the native scene colors with any desired special effect, AI effect, or substitute lighting needed, such as to match shots taken with other cameras at a wedding or to match shots taken on different sets of a movie production.

Referring again to FIG. 4, the color target 40 is preferably constructed from a rigid unbreakable black substrate having effective paint adhesion properties. The dimensions of the color target array can be scaled to any size preferable to a user. The rigid durable black material surface is preferably initially prepared by sanding with a fine abrasive, and then applying an adhesive promoter for the colorants. The base colorants are applied for all thirty-seven numbered pigment patches 41 (FIGS. 4, 5) in a grid array fashion.

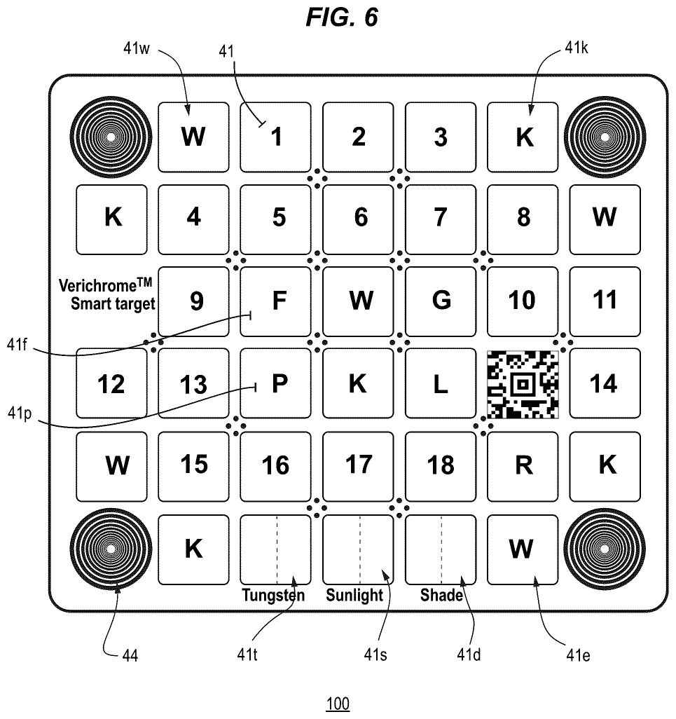

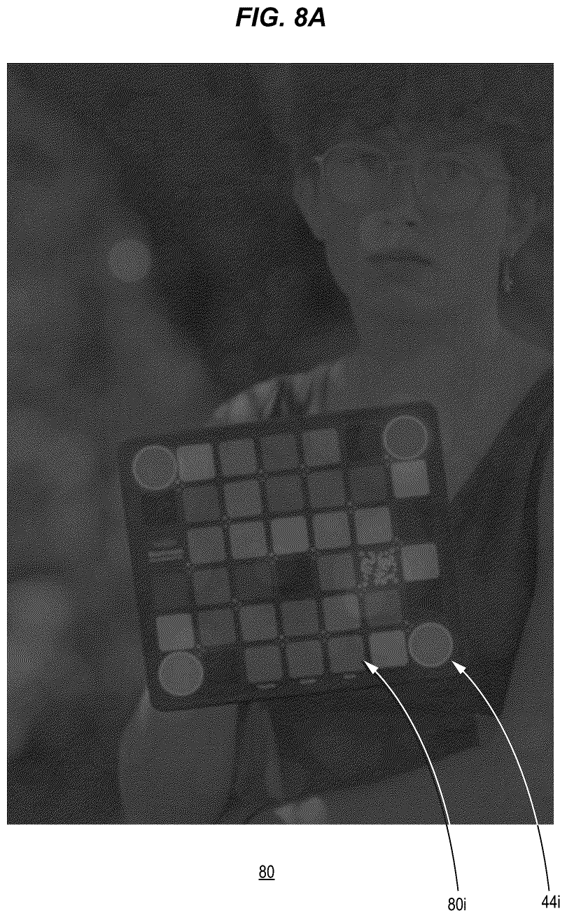

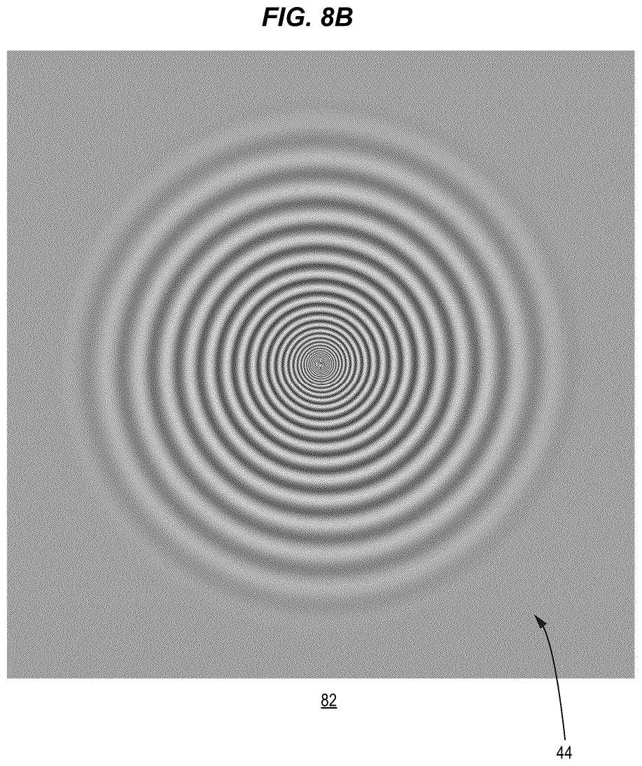

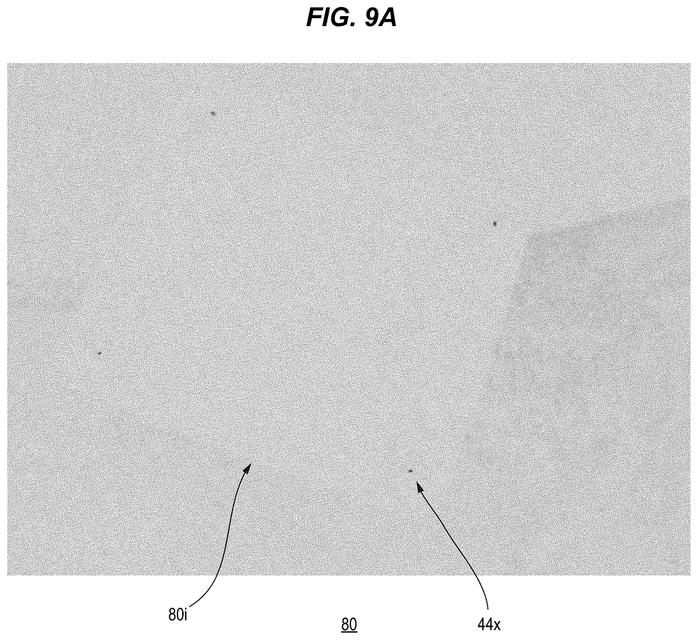

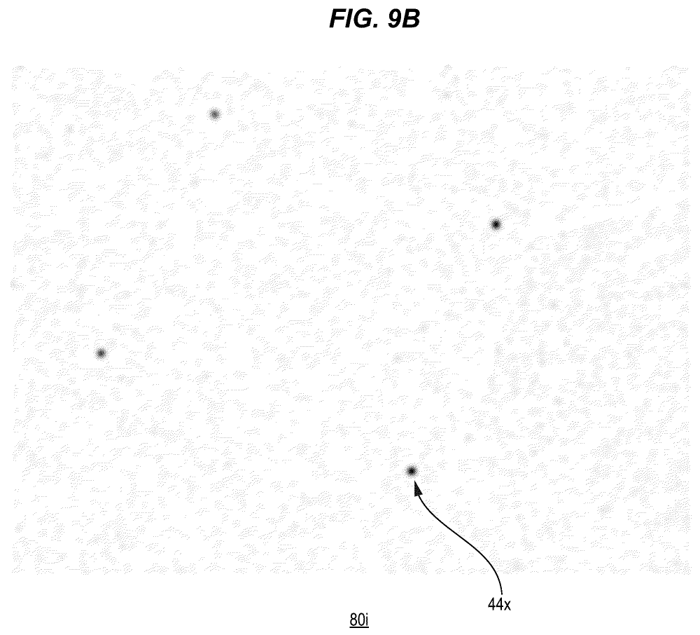

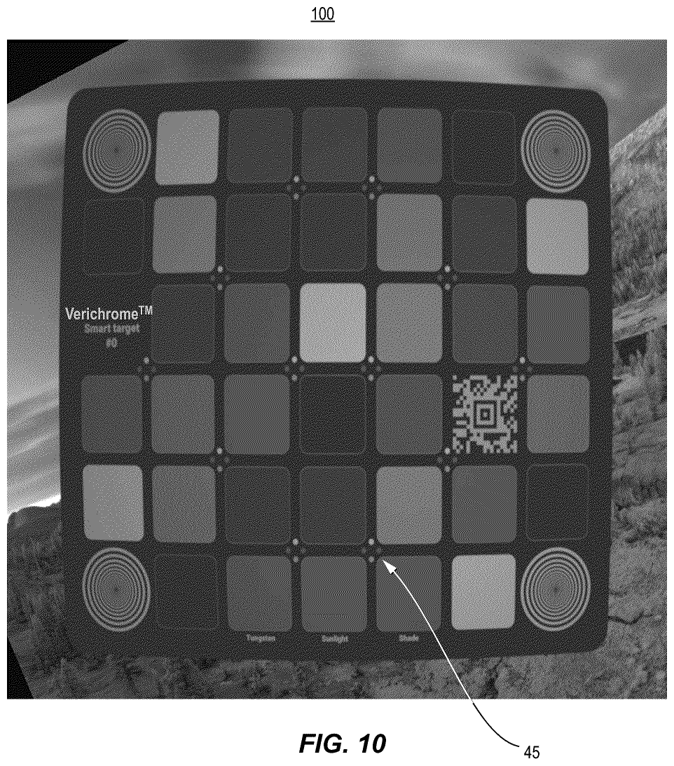

The color target 40 also includes FFT “bullseye” corners 44. The bullseye corners 44 are used to perform rough position detection and alignment. The “bullseye” patterns of the corner fiducials were chosen because they can be quickly and reliably detected at any scale and in any orientation (FIG. 4, FIG. 6, FIG. 8, FIG. 10). This eliminates the need for a user to align the color target 40 in any particular way. The software can automatically register the alignment. Importantly, the pigment patch 41 species, order, and placement of markings is not constrained to the illustrated implementation, and may be determined by the color target class, kind or type, which is readable by scanning the QR code 50. This allows the color target 40 to be made in multiple configurations, with various patch counts, and is useful to enable added features to be determined in the future.

The color target 40 may include a human-readable identification 42 that may comprise one or more of a logo, title, and serial number (not shown) of the color target. The color target also preferably includes a “Quick Response” (QR) code 50 (FIG. 5A, 50a). It is anticipated that in various implementations, a barcode, Aztec code, Round code, or other optical mark capable of encoding identifying information may be used in place of the QR code 50. The QR code or other optical code 50 is used to provide the software operable with the color target 40 with the ID number of the color target and optionally with other relevant information. For security, the QR code may also include a unique challenge message generated by the system to confirm the identity of the color target 40 and user via a secondary confirmatory response.

Examples of conventional color target cards are described in U.S. Pat. No. 9,823,131 to Vogh (X-Rite), U.S. Pat. No. 8,610,777 to Bengtsson (QPCARD), U.S. Pat. No. 8,743,137 to Peters (Edgenet), and U.S. Pat. No. 9,894,340 to Holub (Rah Color), for example. U.S. Pat. No. ______ (Ser. No. 17/581,976) to Spiker, which is incorporated here in full by reference, teaches that each color target is individually characterized with a scanning spectrophotometer for greater accuracy, and the reference color data that is recorded is accessed (through the cloud) when the camera reads a glyphoptic ID code (FIG. 4, 50) displayed on the front of the color target card 40. The camera stores the reference data so that future camera color profiles can be created at will by capturing an image of the color target, and in fact continuous color remastering may be achievable by keeping the color target in the image frame, for example. Using AI, the image of the color target card may be removed in post-production if not cropped out, or an initial remastering may be performed just once-before the clapboard signals the start of a shoot.

FIG. 4 and FIG. 6 is annotated with lettered pigment patches, each patch 41 having a specific function. The plurality of white and black pigment patches W (41w) and K (41k) for example may be used to generate a vignette correction map. Pigment patches W are all identical and all comprise the brightest spectral neutral possible given colorant constraints. Pigment patches K are also all identical and are as dark as possible given colorant constraints. Pigment patch G and pigment patch L are each a spectral neutral grey that conforms to accepted colorimetric standards. Pigment patch G and pigment patch L differ in that pigment patch G is a fifty percent reflectance, while pigment patch L is fifty percent LAB space grey (i.e., 18% reflectance). By using newer paints containing calcium carbonate and barium sulfate, white surfaces achieving 98 or 99% reflective white have been reported without specular glare. Blacks based on carbon nanotube powder have no detectable reflectance.

Pigment patch F (41f) is a fluorescent indicator pigment patch which is used to display to a user or to a machine vision device the amount of UV present, roughly, in an image. Pigment patch R is used to measure the level of infrared (IR) contamination or leakage in an optical device or scene.

Pigment patch P (41p) exposes a “fugitive” pigment selected to indicate any physical damage to the color target 40 during its useful life as caused by ultraviolet (UV) light, or harsh chemical exposure, for example.

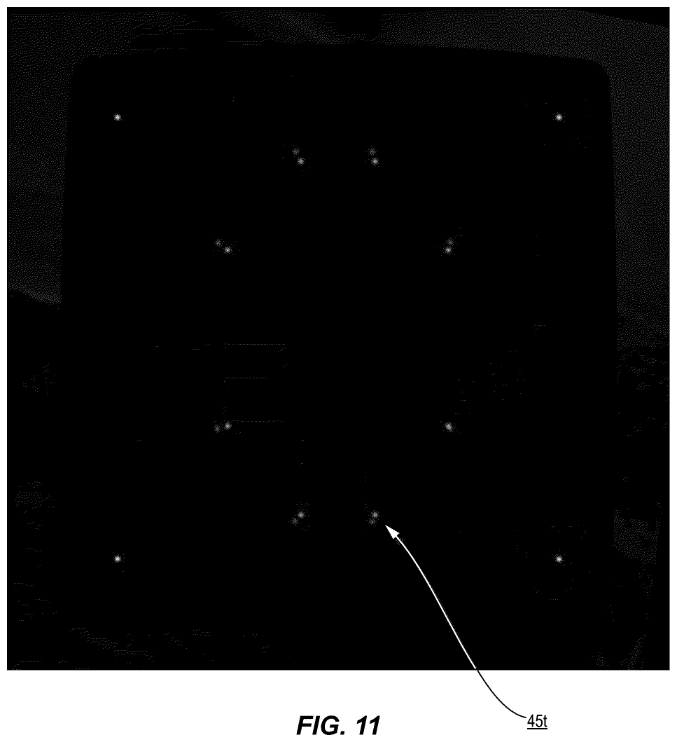

There are fine alignment marking dots 45 arranged in a white-red-green-blue diamond to aid in orientation discovery and distortion correction between the thirty-seven pigment patches of the grid (FIG. 4). The locations and location pattern of the fine alignment marking circles 45 are selected for reliable detection and distortion correction (as shown for example in FIG. 11).

Pigment patches T, S, and D (45t, 45s, 45d respectively) are used to provide a visual indication to a standard observer as a check for metamerismic lighting conditions, filters, etc. If a standard observer looks at each patch under each respective light source (in the illustrated implementation; tungsten, sunlight, and shade) the left portion and the right portion of the pigment patch (dashed center line) will visually match, indicating that the lighting condition is what it is assumed to be. Tungsten lighting causes patch 41t to appear as a one-tone patch, sun or daylight causes patch 41d to appear as a one-tone patch, and shade causes patch 41d to be one-tone—as handy referents. If these telltale color patches are unexpectedly split (i.e., don't match), then the lighting conditions should be investigated. Metameric indicator patches may also be provided for fluorescent, xenon, or halogen light sources, for example.

The surface of the color target tool generally includes one or more of trade markings 42, computer readable optical codings 50, coarse Fourier Fast Transform (FFT) registration marks 44, and fine alignment markings 45. shown here as tetrads-white-red-green-blue diamonds to aid in orientation discovery and distortion correction between the thirty-seven pigment patches of the array. The locations and location pattern of the tetrads are selected for reliable detection and distortion correction as shown for example in FIG. 10.

The matte finish on color target 40 (as a uniform layer over pigment patches) is designed so that the color target provides reasonably consistent color regardless of the viewing angle. The color target 40 matte finish includes an anti-reflective (AR) layer or layers that eliminates any mirror-like reflections that can interfere with color consistency and accuracy.

In its form as patented in US the color target device comprises a) a color target surface on which are disposed a plurality of colored target patches arranged in a non-random pattern; b) the color target device further comprising identifying indicia and alignment indica disposed on the color target surface; c) wherein the device is configured for automated operation with an associated digital image capture system having a processor and processor-executable machine readable instructions with supporting logic circuitry, such that the digital image capture system is able to capture a calibration image of the color target surface under a scene-referred illuminant, and perform automated steps for:
a) reading and assigning a machine color value to the colored target patches in the calibration image;
b) reading the identifying indicia and identifying the physical target card;
c) reading the alignment indicia to map and identify individual colored patches;
d) comparing the machine color values of the individual colored patches to known factory color values recorded under a standardized lighting condition illuminant; and,
e) generating a color profile assignable to the digital image capture system by which any digital image captured under equivalent lighting conditions by the system is remastered so that such colors as a present in the digital image are rendered by an associated display according to one of an illuminant selected from the scene-referred illuminant, the standardized lighting condition illuminant, or an illuminant selected by an operator of the system.

The color target thus is part of systems for color remastering and is designed as a convenient tool for photographers, cinematographers, and digital color experts. The use of a cloud assistant or URL at Verichrome. * that supplies needed data that surmounts the problem of supplying device-specific information to the end user on demand. Each device as shown here includes an optical code, we term a glyphoptic, that is useful to access this information and validates traceability of the color target. Thus the color target is, in a first embodiment, a metrological standard for certification of color in digital images. The fiducials and related indicia permit the calibration of a camera to be automated, an advance in the art.

FIGS. 5A and 5B illustrates an exemplary QR code patch 50a and a “round code” 50b as codes for computer optical identification of individual color target tools. These indicia may relate to the genus or species of the color target tool, but may also provide a unique target-specific individual identifier.

Referring to FIG. 5A, the QR Code indica 50a may be isolated with a mask and a threshold applied to break down the black and white code elements. The QR Code image is then fed to an optical code reader of the camera 70 for example. FIG. 5A shows an exemplary QR code 50a having the following sample data. In the QR code of FIG. 5A the data includes:
“Verichrome!RyAPrwOuJKdK 0”
Check data=Verichrome
Target type=!
Unique ID=RyAPrwOuJKdK
Serial number-0

In an alternate embodiment of FIG. 5B, a “roundcode” patch 50b may be used to optically communicate analogous information. A variety of other optical codes, including bar codes and for example, Aztec codes may be used to ensure traceability of the certification process for remastering of digital color in images. Those skilled in the art will understand that variant optical encoding marks are readily generated and used.

FIG. 6 illustrates another view of color target 40, where selected pigment patches are identified according to their individual properties. Colored pigment patches are numbered one through eighteen, white patches are marked with as “W” (41w) and black patches are marked with a “K” (41k). Also labelled are the greys G and L, the P, F, and R patches, and the metamerism indicators described above.

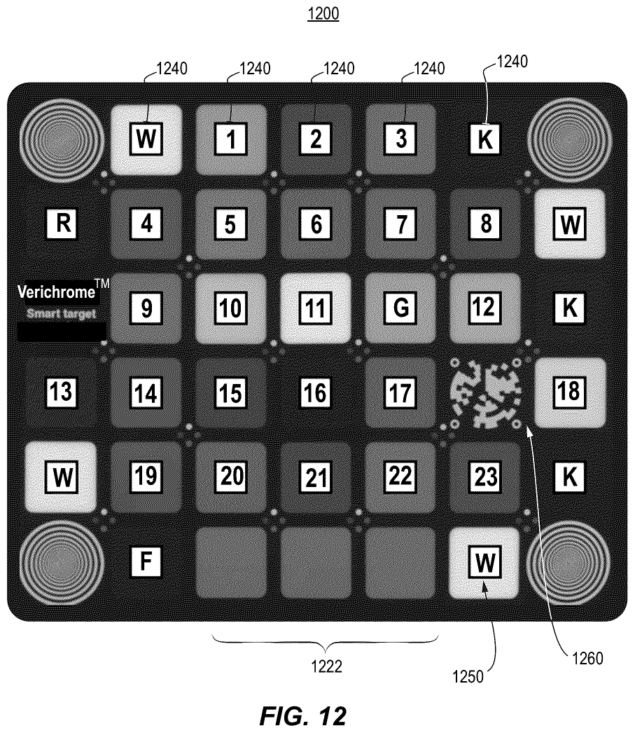

Referring to FIG. 6, using the isolated digital image (40i, FIG. 7) of color target 40, the patch color and greyscale values are then read to memory by averaging center portions 1240 (FIG. 12) as defined by the target type and software. The white and black patches (i.e., pigment patches “W” and pigment patches “K”) are distributed to ensure that any vignette profiling is detected. The patch data is dark frame corrected and flat field corrected based on the vignette profile. The client software sends the target serial number and unique ID to the server (not shown) with the data. The resulting data is stored for camera color profile generation. Optionally the spectral SPD data is retrieved from a local smartphone or from the server. The data is preferably encrypted by a client device private key. The data is preferably decrypted on the server side and the serial number and unique ID is checked against a database. If there is a match, the file with factory spectral data and pre-calculated color values is sent to the user device using the same end-to-end encryption. The factory spectral data and pre-computed color data is stored in non-volatile or flash memory and is available for use on camera device 70 (FIG. 7) as many times as needed or until the user removes or overwrites the factory data. A three-by-three transformation matrix may be calculated using a best fit solution and is preferably returned to the user in the form of a tag on the input digital negative (DNG). Image data may be containerized in memory and may include embedded input device transform (IDT) tags useful in manipulating the illuminant and device sensitivity as described below. The IDT may also be tailored for the human eye and the user may make a choice of colorspaces, such as XYZ, LMS, HVS, LUV, REC2020, CAMO, TM-30 and so forth. This tag information forms the basis for a set of color remastering services enabled by the software and host server. In a preferred embodiment, data is transferred in the format of VSF containers.

FIG. 7 illustrates the use of a color target tool 40 in a context of use, here for calibrating color in a digital image taken by camera 70 of a landscape 72. The color target tool may be removed from the scene after the remastering snapshot has been taken, and a second image may be taken to accurately (or creatively) represent (or remaster) the lighting and color of the entire scene. Software is used to mask and clip the image 40i of the color target from the full frame of the image 72. This can be performed automatically in the camera, in an associated smartphone, or by using a cloud assistant.

FIG. 8A provides a sense of the automated process as applied to image 80. Using artificial color, the software identifies four bright red corner marks of the color target as held here by a subject. The FFT pattern (red circles, 44i) includes multiple circular motifs, but the four corner marks 44i are bright scarlet and are readily identified by the software. This provided a coarse localization of the color target on image 80i for subsequent analysis. FIG. 8B provides an image 82 that gives a sense of the FFT process. The software operates to scan the image, detect the color target, and refresh the image as required to complete the analysis. A tripod is not necessary.

In FIG. 9A, continued automated processing of the FFT image 44i yields four dark spots 44x, one at each corner of the image 44i of the color target of FIG. 8A. The normalized outline 80i of the color target tool is faintly visible. FIG. 9B shows an initial transformation applied to the four dark spots 44x of FIG. 9A.

FIG. 10 illustrates a distortion map created using pixel shifts and channel mixing of the pigment fine alignment markings 45 of the color target tool. This is sufficient to track the patches of the color array and to sample colors needed for remastering. The distortion map also validates the QR Code, even when the color target is not steady, is held at an angle, or is viewed with a fisheye lens. FIG. 11 illustrates a distortion polynomial which is found for the best fit of the fine alignment markings 45t as applied to the image data of the image of FIG. 10. Obtaining a quality color sample from this tightly registered remastering target is facilitated by the fine alignment markings 45t.

FIG. 12 illustrates the color sampling process for color target device 1200. The camera, smartphone or cloud is able to take an image of the color target and parse out the color patch array with high precision. Samples are taken near the center of each patch (boxed area 1240), The QR Code (or related optical identifier) ensures that the correct color pattern is applied for remastering. Each patch includes a homogeneous matte finish color area 1250 suitable for spectrophotometric sampling during remastering and use. This exemplary target includes twenty-three color patches plus a set of white 1240w, blacks 1240b, greys and a fluorescent patch F, infrared overflow R, and also split targets designed for visual detection of metamerism (1222). This color target tool includes a round code 1260 for reading by software or firmware used by the system in association with the color target tool. Up to a hundred color patches may be included if desired, for example.

The software is configured to compare color values captured from the color target card by the optical device to known factory color values, and to generate a profile that is assigned to the optical device. The software may store the IDT for continued use, and the IDT will remain accurate as long as the same lighting conditions persist. The profile operates in a digital image pipeline to standardize the color to a reference condition that can then be reliably remastered for consistency, accuracy, color matching, or for capturing creative intent in a reliable and robust pipeline.

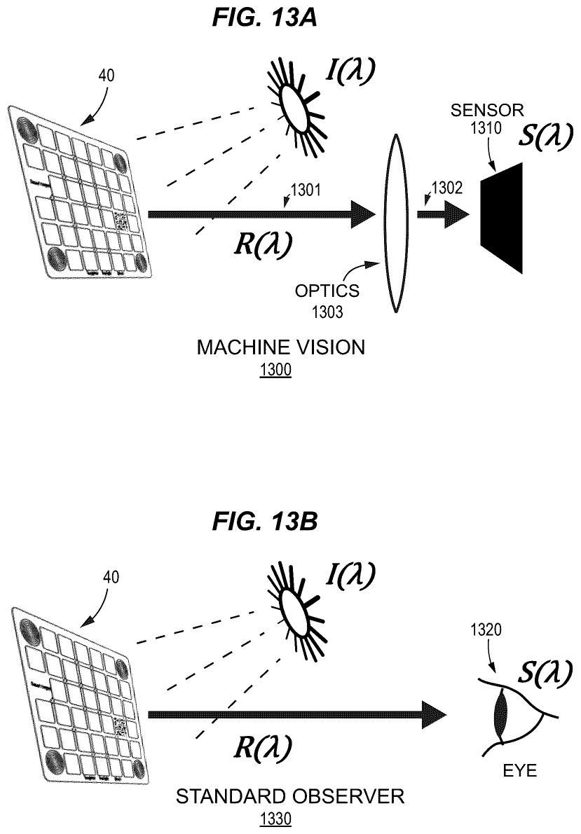

EXAMPLES II and III illustrate the mathematics more formally, while FIGS. 13A and 13B illustrate the notations graphically (after WENGER_2003). In physics, a spectral power distribution (SPD) describes the power (in W or candelas per unit area) and can be distributed per wavelength of light. As used here, an SPD is a power function over a range of wavelengths λ (in nm) of the spectrum, and is treated binwise, indicating the power density per discrete spectral bin. Total intensity is also sometimes given the unit term “nit”, a unit more commonly applied to display screens, but corresponding to candelas/m² and interconvertible with W/m².

FIG. 13A illustrates a machine vision process for reading color patch values from the digital image 80. The analysis generally follows Eq. 1 and relies on solving for I, R, S and the resultant color c′ Each color in the image 100 is compared to a reference color recorded under standardized lighting conditions for color target 40. Optics 1303 generally refers to a camera. Light rays from a radiant light source I(λ) are reflected 1301, R(λ) from the target to the aperature of the lens, light rays 1302 extend from the optics to a camera solid state sensor 1310. Within the system, an IDT with transform(s) is calculated for machine vision characteristics and scene-referred lighting conditions. The IDT is attached to the image in the form of metadata when exported from the machine vision device (not shown).

FIG. 13B is a schematic of the principal components of light as emitted by a radiant light source I(λ), as reflected R(λ) from a color target tool 40, and as enters a human eye 1320, where it is interpreted S(λ) as a color \grave{c} by the lateral geniculate nucleus and visual cortex. In this instance, the human eye is conventionally taken as the “standard observer,” which refers all color annotations to a CIE 1931 XYZ reference model. While somewhat analogous to the machine vision model shown in FIG. 13A, in practice the photopic human observer introduces a significant level of neural network learning into the process for distinguishing and naming colors.

For analysis, we use the term Illuminant, I(λ), to refer to the SPD of a source of visible light such as the sun. We will distinguish I_{ref}, the reference illuminant under which the SPDs of the color target were measured and archived in a remastering library; I_{cur}, the current “on-scene” illuminant under which the image was taken; and Iₐᵢₘ, the target illuminant that we may chose to substitute for the reference illuminant.

The spectral reflectance, R, is normalized as the ratio of energy reflected by the surface to the energy incident on the surface as a function of wavelength. The parameter r(λ) takes values in the interval [0, 1]. The SPD of the light reflected from a surface, I(λ) (“ell lambda”) is then modeled binwise as the SPD of the illuminant weighted by the reflectance of the surface

$$l ( λ ) = r ( λ ) i ( λ ) . \qquad ( Eq . 2 )$$

This model is consistent with long-standing literature, such as Retinex Theory (LAND_1973, McCANN_2017). As a consequence of (Eq. 2), the reflectance exiting from the patches on surface 40 can be immediately obtained as the ratio of incident and reflected light:

$$r ( λ ) = l ( λ ) i ( λ ) . \qquad ( Eq . 3 )$$

Note that this approach is less robust to noise in low light situations (i(λ)→0) and strictly fails for obvious reasons in the limit (i(λ)=0).

By “S(λ)” we refer to a machine sensor or “Observer” (sometimes written as “0”) sensitivity as the function s(λ)∈R^{M} that specifies the sensitivity of M distinct color sensors over the physical spectrum. Each color sensor has a range of color sensitivity termed its “channel”. The index m=1, . . . , M identifies the corresponding color channel, Iₘ(λ). For this first example, the color channel dimension is M=3 for human color vision because humans have three cone types L, M and S. But other values for M∈ [symbol] are possible, such as M=4 for red, green, blue and yellow channels (RGBY), or M=6 for a camera or an insect having six channels with unique spectral responses. Machine sensors and non-human “observers” are not limited to the visible light range. The equations may be extended to any hyperspectral wavelength range as needed. Examples of well-characterized observers are the three-channel CIE Standard Observer, sCIE, or the sensitivities of a particular camera sensor, s_{cam}. Multispectral cameras with up to 9 or 16 channels are increasingly available, and the equations are readily adapted for them.

The linear response Cm of an observer m to an incident SPD L(λ) is modeled as the integral (or binwise) of the SPD weighted by the observer sensitivity sₘ(λ) (over a reasonable range of wavelengths λ):

$${c}_{m} \int {s}_{m} ( λ ) l ( λ ) d λ \qquad ( Eq . 4 )$$

Together with (Eq. 2), an M-channel observer will therefore sense the following M-dimensional color vector c∈ [symbol] ^{M}, as given in Eq. 1 (FIG. 3). These equations apply to digital images universally.

No matter what imaging modality is selected, image analysis is increasingly automated. Images have become essential in remote sensing, medicine, biology, and computer vision. Indeed, images can provide deeper insight about the reality around us than vision alone. In the visible spectrum, they tell us something about our environment and allow us to navigate safely or reach for objects. Images, however, extend also to other spectra and allow us to see through objects or measure quantities at very small scales. In medical imaging we extract information from images about a physical reality that is otherwise inaccessible.

Mathematical analysis of images involves an ensemble of individual problems such as denoising, segmentation, classification, decomposition, with the aim of getting more information about physical reality and image structure or layers out of images. Mathematically speaking, most image-related tasks are instances of inverse problems, where one is given a set of derived measurements and looks for an underlying, hidden layer of information. The key to tackling large data sets rests in the smart exploitation of problem structure and sparsity. In general, there is a strong convergence between problems and methods in imaging on the one side, and data science and machine learning on the other side. Maybe more unexpectedly, one important class of partial differential equations bears strong similarities in its applications for both imaging and data problems. Indeed, elliptic PDE, which are commonly found in scientific computing, mathematical physics, material science, computer graphics, and consumer electronics, correspond to “convex optimization problems” of the same form as those encountered in imaging and data science. Solving these PDE more efficiently increases the range of problems that we are able to handle computationally, and competes with least squares error minimization in generating fits. Remastering is configured for constrained optimization when needed and can be integrated into digital image capture, analysis, editing and rendering devices, as will be shown here.

The spectral character and distribution of reflected light 1301 is very much dependent on the spectral character and distribution of the incident light, and any change in incident light will be reflected in revisions to the solution for Eq. 1. While a color target 40 is shown as the source of reflected light rays 1301, any subject that is not fully transparent will result in a reflection of at least some of the incident light into an optical aperture (lens), shown here with optics 1303 and sensor 1310. The camera optics will result in some scattering loss, loss due to numerical aperture, and loss due to absorbance and filtration 1302 before the light reaches sensor 1310. Thus remastering of an individual optical device with solid state sensor 1310 will not be directly usable with any substitute optical device, even if only a lens 1303 is replaced. Any change in the illuminant I also requires a recalibration. And to be considered is whether the excitation output from the optical sensor is to be reported (by a machine) to a human eye, or is to be stored in its raw form as a digital file for future machine use. When colors are re-expressed for display in values that the human eye can appreciate, Eq. 1 is necessarily modified to reflect the eye's more limited capacity to appreciate electronic display or printer colors. Output device transforms (ODT) are used to convert the raw light input information into an electronic or printed output display that the human eye can see and appreciate.

When considering machine vision 1300, the character of light source I(λ) as daylight, candlelight, incandescent light, light from artificial sources such a fluorescent tubes or LEDs, for example, gives rise to incident and reflected signals over a large range of the spectrum. Light from the sky, for example, is not limited to the range of human visual sensitivity, but has a range from deep UV to tens of thousands of nm, extending into the microwave and radiowave spectra. Light in the far infrared is sensed as heat by humans if it is sensed at all, and light at longer wavelengths is an invisible form of energy, but can be visualized if it is detected with a suitable sensor and transformed so that a pseudo-color is supplied to map the virtual image to our visual spectral sensitivity, for example. Invisible UV can be used to add “whiteness” to colors humans would define as white. Thus machine vision is a much less easily fooled tool than the human eye. Nonetheless, the mathematics and algorithms used here in machine transformations 1300 of light to digital information are equally applicable to the human eye 1330, with the important exception that the human eye includes a neural processing unit with millions of parameters by which the brain fills in details and interpretations of a visual scene that the eye may not actually see. Yes, human vision is a creative act that gets better with experience and learning, combining multiple senses that include tactile, proprioceptive, and motor functions to interpret visual input.

For general purposes, the typical fovea has a sensitivity of about 400 to 700 nm, 380 to 720 at best, with optimal color sensitivity at about 450 to 600 nm. By our analysis, in which light is digitized for processing, the analysis is essentially identical to that for machine vision, . . . up to a point. Once light has entered the eye, special rules for perception must be added to understand signals that arise in the retina and the visual cortex. For example there are major logic tracts that extend to the ventral cortex and the temporal cortex that are beyond the scope of this report. The optical nerves first target is the lateral geniculate nucleus, which is closely associated with the thalamus and amygdala; hence there are powerful direct connections between the eyes and the emotional responses of the limbic system. Many muscle reflexes begin in the eye and are wired directly to striated muscle via the spinal cord and cerebellum or parietal lobes. These complex neurological overlays to perception and awareness remain the subject of intense scientific research and will not be reviewed here in any depth. No, the eye triggers much more than just a blink reflex, perception of color can have a profound effect on mood, behavior and personal interactions.

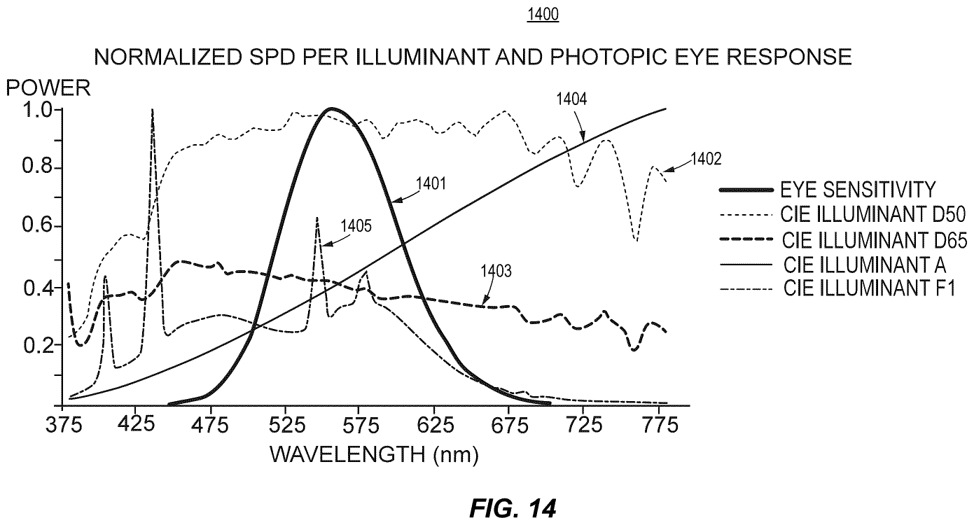

FIG. 14 shows a set of spectral curves 1400 for four standard light sources as defined by International Authorities [CIE D65 1402, CIE D50 1403, CIE A 1404, CIE F1 1405) and superimposes on those curves the limited spectral window (dark solid line 1401) that defines the window of sensitivity that the human eye is capable of interpreting as color.

Various standard illuminants have been proposed, including CIE D50, CIE D65, CIE A, and CIE F1, where CIE is an international color standardization institution (Commission Internationale de l'Eclairage, Vienna, Austria). Note that CIE D65 and D50 are broad spectrum daylight illuminants, illuminant A is a black body incandescence typical of a tungsten lamp, and illuminant F1 is a sample fluorescent lamp. However, with this mathematics and a suitable computational aid, creative or industrial use of any desired lighting and colorspace may be achieved. While REC709 and REC2020 approach current state of the art, much improvement is still needed.

A challenge in digital photography has long been the interest in capturing image color as SPD data. While historically, the SPD datasets have been considered to be too large, recent advances in memory and processors are at the cusp of enabling this capacity routinely. Most digital images, including cinematography, are shot in compressed form such as JPEG or RGB, in which color coordinates are used to summarize pixel color rather than SPD. This lossey compression has the disadvantage that information is forever lost because each color that is not monochromatic can be reproduced by mixing a variety of colored lights (law of superposition leads to metamerism), and given that the illuminant determines in part the color of the reflected light that enters the eye or the camera's aperture, any attempt to remaster pixel color in archived digital images confronts an insoluble dilemma, that without knowing the illuminant component, the reflected component cannot be known, and hence the true color of any given element in the digital image is guesswork, a metameric puzzle with more unknowns than knowns. A large body of work in this century has been devoted to lossless compression in which a smaller digital image file is produced, but the color assigned to each pixel is somehow presumed to be a “ground truth” color selected from an RGB cube. Given the limitations or color sensors of cameras and color display devices, this promise is an empty promise. In this work, we will show a rigorous scientific solution for this decades-old problem.

Ironically, some devices and firmware packages offer “lossless” compression, but the images are captured in a deeply compressed color model. Thus, while the processing may be lossless, the image is qualitatively very lossey.

FIG. 14 demonstrates the sensitivity “S” (Eq. 1) of the human eye, as is termed the “standard observer,” The sensitivity is the combined sensitivity of the three cone types, Long, Medium and Short over the spectral range of 380 to 780 nm. Peak sensitivity of curve 1401 of the eye is in the mid-greens at about 550 nm. That is not the whole story. Much work has gone into characterizing purples for example as a “negative chroma” of red by a retinal “opposites” physiology that is neuronally embedded in the sub-500 nm response of long cones in a first layer of retinal ganglia. What is clear is that the light that produces what we call “color” is not bounded by the limits of the tristimulus/trichromatic model used for the human eye, and hence a whole new industry of machine vision is opening up that may include hyperspectral color fields and augmented reality. To recover accurate color from an image in such a way that both human color vision and machine color vision are treated by one unitary mathematics, the rigorous approach taken here first maps the total reflection intensity to channels of the color sensors, then solves for the illuminant as a spectral curve before applying the “S” sensitivity function of the sensors (using either the cone sensitivities of the standard observer or the camera sensor sensitivities of a machine observer). In the case of machine vision, conventional output is a coordinate or tuple, but this work postulates that a closer approximation of an SPD is possible, and that, where possible, use of SPDs is advantageous.

FIGS. 15A and 15B demonstrate a contrast in information density. FIG. 15A is a 3D plot of a TM-30 color target (ROYER_2016) as presented using coordinates J′, a′, and b′ (with ninety-nine colors). Because the TM-30 colorspace is a cylindrical polar color system, the colors have been converted to a more conventional x, y, z-style Cartesian coordinate colorspace and presented on three axes not unlike the color model the RGB cube sits in. If the RGB cube was presented here instead of TM-30, or any conventional colorchecker, the differences would not modify the concepts.

In FIG. 15B, the same TM-30 colors are presented as ninety-nine SPDs in 2D, each SPD spanning 380 to 800 nm. Despite the loss of one dimension, the SPD plot conveys much more information than FIG. 15A. When these SPD plots are superimposed according to the SPD of the Illuminant I(λ) on a scene that is imaged, then the color of the scene is very well defined. In contrast, the colors used in an image based on the data provided in FIG. 15A is more like a look-up-table (LUT) with banding and noisy contours, cannot possibly be solved for metamerism because it is “flattened”, and again is deficient in its greens, having essentially the same weaknesses as the RGB cube.

A spectral power distribution of the reflected light from color target 40 is given in FIG. 15B. The spectral domain can be visualized in a simplified concept as the output a beam of white light dispersed through a prism, but these are monochromatic colors of the spectral locus (3, FIG. 2). The spectral domain inside the spectral locus is filled with mixtures of monochromatic colors, and with mixtures of apovisual colored light outside the visible range, so the true impact of Eq. 1 is to present a unified concept of digital light as a cloud of excitations, not as a set of a few tuples X, Y, Z or some look-up table with the 256 colors of the JPEG palette, for example. By calculations in which the entire cloud is weighted, a much more scientifically accurate and realistic display can be achieved that can be modified to fit the observer, be it a human, a butterfly, or the Webb telescope. Also, the information as displayed, unless flattened downstream from the sensor chip exposure engine, retains the full spectral gamut so that any transforms that are applied do not lose data—i.e., smart compression is lossless.

In subsequent work, the integral to Eq. 1 is solved by binwise discretization using matrix algebra with a twist. The mathematics is independent of the number of bins, the bin size, the spectral window, the number of channels or primaries, and the choice of observer. In another embodiment, with this information, the image can be re-lit by substitution of other illuminants. Use of partial derivatives will be introduced subsequently.

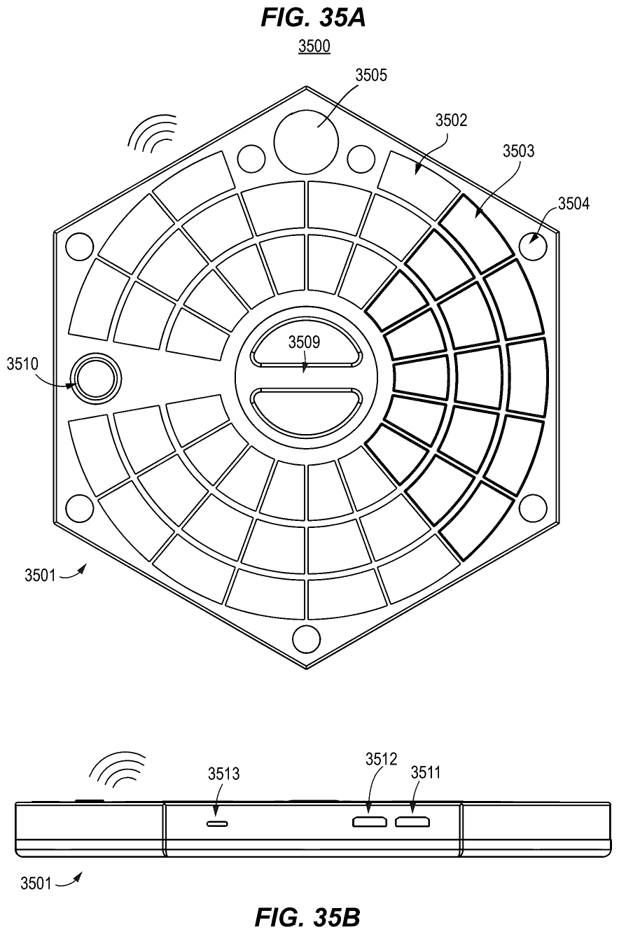

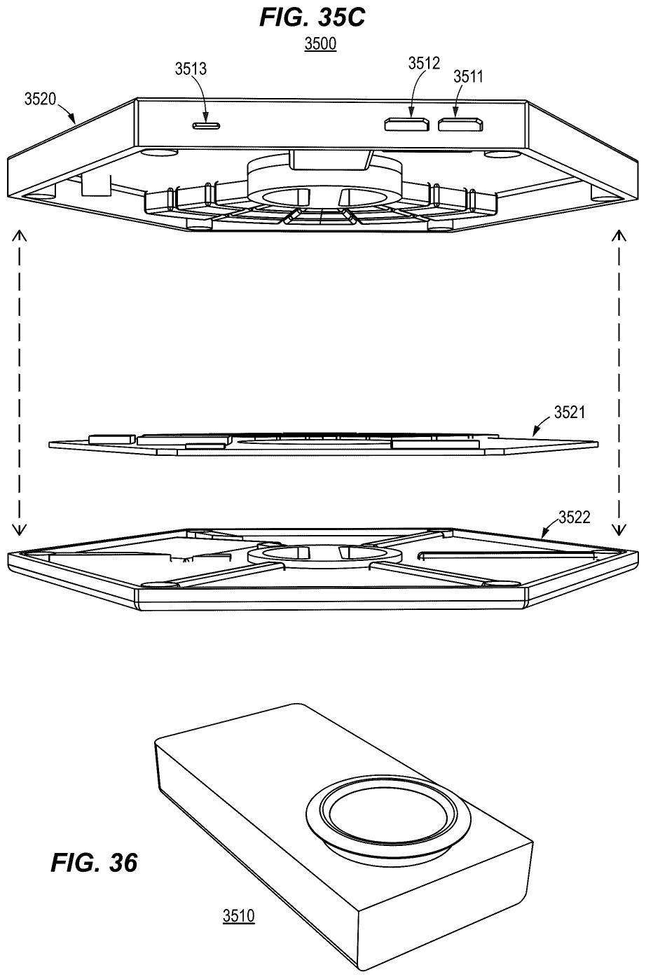

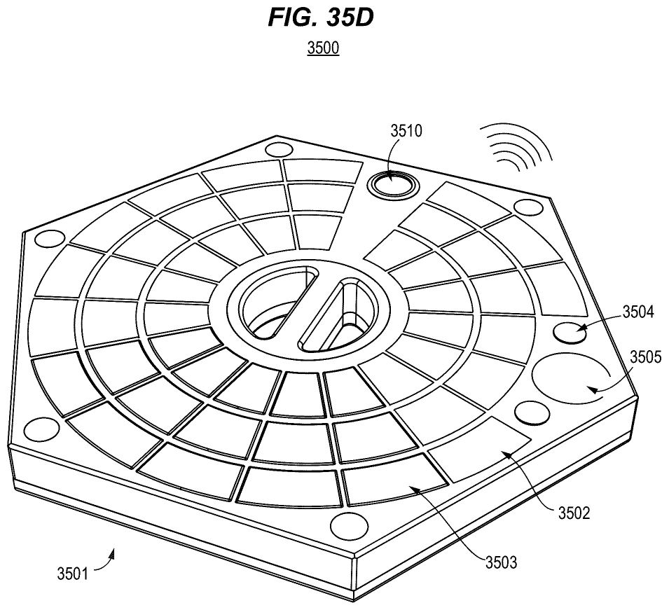

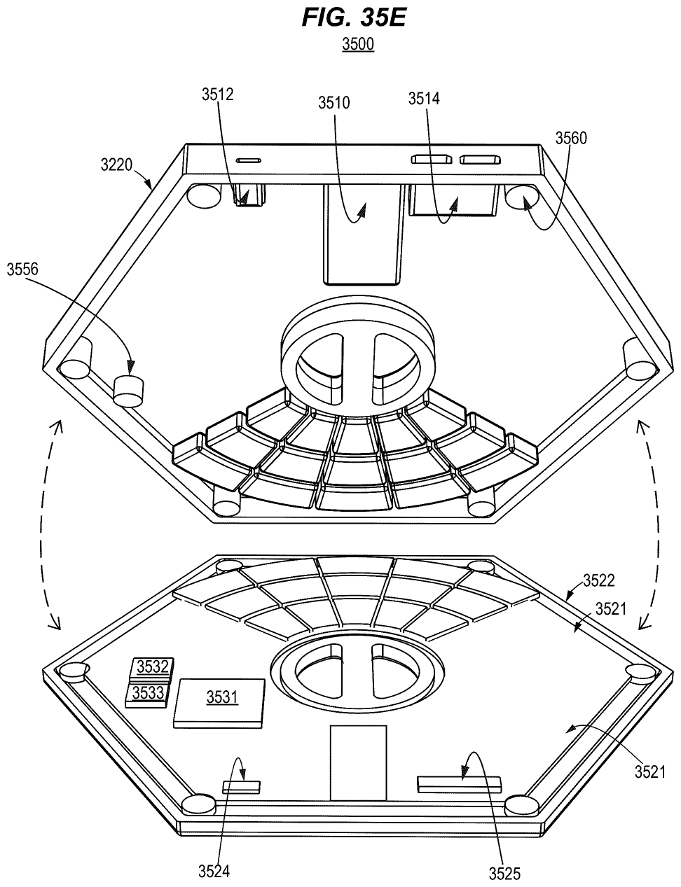

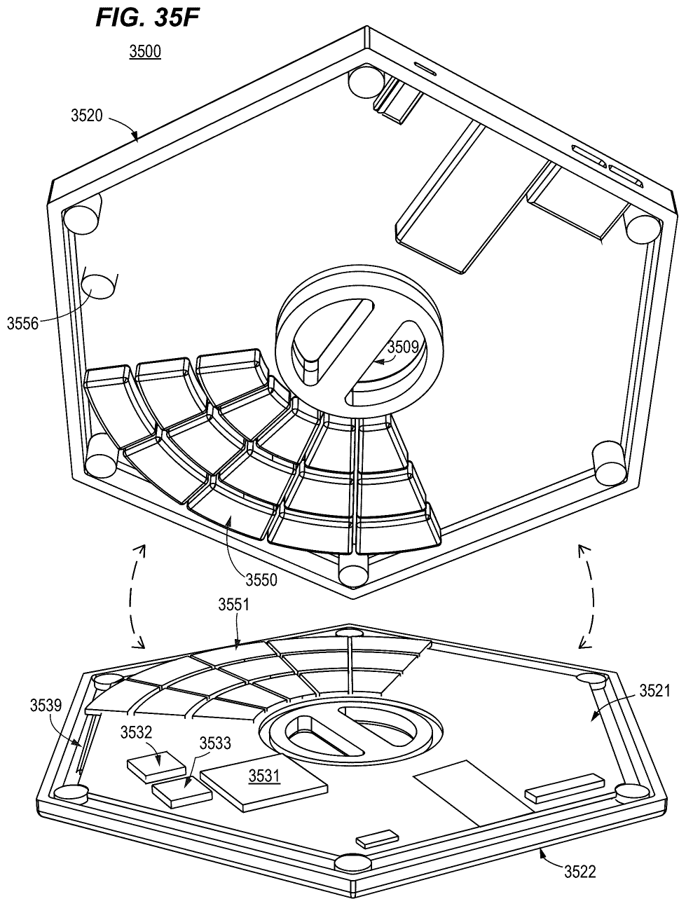

SPD data of the spectral domain as captured in a digital image is a much more robust record of the full spectral power of the illuminant, reflectant (and radiant) light and is free of assumptions about the observer sensitivity. SPD data lends itself to calculus, but in order to simplify the calculations, binwise linear algebra offers good approximations. Unfortunately, at 2 nm or even 5 nm wavelength bins, the information density in SPD data per pixel is still very high for large format photographs or videos, and hence it is only recently (with advances in visual processor units (VPUs, FIG. 25,2520; FIG. 35F, 3531) and the drop in DRAM memory prices) that imaging in the “spectral domain” has begun to leave the laboratory. While RGB continues to dominate consumer electronics, scientists have recognized the value of SPD data and seek the tools to collect and process it. “Upsampling” is a weak alternative, but is also under study as less desirable estimation. Given the improvement in newer display quality with an increase from three primaries to four or six, the combined improvement by using these new displays with SPDs is magical.

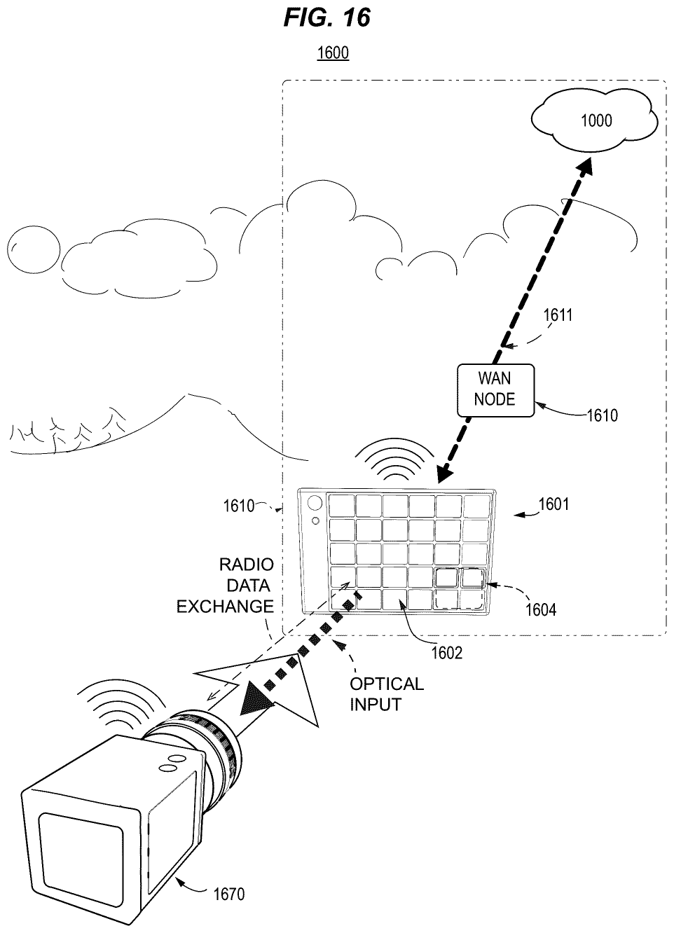

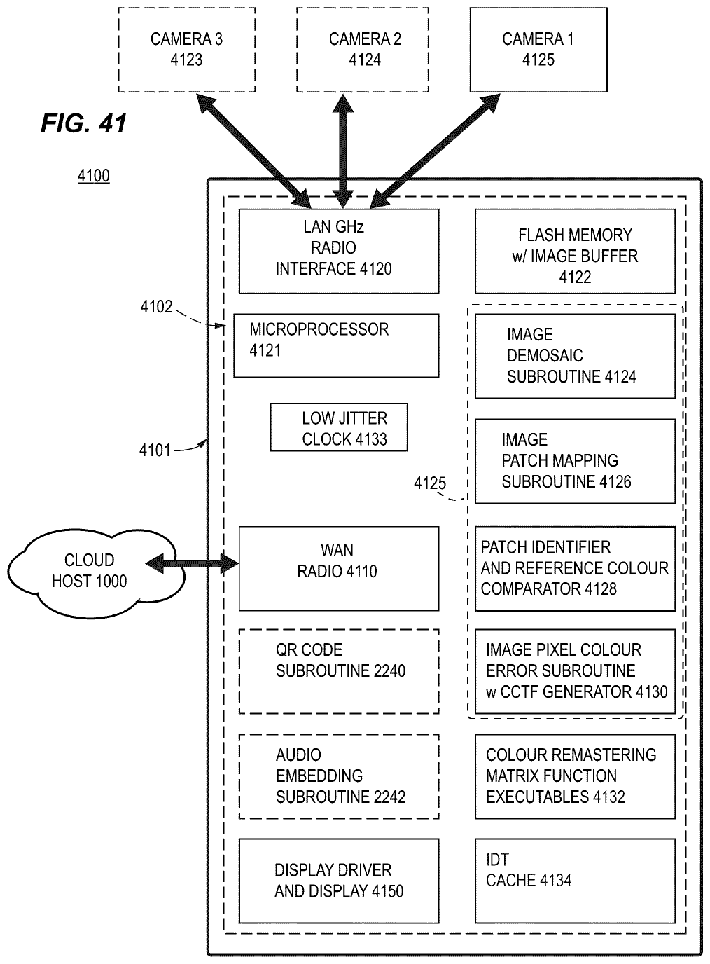

This returns us again to the need for quality by remastering and data management. FIG. 16 offers an innovation 1600 that unlocks the potential of spectral data. The ‘smart color target’ 1601 is transformed into an electronic processing center capable of generating emissive colors (as needed for today's brighter display screens), capable of transmitting data by radio (given the difficulties of wired connections), and communicating with the cloud 1000 and all the resources of the cloud (either directly using Wi-Fi, or indirectly via smartphones or laptops). The availability of Starlink portals is one example of how a smart color target can find its own path via WAN node 1610 to a cloud resource center dedicated to color imagery. A smartphone provides another alternative node. The smart color target includes reflective color targets 1602 (as an array) and emissive color targets (as an array) 1604, enabling both relative and absolute remastering over the visible spectrum and up to radiant intensities of 2000 nits (FIG. 41) as currently practiced, or higher. Blacks begin at 0.0002 nits.

By including LEDs in the color remastering profile, the photographer will be able to keep up with the latest evolution in color image standards and colorspace definitions, which are expected to go beyond the limits of RAW, DNG, SRGB, ACES, CAMO, TM-30, VSF or OpenRAW and may involve re-engineering of color sensor chips. Just as Kodak color film and Technicolor cinematography were once the gold standard, there will be new standards for digital images, and color remastering and remastering from a customized IDT that is stored with the RAW images preserves the capacity of the photographer to change with the times. By use of color remastering as described, lossless curating of still images and video clips is within reach.

By supplying color profiles as metadata with the image bitstrings transmitted 1611 to the cloud 1000, the larger data sets are selectively compressed for transmission and uncompressed in a remote server environment for further post-processing. Alternatively, the smart color target is supplied with a VPU, an instruction package, and memory sufficient for local calculations (FIG. 25). A camera captures an image that includes the remastering color set (both reflective and emissive patches) of the smart color target device. The image of the patches is processed locally or in the cloud to generate an IDT that is retained by or returned to the camera, where the matrix transform(s) may be stored in memory and applied to subsequent RAW image files taken under the same lighting conditions. The IDT may be remodelled using artificial intelligence for special effects or to predict changes in the IDT that accompany changes in lighting. As shown here, use of a spectrophotometer allows the computation of updated IDTs by sophisticated color and shading processors.

Even AI is becoming decentralized for specialty applications and can be operated on a hand-held camera accessory. Visual data is the new venue for artificial intelligence and augmented reality. Supplying the radio link in the smart color target unlocks the capacity of servers to communicate directly with a variety of videocameras and still cameras, while also enabling users who are attached to their smartphones to share and modify photographs and video clips.

Users can supply a learning library of video clips to a server complex like AWS and over time a LVM will be released that is capable of predicting how to light images, where to cast shadows, how to similate a sunset, and fixing the smile on a child's face in a picture.

Color remastering, especially in smartphones, has been neglected. The color palette is garish. But using the smart color target 1601, a “ground truth” color model can be set up as the North star under standard lighting conditions, and relighting to match existing conditions or to simulate a sunny day is accomplished using the mathematics shown in EXAMPLES II and III. The color target includes a set of reflective color patches as before, and also a set of emissive color patches. The emissive color patches are used to automatically check or adjust the spectral locus (absolute remastering), while the reflective color patches automatically check or adjust the chromaticity and luminance within the visual gamut (relative remastering). These improvements return more natural colors and minimize banding and metameric mismatch artifact.

There is increasing unease that the synthetic colorization of display screen images is disruptive. KAPLAN 1989 is cited as one of the pioneers in the effect of light and color on behavioral development. MUPPALLA_2023, in a National Institutes of Health study, have reported that today's children are now spending a total of four months a year (almost 3000 hours or ⅓ of life) watching RGB screens, and while the connection to anti-social and violent behavior has not been firmly established, it seems likely that the dissonance between the ground-based colors of the natural world and the synthetic colors of phosphors has an effect in brain development, particularly given the direct connection between the optic nerve and the thalamus and hypothalamus, which are centers of emotional memory. For those working an eight-hour day on a computer and time in the evening using other display screens, there may be as yet undocumented effects on mental health and personality. Yet given the increases in productivity and safety availed by access to augmented reality and artificial intelligence, it seems predictable the eye/screen connection is likely to become even more important in coming decades.

RGB has become the default commercial colorspace for transmission and display of digital images; largely because if its association with Microsoft's ubiquitous Windows computer operating system, which once held a 95% market share. For sheer volume, JPEG is also dominant, and uses a Y′CbCr colorspace that reduces color to an 8-bit LUT. Both RGB and JPEG are lossey for color management and archiving; it is known that RGB drops about 65% of the colorspace native the human eye (even more for color visible to other organisms). The devices of the invention are foundational in improvement of “ground truth color” and in introducing spectral color pipelines into the imaging data stream.

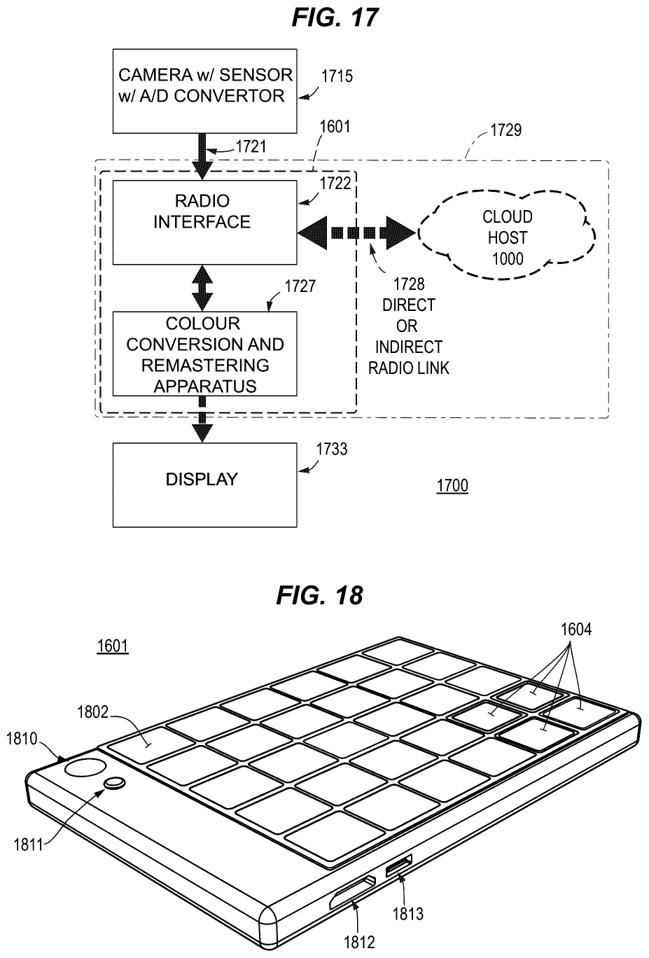

FIG. 17 is a block diagram of a system and circuitry 1700 incorporating a smart color target device 1601 with communications and computing capability for color remastering and remastering of digital images in combination with a camera 1715 and cloud host 1000. The color target device and camera may be linked via a bus or by radio as shown in FIG. 16. A display 1733 is a useful accessory to evaluate the color but much of the process is automated. The central component of the camera 1715 is a color sensor chip of three, four or six channels and associated A/D converter that takes an analog signal from each pixel sensor well and loads it onto a databus as a digital word, for example as a set of M channel outputs, each having a floating point number value. As part of the workflow the camera sends an output 1721 with the values as a formatted bitstream via a LAN radio interface 1722 to a colorspace conversion apparatus 1727, as represented here, housed in a smart color target device 1601 (FIG. 18). While the calculations may also be achieved inside the camera as an option, and perhaps with more speed, a universal radio transfer link to the device 1601 has the advantages of being more universally adoptable by camera manufacturers, of sharing a cloud link 1728, and may be achieved even in older cameras by using a radio adaptor (FIG. 19A, 19B: 1900, 1920). With a suitable radio link 1728, system 1729 may include cloud host 1000 such that a “Cloud Assistant” may function in sharing or offloading larger color processing tasks uplinked from the color target device 1601.

Generally, IDT color profile generation is performed by a color conversion apparatus 1727. The color conversion may require communication with the cloud host 1000. Information may be obtained from the cloud host about the layout of color patches 1602, 1604 on the smart color target 1601 and relevant user profile information, including timestamp and geostamp. Image files may also be uplinked to the cloud host using a wide area network WAN radio node such as a smartphone or other node operated in synchrony with the smart color target 1601. Software to operate the smartphone is readily downloaded by the end user.

This block diagram is oversimplified because camera firmware may be used to append the color conversion transform IDT to subsequent images, and hence the color conversion apparatus 1727 need only buffer and format subsequent photos or videos for transmission to the cloud 1000 or to a display 1733 for final processing or storage.

The LAN radio 1722 may be capable of interfacing with multiple cameras simultaneously, and may be able to form a mesh network with accessory devices such as smartphones and laptops. While radio link 1928 is shown as being directional to the cloud host 1000, as for transmitting digital images to the color target device, in fact commands and status information needed to establish and maintain a Wi-Fi link with the camera, smartphone, smart color target and cloud are all bidirectional so that a mesh or “peer-to-peer” network is the preferred operating mode.

Optionally, the color-converted image may be directed to an accessory display 1733 so that the viewer can check the quality of the image at higher resolution than is available on most standard cameras. This display may be the end use, for example if a live image stream is being transmitted to a video display. Video blogger apparatus is a growth industry and interesting use case. As IDT/ODT tensors are adopted, there is a significant reduction in processing work.

Returning to the above description, in a basic implementation, the smart color remastering system is operative for color remastering in an optical device such as a camera using an IDT profile of target colors that originate with the color target tool 1601. The target tool includes a plurality of colored patches arranged in a predetermined pattern on a surface. The color target tool preferably also includes identifying indicia and an alignment indicium layout which can be optical or can be radio driven. Executable machine-readable software is installed for processing digital images from the camera 1715 and is configured to read and assign a color value to the colored patches of the color target. The software is configured to identify the target tool species and unique signature ID and to read the alignment indicia for identifying individual colored patches. The software is further configured to compare color values captured on location to known reference factory color values, to generate an IDT profile for manipulating the color to match standard conditions, and may apply the same IDT color profile to future images taken under the same light. The IDT is accurate under a specific lighting condition and is intended for use in processing subsequent images under the same lighting conditions where possible. The profile operates in a digital image pipeline to standardize the color to a reference condition that can then be reliably remastered for consistency, accuracy, color matching, or for capturing creative intent in a reliable and robust pipeline that supplies a color profile chosen by the user or the system. In other words, the initial step is to remaster the digital image color to a standard reference condition automatically, but then the user may elect to apply any optical effect or AI effect desired with confidence that the underlying color is “ground truth” accurate.

To recover accurate color from an image in such a way that both human color vision and machine color vision can be treated by one unitary mathematics, the rigorous approach taken here first maps the total reflection as captured, then solves for the illuminant as a spectral curve. Eq. 1 is solved for its component parts. Eq. 1 is solved by our process that first isolates R (Reflectant) and I (Illuminant) contributions to the SPD as light enters the camera Once the base condition is met, the sa,e algorithm allows us to remaster any digital color image to substitute alternate illuminants, such as daylight, tungsten, fluorescent, halogen, xenon flash, multispectral LED, and so forth. The algorithm may also be reformulated to substitute various alternate “observers” (where “observer” refers to the spectral sensitivity of the passband capture apparatus): i.e., any of a human observer defined by a chosen colorspace or a machine observer that maps chromaticity coordinates to any chosen colorspace. With broader sensitivities available in machine vision, spectral characteristics can be matched to surface material characteristics, for example a wet road surface can be distinguished from a dry road surface, ethanol can be distinguished from water, and healthy forests can be distinguished from dying forests.

Colorspaces that include the “fingerprint” region of the near IR can provide spectroscopic characterization of the chemical nature of an apovisual element in a digital image, for example a jar of benzene in a window would have a sharp signature for ‘pi-orbitals’ of the organic molecule and the silicic oxide bonds of the glass. The skin of a live body will have characteristic signatures of hemoglobin, including identifiable Soret bands that differentiate reduced and oxidized hemoglobin, and spectral signatures that identify abnormal hemoglobins such as met-hemoglobin and sickle cell hemoglobin or thallasemia. Plant chlorophylls may be analyzed in the visual spectrum, providing the capacity to identify pathognomic signatures characteristic of iron deficiency and dehydration. Plant health may be linked to soil health, and by use of the algorithm and sensors from orbit, large areas of the planet are readily assessed for aridity and ground cover viability, for example. In other instances, pollution of bodies of water are easily assessed.

In addition, the RGB colorspace (which has been implemented for so many of our optical devices, but has serious deficiencies in representing many colors visible to the human eye) may be replaced with improved novel colorspaces using the tools described here. Users who discover that cameras and display monitors are different and are better, or at least can be corrected to have a higher quality of fidelity to the ground truth color that the eye should be seeing, are keen get started. An image is displayed as a representation of an actual scene in its native color on a monitor that preserves the color depth, shading of contours, highlights, and vividness. Synesthesia is the new mark of a successful camera/monitor-if you want to reach out to touch it, if you can see how it feels with your fingertips, you have achieved synesthesia. Consistency of representation is also ensured. Any modifications of a camera or a cinematographic stage, such as lights, lenses or filters, also result in image color distortion, but can be corrected using the apparatus and systems described here. Thus the algorithm is able to identify a subject of a digital image by multiple traits, not just by shape but by eye color for example, and the colors blue or brown are redefined so as to be scientifically accurate and can be annotated as metadata in a transmitted file. Given these gains, the improvements in biometrics offer substantial leaps in convenience for the user, who is assaulted daily by identity theft and an endless requirement for strings of passwords! Seriously, we offer to counter digital misinformation by concealing sub-pixel or spectral watermarks in images so that machines may provide a warning or take action if false and misleading images are transmitted. All images will have traceable timestamps, geostamps and user IDs. Some of these watermark calculations are large and may involve probabilities as needed to solve for metameric color combinations. A cloud assistant may be provided if local computational resources are limited by processor size or by battery capacity of a portable device, for example, but the solution is needed for year 2024.

FIG. 18 is a perspective view of an electronic color target device 1801, which contains circuitry and internal antennae for making radio links to a network 1610, four color patches 1804 that display light from colored LEDs, each with a diffuser that evenly scatters light from different colored LEDs, and twenty-six pigmented, reflective color patches analogous to those deployed in FIG. 6 (40). While not shown, the electronic color target device may contain automated protocols to display fiducials, but may also register its relative position with the camera using MIMO or UWB radio and may broadcast a radio identifier or include RFID for traceability as a certified reference. The device is battery powered and includes ports 1812, 1813 for receiving or sending data via an HDMI or USB-C compatible device or for recharging power. A power switch 1811 is included for the user.

The emissive color patches 1604 may contain one or a plurality or array of individually colored LEDs emitting selected colored light and having programmable intensity output. A diffuser is used to spread the light emitted from the patches so that the radiometric remastering algorithm of the color target reader can measure the average “nits” per patch. These emissive light sources are useful in constructing “absolute” color profiles. While only four illuminated patches are shown, larger arrays of emissive patches are not excluded and may be constructed as parts in a low profile circuit board under the diffuser assemblies of the top cover. The emissive data lends itself to immediate adjustments in camera settings such as fine tuning of the spectral locus and quantitative tone curves.

Use of a spectrophotometer 1810 on the networking device to assess the spectral properties of the scene illuminant(s) is also anticipated in networking device products of this family.

The color patches of FIG. 18 may include one or more infrared (IR) reference color patches. These patches are selected with a known capacity to reflect, absorb (or emit) light at frequencies between 780 to 1200 nm (infrared), which enables remastering of infrared cameras. Remastering using the IR patches is useful for example when using false color imaging as in night vision surveillance where an infrared camera profile is needed. Analogous adaptations may be applied when a UV patch is included for remastering outside the visible range (generally below 380 nm).

FIG. 18 is termed here a “Type K” color target array because it has both reflective color targets and emissive color targets (emission targets). Emissive remastering standards with monochromatic and white light have an added use in calibrating the spectral locus of a camera sensor and for calibrating a standard greyscale curve as measured in W/m². These electronic “Type K” targets are intended for use in doing absolute and relative remastering of optical image capture devices.

The housing may comprise a user interface by which the digital image is displayable, and by which I(λ), L(λ) and S(λ) may be manipulated. The digital image output is intended to be fed into a pipeline for digital image editing and grading. The output comprises the image or video bitstring and the metadata that is generated by a solution to Eqs. 1a (EXAMPLE I) and Eq. 1, wherein the bitstring is losslessly compressible and expandable in a RAW or VSF format according to a matrix transform or a concatenation of matrix transforms in the metadata. CAT transforms are also embedded in the output or can be generated at a cloud host or in a remote image processor. All transforms are ideally carried in the containerized data vessel so that each is applied only when needed and is entirely reversible depending on the needs of the editor or color grader. The device 1601 works with system 1600. From an ID associated with device, the cloud host 1000 (FIG. 16) may store user profiles and data relating to the layout of the color patches and their known reference color values—as is essential for calculation of the color profile for the camera. Essentially, the camera takes a “selfie” of the “smart color target device” 1601 and after receiving the color image of itself, the color target device automatically calibrates itself and completes the color remastering process so that it can return the calculated IDT profile to the camera or use the remastering in making future image color adjustments.

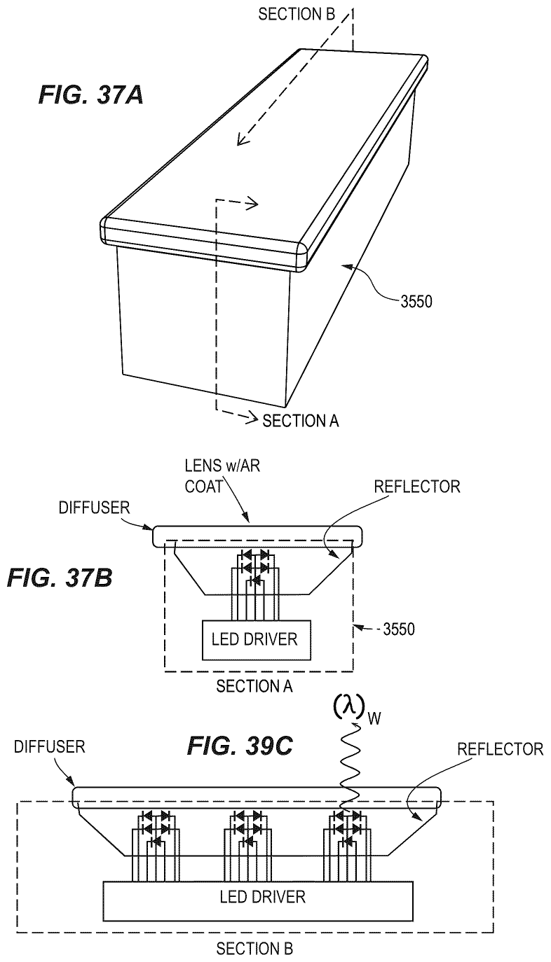

The electronic color target may also be in network radio contact with the camera, the cloud, or a smartphone and may exchange image data with minimal guidance by the user. A more elaborate user interface may be provided, for example on the back of electronic device 1601 as shown in FIG. 37A.

Not all cameras have radios, but may include a hotshoe and a digital cable port. Adaptor 1900 includes datapins 1902a in the hotshoe 1902. Adaptor 1920 plugs from the radio unit 1922 into an HDMI or USB port of the camera for sharing data and command received and transmitted by the radio (PCB not shown, Wi-Fi antenna 1909). In this way, every older camera with a suitable I/O port, whether parallel or serial, can be adopted for use with systems 1600, 1700 without internal hardware or firmware modification.

Shown in FIG. 19A is a radio interface 1900 accessory with Wi-Fi rabbit ears 1909 for forming a local area network (LAN) with the camera 1715. Commands and data are transferred to and from the camera. Data transfer rates of 1 to 5 Gbps are achievable with conventional radio units, and higher rates are possible. These transmitters operate at 2.5 to 14 GHz in the ISM and open bands of the spectrum, and by virtue of their higher frequencies and limited range (particularly Bluetooth®), are private except to compatible radio receivers that must be in close radio proximity. Wi-Fi has an added advantage of vigorous encryption as needed. When linked, communication is bidirectional. In one embodiment, the radio accessory 1900 may be networked with camera 1715 and color target device 1601. As an example, the image transfer from the camera results in generation of a camera color IDT profile that is then sent back to the camera 1715 and appended as metadata to subsequent RAW image files captured by the camera and exported to extended memory in device 1601 or to the cloud 1000. Use of flash cards 1925 for transferring camera images is becoming obsolete as camera's are outfitted with internal radio, but is drawn here as a use case for all the cameras that use SD cards. Here we show (FIG. 19B, 1926) a work-around by which older cameras may achieve a similar radio capability for sharing and receiving data with a limited firmware upgrade. The SD card is complementary with a data cable where radio broadcast of images is not desirable. Power may be drawn from the hot shoe or from the cable 1926.

Radio adaptor 1922 is typically a retrofit for older and less expensive cameras that do not include a compatible radio. The adaptor supplies the needed radio for networking as a plug-in to a HDMI or USB port in the camera, or as shown in FIG. 19B, where the coldshoe of the camera becomes the mount for the radio adaptor. Use of the sturdy coldshoe avoids a loose radio adaptor that dangles from a cable, as described in U.S. Pat. No. 9,712,688 to Pawlowski. Mounting the radio adaptor atop the camera also optimizes use of a directable MIMO antenna pair 1909, thus achieving data transfer rates >1 Gbps, an important advance in gaining favorable consumer experience. Each antenna 1909 of the MIMO pair can be adjusted to optimize the signal pairing with network. As a consequence, digital link 1721 is generally a Wi-Fi link that achieves 2.4 Gbps or higher.

In FIG. 19A, USB 1911 and HDMI 1912 power/data cords enable the radio adaptor to be plugged into commonly available USB and HDMI ports on most modern digital cameras. These ports are typically positioned on the left side of the camera body; at most 10 cm away from the hot shoe 1902. The USB cable may supply power from the camera to the radio adaptor; the HDMI cable with its parallel bus may exchanges data and commands with the camera. The cables may include a strain relief 1913.

FIG. 19A is a perspective view of a first radio adaptor 1900 configured to mount on the ubiquitous hot shoe 1902 (or cold shoe) of a well-equipped digital camera. The bracket plate 1902 is an inverted “T” cross-section that slides under the rails of the hot shoe to form a rigid mount. The bracket plate may also include multiple electrical contacts. Five or six electrical contacts are generally available, but more may be provided so as to provide a parallel bus. The contact surface may include a databus. The adaptor also may include a microphone (1903) for recording audio associated with the image capture process. The microphone is protected by a foam filter from wind buffeting that would result in whooshing sound and from pops that occur when the microphone is touched, and may be useful for the camera operator so that notes about each shot can be dictated and recorded with each photograph. Alternatively, the microphone may be directed at the scene, or is omnidirectional, so as to capture a group conversation, and so forth. Audio signals are generally synched with the video output, and may be multiplexed so that the synchronization is preserved during transmission, as in a live broadcast.

Antennae 1909 are operatively connected to a radioset inside the housing 1900, 1920. The antenna may be exchangeable according to the model of the device and the intended use. For higher data transfer rates, paired MIMO antennae are used on the condition that the receiving unit also have paired MIMO antenna. Similar antenna designs may be operated at 2.5, 5, 6, 8, 10, 12, 14 or UWB frequencies where broadcast range is not an issue. [At higher radio broadcast bands, terrestrial physics limits the range even more than the cube root of the distance]. In some embodiments, the antenna are internal, and are diversity antenna or beamforming antenna, but the advantages of MU-MIMO are well known in the art, and the advance shown in FIG. 19B is a radio adaptor 1919 with antenna that firmly mounts on top of a camera in close proximity to databus and power ports of the camera, plus the capacity to steer the antenna where the signal to and from the network is strongest.

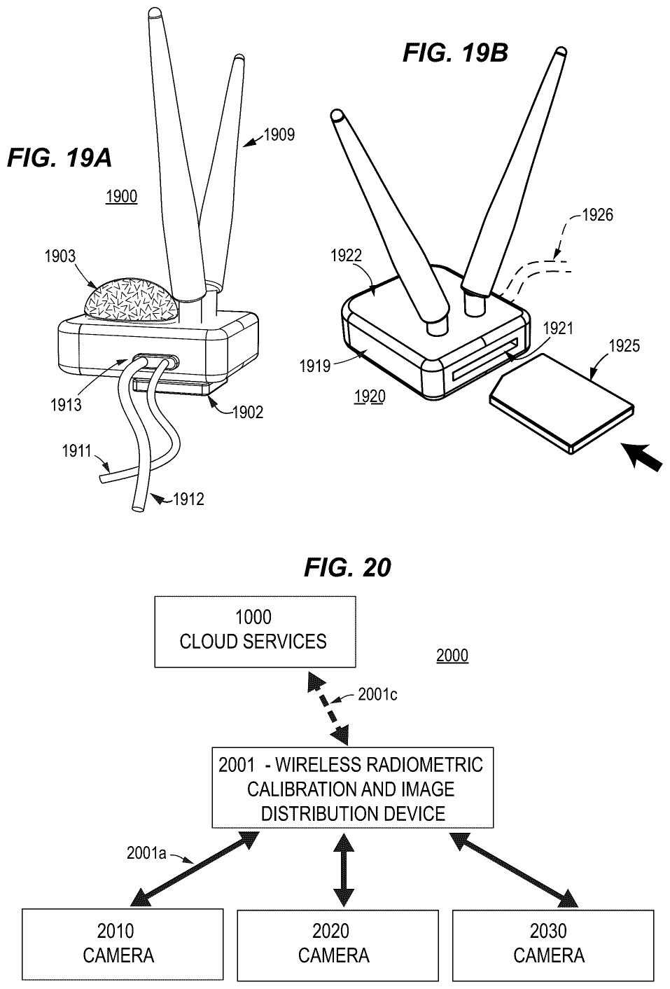

FIG. 20 is a block diagram of a wireless system 2000 for distributing image files through a network, the network having computing resources for performing radiographic remastering on image data received from one or more cameras 2010, 2020, 2030. Device 2001 is an electronic color target that functions as a “networking accessory” and is supplied with computational resources for calculating an image color remastering matrix, termed here an “IDT” (Input Device Transform) or “IDT” matrix transform, by comparing observed color notations in a digital image file captured of a scene on-location to reference color notations assigned to standardized color patches of known color under calibrated and traceable illumination. The patches are configured to calibrate a color gamut for the camera image so as to remaster colors encoded in the digital image file to the standardized illumination condition. The network (bold arrows, 2000) has a LAN level denoted by wireless links 2001a and a WAN level denoted by wireless link 2001c. In some instances, images are shared with a cloud host 1000, from which images are distributed through the network, archived and stored for future access by the user or by others. Cloud host 1000 may be considered as a global network having servers specializing in particular functions; in this case functions useful to photographers and cinematographers.

The apparatus of wireless system 2000 may include a user interface operably linked to the processor, wherein the user interface is enabled to adjust hue, value, saturation, and alpha of the digital image, alpha defining an artificial intelligence-generated enhancement of the digital image.

The apparatus of wireless system 2000 may include a) a device having a device housing with a color target surface on an exposed surface of the device housing, the color target surface is configured to display a plurality of emissive and reflective color target patches, the color target patches having a variety of spectral colors and tones sufficient to define a visual spectrum and tone curve when scanned spectrophotometrically under a standardized full-spectrum illuminant condition and stored as a reference library of color target patches, each color patch individually identifiable, the reference library having an identifier that is unambiguously associated with the color target surface and the geometry of the color target patches thereon; b) an electronics package within the device housing, the electronics package having a processor, supporting memory, logic circuitry and a radio configured to receive a first digital image of the color target surface as captured by an optical capture device under a first scene-referred illuminant condition, wherein the processor is configured to to parse the image, extract a calibrated digital chromaticity and tone value from each patch of the mixture of emissive and reflective color target patch images from the first digital image, and to generate a color and tone profile by which the first digital image is remasterable in colors and tones calibrated for the standard full-spectrum illuminant condition; c) whereby a next digital image captured by the optical capture device under the first scene-referred illuminant condition is processable according to the color and tone profile and is configured to output to memory a remastered digital image renderable as if lit by the standard full-spectrum illuminant condition, by the scene-referred illuminant condition, or by a creative illuminant condition chosen by an operator.

FIG. 20 demonstrates that a networking color target device 2001 can service multiple cameras 2010, 2020, 2030. Networkable “cloud services” 1000 may include color correction, storage of user profiles, administrative services, camera information, archiving, uplinking to the cloud, and downlinking of OTA updated firmware or “apps” to cameras on demand, for example. Cloud services may also include links by which APIs can be accessed to perform more complex post-processing of images. In addition to archiving, images may be distributed to remote user devices and published for viewing by others. Servers responsible for cloud services may be referred to here as a “cloud host” in a collective sense.

By packaging the electronics for comm functions and some color process functions in the networking accessory device, the device can serve multiple cameras, and can also participate in cloud-sourcing of image transform functions. While these network functions may also be performed by smartphones, the color remastering device 2001 has external color patches necessary to perform a rigorous, traceable remastering and contains a VPU or GPU engineered specifically for digital image processing according to Eq. 1. The device may also communicate with smartphones, and the smartphone may be used to link with the cloud. The device 2001 may also have a specialized User Interface intended for digital image manipulation, as will be described below.

Device 2001 may be a combination reflective and emissive color target tool. A camera captures a digital image as known in the art. The image includes the color target device and its color patches plus the background scene and any subject matter of the photograph. The color target device is an electronic device with computational power, memory and a radio. The radio may be local, such as Bluetooth®, or may be Wi-Fi with sufficient power to network with other computers or cloud resources. The digital image of the color target tool is processed locally (or in the cloud) to generate an IDT, and that matrix transform is stored in memory and applied to subsequent RAW image files taken under the same lighting conditions.

Device 2001 preferredly also has the capacity to execute a level of “edge computing” so that it may perform image color transform calculations (and radio signal encodings) and may act as a “hotspot” or direct wireless peer for communication with the camera and for transmission of image data to a cloud platform 1000. The networking device will also include several hundred GB of flash memory to buffer an incoming video stream or to function with a camera independent of cloud connectivity for extended use on site.

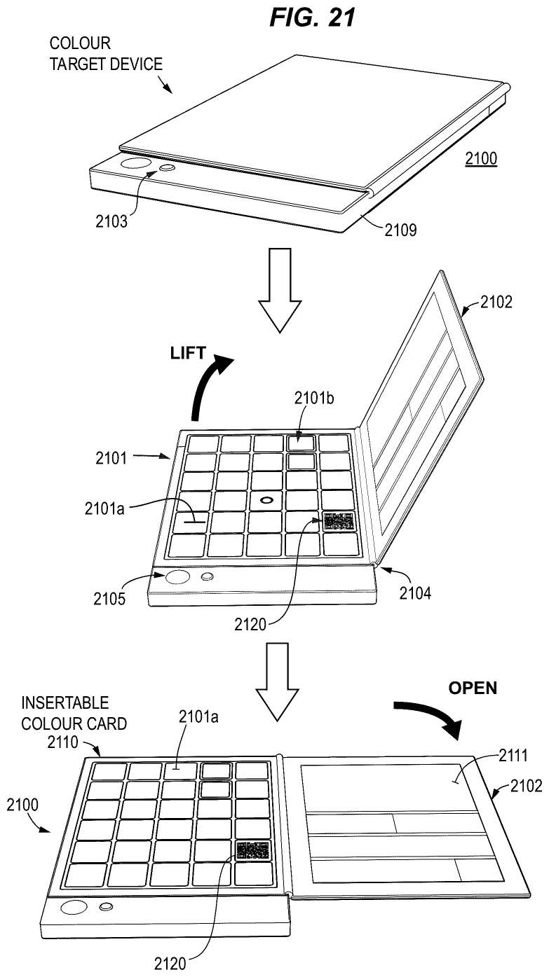

FIG. 21 is an exemplary color target device 2100 with multiple patches 2101 disposed on an exterior surface of a housing 2109. The fold-out cover 2102 contains additional patches or user information. Multiple patches 2101a are disposed on a rectangular exterior surface of the housing that is protected by cover 2102, which rotates on hinge 2104. The rotating action (bold arrows, LIFT, OPEN) of the hinged cover is demonstrated in this three panel figure.

This electronic color target device 2100 includes a radio and emissive color targets 2101b for calibrating greyscale at 20, 500 and 1500 nits, for example.

Each patch 2101a is a reflective colored reference patch. In some embodiments, the reflective patches may be printed on an insertable color plate 2110 that slides into a frame on the top surface of the device. In these embodiments, the patches may be selected by the end user so as to be most appropriate for the intended shoot. Each insertable color target card is encoded with an optical bar code 2120 or other identifiable marks so that a photograph of the color target device can be decoded and compared to reference color patch values in the same layout. These color plate layouts may not be stored in the device, but may be accessed from a cloud host, for example, and are updatable whenever a new card is inserted. Color plates 2110 may be replaced if the existing patch surfaces becomes dusty or scuffed. The color plate includes a cutout or window for emissive patches 2101b.

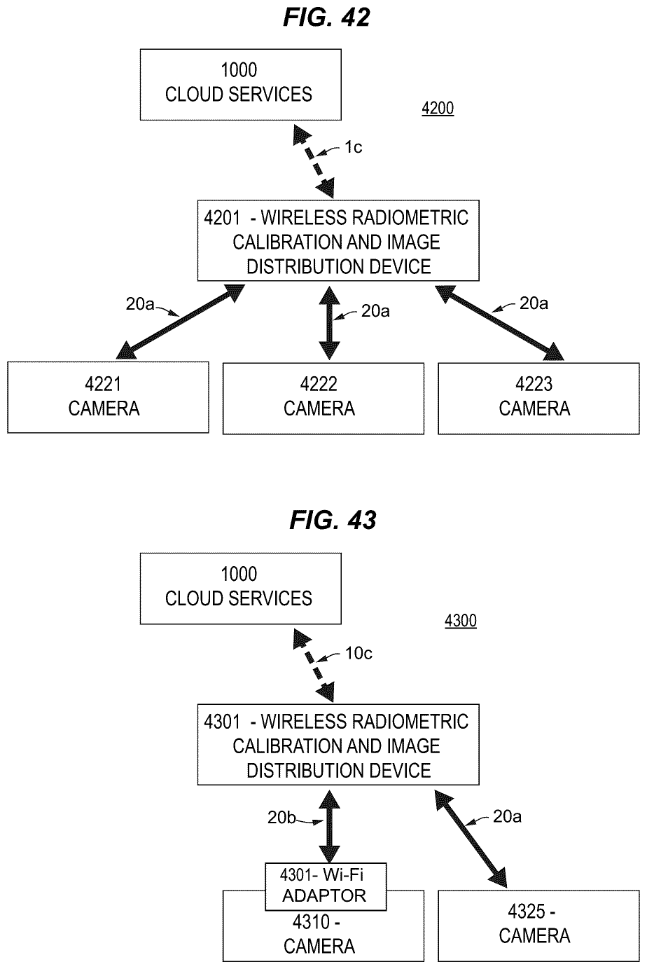

One surface of the device, either on the fold-out cover or the back side of the body may include a solar recharging panel (not shown) for topping up the battery (inside housing 2109) during a shoot. Exemplary internal circuitry is described in FIGS. 42 and 43, but may include an LDO in the power management circuit for switching to solar power when insolation is sufficient to power the device. The device may include a user interface with ON/OFF button 2103 and status indicator lamp 2105, for example.

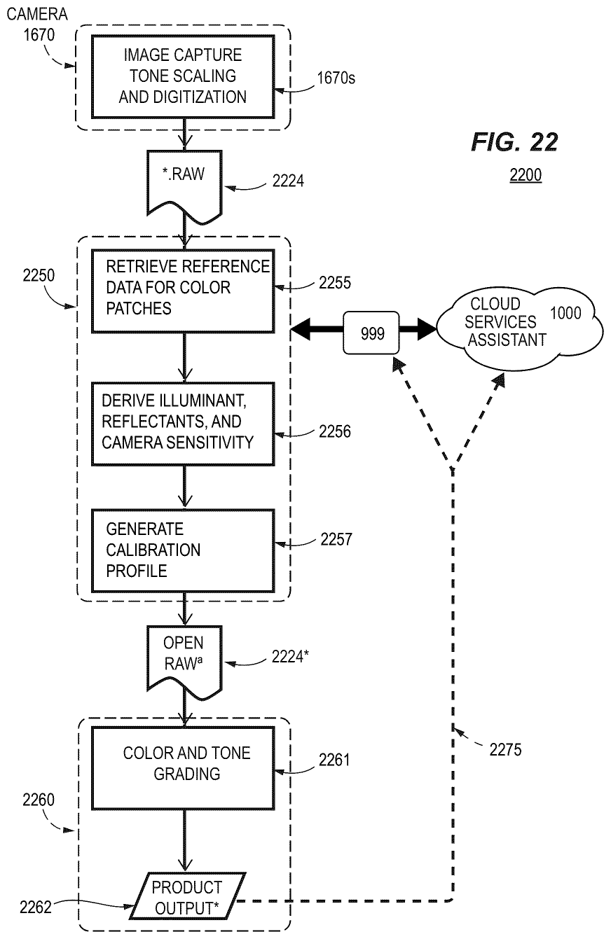

FIG. 22 is a view of a composite system 2200 of another embodiment, in which camera 1670 comprises a color sensor 1670s is configured to output RAW images 2224 to a smart color target 2250. As before the color target includes remastering markings, a processor and logic circuitry, memory, and at least one LAN radio.

Camera pixel outputs are digitized, dark frame subtraction, bias, flat field division and RAW encoding are performed automatically in the camera. Some cameras also compress the image and demosaic the RAW data before performing a white balance, color matrix multiplication, proprietary transforms and gamma mapping before image encoding and preparation for export. These steps may interfere with best quality color, but can be compensated to an extent in the remastering process.

The color target processor is configured to perform color remastering steps. The steps include: 2253 retrieving the color target patch reference color data from internal or external memory; 2255 deriving the illuminant, reflected colors for each patch, and validating the absolute remastering of the camera sensitivity, 2257 a scene-referred IDT profile remastering is then solved and is exported as metadata with the image bitstring. The Cloud Services Assistant 1000 may assist in these calculations or in a supporting role in archiving data. Because the color patches are affixed to an exterior surface of the device, the layout of the patches and their reference values may be stored in an internal memory. Exported RAW data 2224* includes the image bitstring, stripped of any log compression or manufacturer's formatting, and metadata that includes an IDT/ODT. The RAW camera sensor data is exported with a tag containing an IDT/ODT calculated by the algorithms of the invention. This image is more suited for conventional color and grading because the colors are reproducibly relightable. Using the same equations, a new illuminant may be substituted, or a new observer.

A cloud services assistant 1000 may be engaged if desired, or the apparatus may include a bridging device such as a smartphone 999 that executes key steps of the color algorithms and reformats the data file before displaying it on an accessory display or before sending it to the cloud for sharing. Note that no modification of the camera 1670 is required, and that a conventional RAW image file 2224 is an acceptable input to the spectral standardization process. If necessary, a data cable or a memory stick may be used to transfer the images to the cloud services assistant, although it is preferable to use a camera radio or radio adaptor as discussed earlier. While not shown, this process typically relies on an image taken with camera 1670 of a color target, most preferably the color target “Type K” as illustrated in FIGS. 18 and 21.

Digital image 2224* ensures that the ensuing steps in any image process pipeline are started from calibrated color and are reproducible for any post-processing 2260, which may be performed remotely and at a later time. This post-processing typically involves color and tone grading 2261 to achieve the desired “look” or creative intent of the photographer or cinematographer. The finished image may then be exported into any convenient file format for distribution 2262 but the RAW file is archived as a complete record in which all transforms are recorded as metadata. By storing the metadata as a mathematical function or functions, the size of the file is not significantly increased. Options are provided so that the polished image can be broadcast or can be transported to a cloud host or to a smartphone 2275, depending on the user's preferred destination IP Address.

The RAW image may be containerized as a *.VSF container if desired.

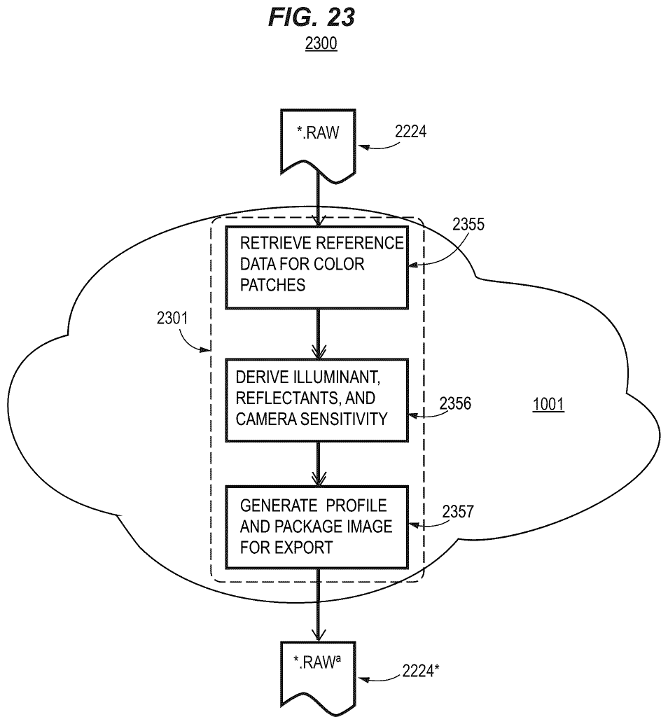

FIG. 23 is a view of another system or apparatus 2300 that encapsulates a cloud assistant component 1001 as described in U.S. Prov. Pat. Appl. Ser. No. 63/460,004, titled “Color Transform, Methods, Apparatus and Systems”, which is incorporated in full by reference for all that it teaches. Here the cloud API 2301 includes the algorithms expressed in Eq. 1. RAW file 2400 is conveyed to the cloud assistant, goes through the process, and is packaged or containerized for export back to the user's hardware as a modified image file as a digital film negative in *.RAW* (2224*) or *.VSF format. While the file may undergo selective compression, the equations that perform the compression are embedded as metadata in the finished output and are reversible so that the full information content of the original digital image is recoverable at any time. As spectral data becomes more available, the utility of containerizing images and video clips will drive the professional market.

Upon inspection of FIG. 23, it will become apparent that a smartphone may host the “Cloud Assistant” as an ordinary “app” running on Android or OS, but the cloud resources are substantially larger, and include neural learning and AI models, plus the capacity to interact with the API 2301 in a full desktop user interface (not shown). Layering and transparency, 3D ray tracing, shadow and luminant radiance are not readily achieved in the limited sandbox of a smartphone MCU. Cloud servers running specialized VPU or GPU blades with terabytes of memory provide a stimulating user experience that cannot be experienced with the limited display power of a smartphone.

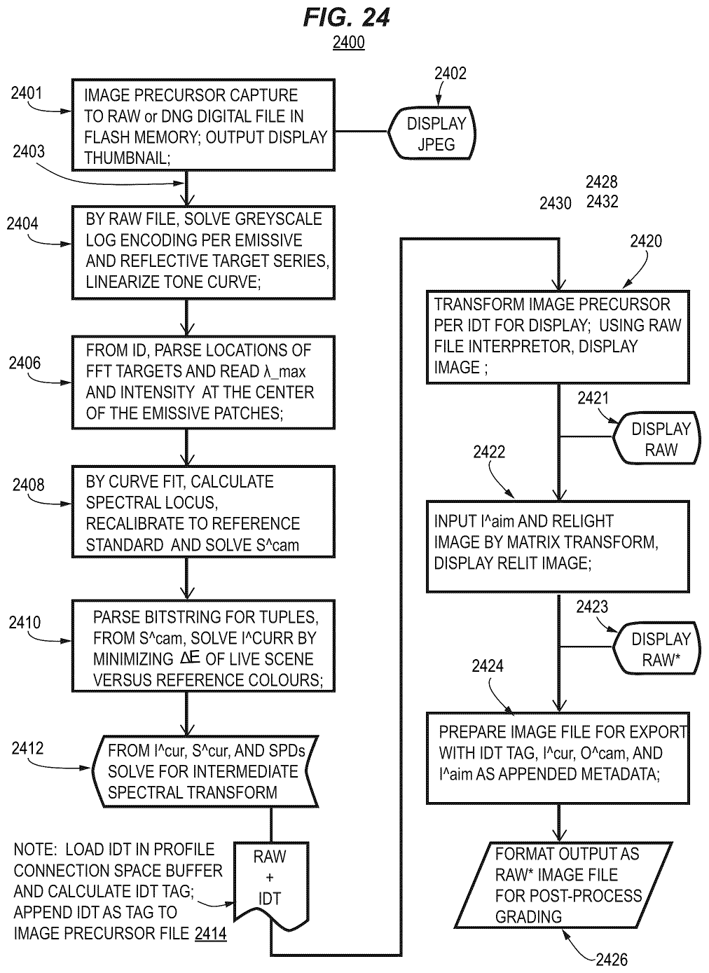

FIG. 24 is a more detailed workflow or “pipeline” 2400 showing image processing using the hardware and code blocks that support Eq. (1). This exemplary image processing sequence is generally automated by the system according to logic in firmware or software. This workflow is device-independent but for development is preferably coded in Python or PyTorch. The sequence generates an improved RAW* output file that can then be used for color grading and any creative post-process editing. In this example, as a general rule, the priorities are, master the tonality first, then the hues, and finally the saturation. [Note: A smart color target device 1601 may be supplied with a spectrophotometer 1810 or lightmeter, and for first pass setup of camera, the device may estimate initial camera exposure settings from the lightmeter readings and forward that information to the camera].

The process begins 2401 by using camera 1670 to capture a first image 72 of the color target 1601 device under “on-location” direct scene lighting conditions and buffering the RAW image data into a camera memory as a digital file. An envelope or container may be added to the file. The envelope or container may include timestamp, geostamp, exposure conditions, and any other metadata or annotations supported by camera firmware. The image may include a virtual frame around the color target, fiducials, a QR code(s), emissive OLED color patches 1604 of spectral or greyscale gradients, and conventional reference color patches 1602 having a fixed reference color (hue and value) that have been calibrated and certified under a defined reference lighting condition. It may be helpful to display 2402 a JPEG thumbnail on the camera as a guide or index for the photographer.

Next 2403, from the camera, export the first image 72 of the color target as a RAW datafile (including camera metadata) to an image processing device. The image processing device may be a smart color target device 1601 [Note: the smart color target device may use ambient light readings to make a first-cut calculation of dynamic range, white point, black point and greyscale error correction factors before generating IDT in a next step.] At 2404, the RAW image with envelope is received from the camera (for example by WiFi DIRECT or over a USB cable) at the smart color target device 1601 and is identified by its serial number. Images may also instead be transferred to a cloud host or are processed in a camera that has internal processor and logic for image manipulation. In the image processing device, log encoding is undone using the remastering patches to linearize the tone curve. White balance is undone. Other transforms implemented by the camera are also undone so as to restore the RAW file to essentially its native state with only dark frame subtraction and flat field division as completed by the camera.

Next 2406, demosaic the RAW data and parse the image to locate the smart color target frame by its fiducials and fine alignment markings.

At 2408, from the ID of the color target, perform an absolute remastering of the spectral locus so as to verify that S_{cam} is correct.

At 2410, parse the pixels to identify patches and analyze each patch for representative chromaticity tuples. Use kernel blending if needed. Retrieve the reference color patch standard SPDs and compare them with the chromaticity coordinates and values of each patches in the image. Calculate a ΔE. By fitting with constrained optimization, optionally using partial differential equations (PDEs), Lagrange multipliers, or least squares minimization, solve for a smooth SPD contoured surface that satisfies the color shifts in the reference color target patches 1602 and accurately estimates I^{curr}.

Next 2412, having solved I^{curr}, R^{curr}, and S^{cam}, calculate a spectral transform that generates c′. Call this transform IDT and store it with the RAW data and in cache memory buffer as a profile connection space or tag. The file 2414 contains the image bitstring or frame plus the IDT as metadata. This IDT profile or transform, when executed on the image pixels, generates a color image as the scene would appear if lit by the standard lighting used when the reference patch SPD scans were created.

At 2420 (next column), the image transform may be completed and displayed as a RAW image 2421. However, the image may be stored such that the RAW bitmap is containerized with each transform in sequence, such that applying the transforms and reversing the transforms is lossless. The image may be compressed as needed using transforms that flatten selected areas of the image, such as the sky, where tone may be preserved, but the hue may be a constant so as to save megabytes as would be used for strings of blue pixels over a large image area. Program operations for scanning an image and rolling up pixel areas that are invariant in color result in significant lossless compression.

At 2422, the user is asked to input a preferred illuminant. After all, the standard D65 used to prepare the reference patches would not likely be suitable for all photographs or video. A spectrophotometer can provide an accurate reading of the actual scene lighting, or the user can be guided by creative intent. By substituting I^{aim} in Eq. 1, the image can be “relit” to match the user's intent or aim—the intended “look” of the work product. This image can then be displayed 2423 and adjusted if needed. Other transforms may be applied and appended to the RAW file. These include saturation transforms and artistic effects. A point spread function may be applied with Fourier transform via a convolution/deconvolution process to resolve motion blur if motion and heading sensor data is available, a Hough transform or other edge mapping and contrast enhancement functions may be applied, Gaussian smoothing may be applied if desired. Various special effect transforms are also available as canned software and can be applied to the RAW data, with or without burn-in. Generally, a preferred approach is to apply the supplemental functions in “preview” and to append the transform to the RAW file as metadata so that the complete information in the original image file is not irreversibly lost.

Other transformations and manipulations of the RAW data such as cropping, recentering, contrast enhancement, saturation enhancement, fade and blur, are not excluded and may be applied before or after the color remastering.

When satisfied 2424, the image file is packaged for export and archiving or broadcast. The envelope or container will include the IDT tag, the S^{cam}, the I^{cur}, the I^{aim} and any other transform formulae as appended metadata.

This product RAW* image can be displayed as it originally appeared or as it has been converted to standard illumination, or as converted to a preferred illumination. However, in final post-production, the image or video clip will be graded and will be given another transform if needed. At some point, a decision may be made to “burn in” the image, to reduce it to a palette of pixels and tones. However, unless the display device has been standardized, it may be more accurate to keep the RAW image, and to reserve a step for generating an ODT so that the color selections viewed in final cut will appear as intended regardless of what display screen is used.

In this protocol, processing the RAW image(s) from the camera includes: using optical or radio fiducials in the color target to determine the ID and orientation of the color target; then,
A) from the color target, referencing a setup protocol associated with the ID or associated metadata and reading the XYZ data (or equivalent digital data) for each color patch or strip from the image of the color target, the XYZ data for each color patch or strip defining “scene-linked color data”;
B) from a library, using the identifier information or other metadata, accessing a reference color and value for each color patch and comparing the XYZ color and value (the scene-linked color data) with the reference color and value; optionally applying a white balance;
C) using an error minimization calculation, determine a best fit equation that fits the observed datum for each color patch to the expected reference color and value; this best fit equation defining a “color conversion transform (IDT)”;
D) attaching the color conversion transform IDT to the RAW file as metadata, and,
E) applying substitute illuminant conditions as desired.

More detail is supplied in EXAMPLES II and III. Note that these steps can be applied to still photos and to video footage, and can be automated in real time or in post-production. By using containerized image data, all the steps are reversible.

As described earlier, the calibrated IDT is valid only if the illuminant conditions have not changed significantly. In order to validate this assumption, we have designed a spectrophotometer with reference patches and a contoured ball 2500 so that the electronic color target or other image processing apparatus can automatically detect a change in illumination (such as a dust cloud rolling overhead) and either make needed adjustments to the live IDT profile in real time, or issue a notification that the IDT has drifted and the shot is no longer at its optimal color quality.

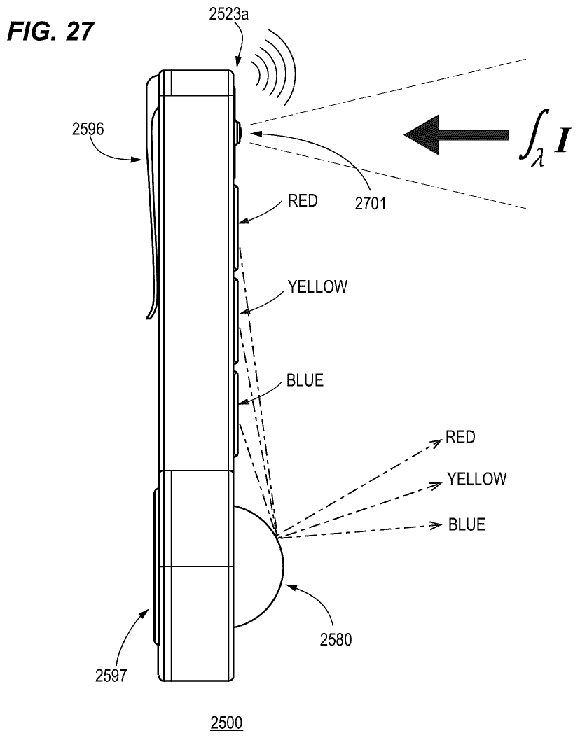

FIG. 25 is an exploded view of a simple “pendant” 2500 that can be pinned on an actor's pocket or lapel, inconspicuously mounted in the background of a scene, and may be removed in post-process using a simple automatic splice sequence for erasing the pendant (about 5 inches in length) and substituting matching fabric or background from adjacent areas of the image. It also finds use in fine portrait photography because of its precision in defining shading across contours. And perhaps another use is in calibrating value to correct for log-compression. As will be shown in FIG. 27, the device is also useful in calibrating luminous radiance, the tricky secondary illumination that causes the reflected glow of one object to light up the shadowed face of another object.

In this exploded view, the two pieces of the housing, cover and base, are shown to form a seal together along seam 2503. Various assembly and disassembly hardware may be used, and gaskets are employed where sonic welding is not the preferred method. Another key seal is around the lens aperture 2511 of the spectrophotometer 2510, where a gasket is pressure sealed between the upper case 2501 and the body of the spectrophotometer 2510. The spectrophotometer body 2510 and its lens 2511 form a sealed unit that either plugs into a receptacle in the PCB or is wired to it.

The spectrophotometer is shaped to match its function. Light enters the lens 2511, encounters a mirrored prism at the base of the neck, and the refracted rays travel the length of the vacuum body 2510 before being detected as monochromatic light by a photodiode array at the righthand end as shown here. The spectrophotometer mounts on PCB 2525 and the neck with input lens 2511 is guided through a hole 2501a in the upper case. The photodiode array outputs the SPD curves to the VPU 2520, which is a custom chip designed to handle color management tasks and includes large memory storage for matrix calculations. The smaller chip 2522 is a general purpose MCU or GPU and also contains a large cache memory as an instruction cache. The smallest chip is a Wi-Fi radio chip 2523 and is connected to one or more antenna at 2.5 or 5 MHz (not shown). Details of PCB 2525 are also not shown for clarity but include power management that regulates power from coin battery 2530 and requisite supporting logic circuitry.

The upper case includes three receptacles 2601 for LEDs 2600. Embodiments have been considered in which electrochromic pigment is installed on the case, but the LEDs are preferred to provide a higher power light output and optionally to change color in a precisely tuned way for tens of thousands of cycles. RGB LEDs are a first choice, but an LED circuit tree with a white LED is also of interest. Most photography is done using a spatial array of remastering standards, but temporal variation is also envisaged to maximize the information available for transmission to the smart color target device 1601 or camera 1670.

Radio 2523 is a networking device and pairs with the camera, the color target device, a smartphone. and optionally, directly or indirectly, with the cloud. The radio can be configured to transmit a radio ID used to verify the identity of the pendant. The radio can also receive OTA updates to the software. The antenna is not shown but can be an antenna on the PCB or can be built into the housing such as around the lip of the bowl 2590.

LEDS 2560 are driven by the MCU 2522 and seat in a mirrored receptacle to maximize brightness. Chrome ball 2580x is useful to detect light sources directed at the subject, but may also be threaded out and substituted with a white ball 2580w or colored ball 2580c that provides detailed information about how the scene-derived illumination interacts with the contoured surface of the ball. This is relatively easy to model and provides guidance to AI routines which identify or add contours to the surfaces of the images. Well 2590 is useful in ray tracing shadows and can be colored to investigate the effect of various lighting fixtures on the appearance of colors. Indirect lighting also shows up in the well where primary light is blocked. These features serve as quick references to ensure that the scene lighting has no major deficiencies.

Three LEDs are shown 2561, 2562 and 2563 for impact, but four may also be used. Red, Yellow, Green and Blue are top candidates. The LEDs can be turned off during a shot so as to not distract the camera crew or actors, but use of primary colored LEDs on the device helps to ensure that the camera absolute profile is calibrated against other profiles for other cameras.

Care is taken so that light from the LEDs does not enter the spectrophotometer.

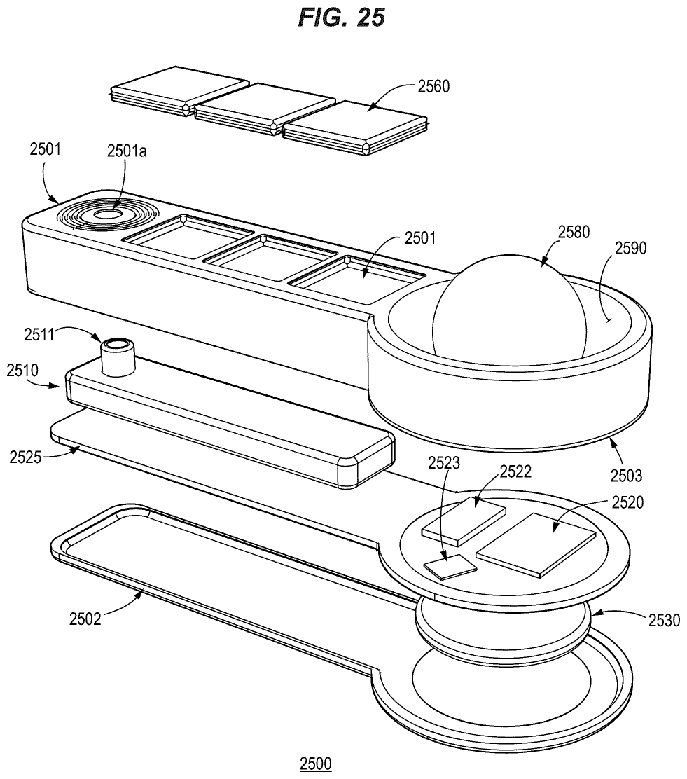

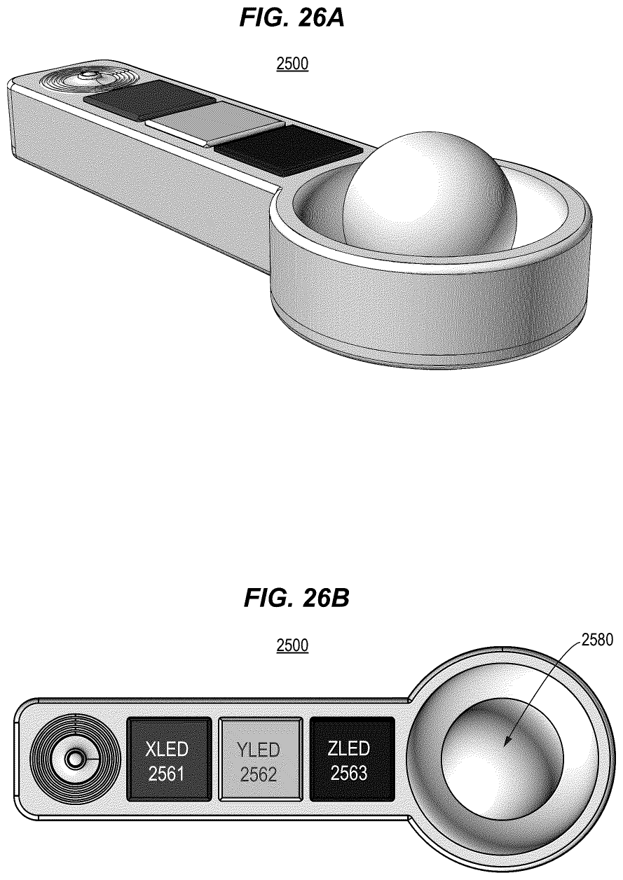

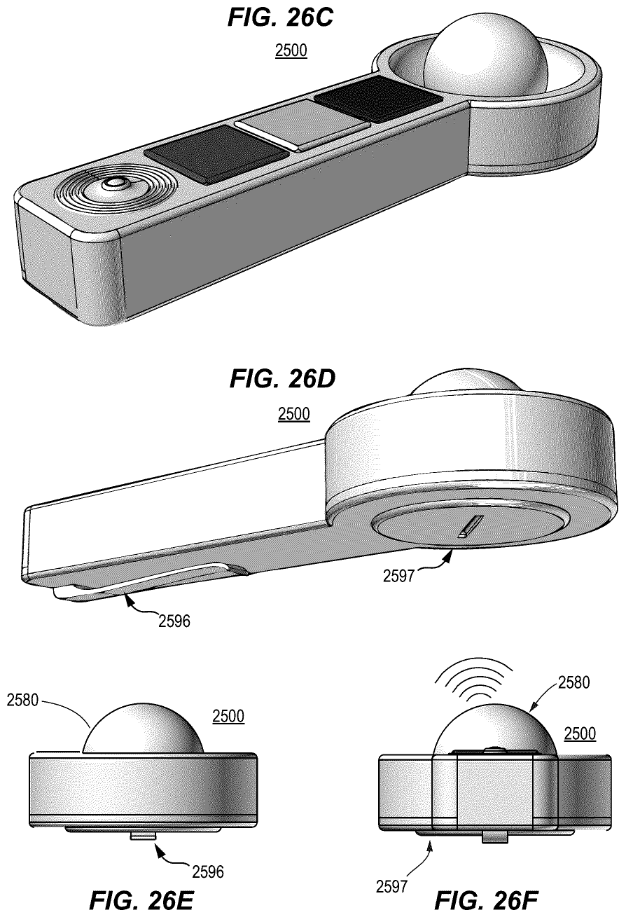

FIG. 26A shows a fully assembled pendant 2500 in partial perspective view.

FIG. 26B shows that the contoured surface of ball 2580w provides a solid guide to the director of photography. The balls are readily interchangeable. The chrome ball 2560x is helpful in identifying specular reflective sources, the white ball provides a soft contour for assessing shadows and highlights, the colored balls are useful when special lighting may have different effects on colored surfaces. Flesh toned balls may be made to order, and provide guidance in assessing lighting angles and even makup.

FIG. 26C is an alternate perspective view of the pendant 2500, demonstrating that the light follows the motion of the pendant.

FIG. 26D is an underside view and shows the pocket clip 2596 and the battery case lid 2597.

FIGS. 26E and 26F are front and back views respectively.

FIG. 27 is another view of pendant 2500, but at an oblique side angle so as to expose the ray trace patterns of the LEDs against a white ball or mirror ball 2580. As can be seen a prismatic reflection results, and that light if directed at the camera. In this way, the fine quality of mixed hues is either acceptable, or not. Given the weakness of RGB in projecting yellow-greens, it is expected that this combination of lighting will pose some irregularities for RGB.

Also detailed here is the entry of ambient scene-derived “on-site” light 2701 into the aperture of the spectrophotometer. This is the I(λ) of Eq. 1 and is very important in detecting deviations from a calibrated color profile during a shoot.

The pocket clip 2596 is shown in full silhouette in this view, and the radio antenna 2523a may be routed to the topmost point of the device so as to ensure a clear signal or routed to the lower bowl 2590 where it has no proximity to the battery or spectrophotometer.

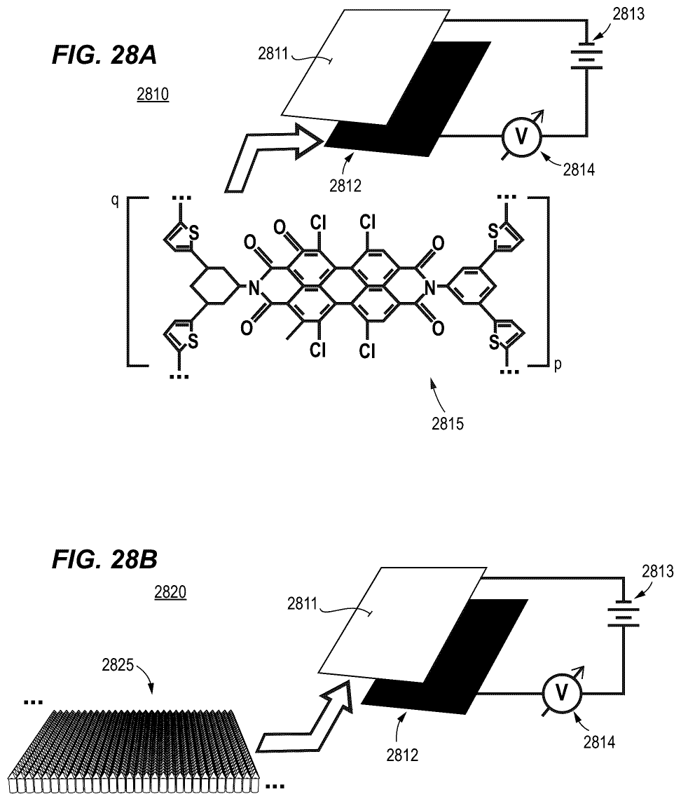

FIGS. 28A and 28B describe two basic classes of electrochromic devices 2810 and 2820. In the first case an organic pigment infused between laminated conductive transparent plates 2811, 2812 and subjected to voltage that results in a colored redox reaction. Generally these are battery powered 2813 and a voltage controller is supplied 2814. The dye in a first case is a crosslinked chlorine-substituted perylene bisimide 2815, which ranges from red to green with decreasing voltage (ZHANG_2022). Viologens, phthalocyanine chelates, polyanilines, polypyrroles and other conductive polymers have also been explored. In another case, inorganic nanorods 2825 are palisaded in an electric field and undergo red, yellow, and blue transitions, or even green. The nanorods intercalate zinc in an organic framework under a transparent electrode 2811 (ZHANG_2020). These electrochromic devices lend themselves to low power, compact plate structures that may be incorporated into the color targets of the invention.

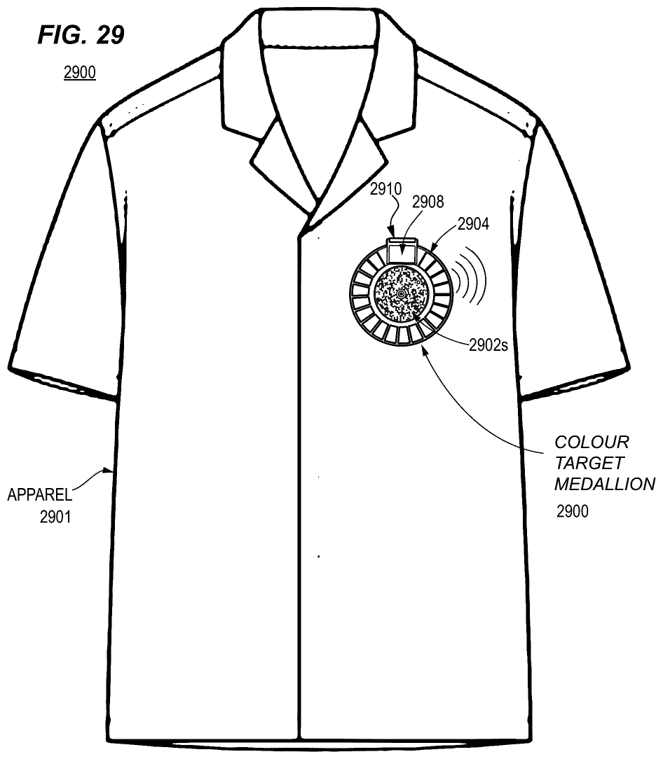

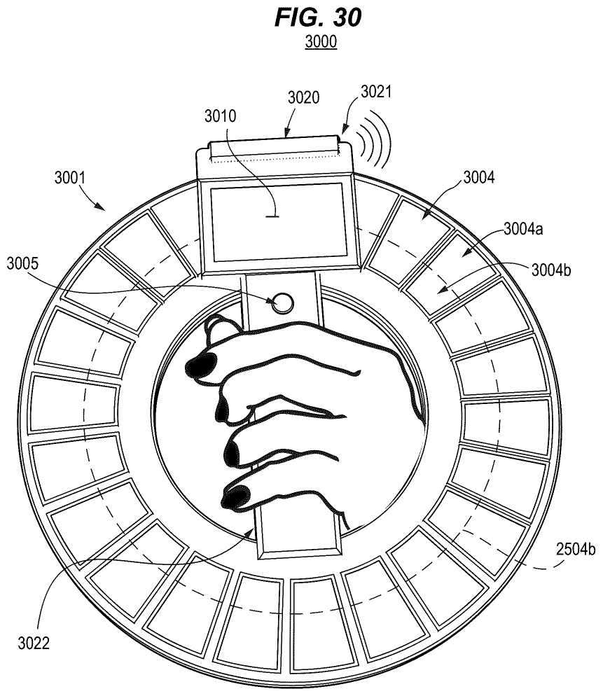

FIG. 29 presents another form factor for a pendant 2900, also termed a “color medallion”, this one circular with reflective patches on the circumference, a spectrophotometer top center, and an LED or LCD display screen for displaying QR or round codes in the center. This pendant can be pinned to a garment 2901, for example.

The pendant may be a smart color target device 2900 having the shape of a circular medallion. Permanent reflective color patches 2904 are displayed around the margin in the form of a “color wheel”. In one embodiment, an optical code 2902 may be printed on the medallion so that a display screen is not used. Alternatively, a center display screen 2902s is a multi-use emissive screen such as an LCD screen for displaying QR codes (as shown) or optional supplemental colors (not shown). Interestingly, while it is convenient to think of a color target device as an spatial array of color patches, the emissive color patches may also be displayed as a temporal sequence of colors on display. The resulting data is read optically by the camera in a time sequence and the color error minimization process on the sequential data is equivalent to that from spatially divided array. In this way, a more comprehensive set of colors may be presented to the camera in a series of exposures.

Body hub 2908 contains circuitry and a power supply for calculating a color profile solution and a Bluetooth® radioset for broadcasting the IDT to the camera. Internal circuitry is analogous to that described in FIG. 25 and includes a spectrophotometer. In some instances, the color correction calculation is performed within hub 2608, but in other instances, data collected from the device and camera is uplinked to a cloud host or smartphone, for example, for analysis and remastering, followed by transmission of the needed settings back to the camera for remastering.

FIG. 30 is a view of a color target device having a disk-shaped body with center handle. Reflective color patches are arrayed as a “color wheel” around the disk. The device may include a scanning spectrophotometer and radio to help detect incident light quality and spectral profile. The lightmeter is also useful in detecting changes in lighting condition that may require re-remastering of the camera's response to the color target device.

The internal handle may be grasped by a model posing for a photograph. An ON/OFF and radio command trigger button 3005 is positioned on the handle. The radio command trigger may actuate a “selfie” for example. The color patches 3004 are arrayed as a “color wheel” around the disc body 3001. Each patch may include an outer zone 3004a for general-purpose reference colors and an inner zone 3004b (dashed line) for specific colors optimized for the type of scene being photographed. A circular clip-on sheath may be used to substitute one set of colors for another, for example if flesh tones are needed in one set for photos of a model, but then bright primaries are needed in Pireaus for a documentary on the history of Athens.

By causing a model to hold the internal handle 3022, 3509 so that the model's skin is exposed, a more precise and verifiable match of the skin coloring is assured and gradations in shadow and highlight modelling may be visually inspected. Exposure conditions can be matched to optimize color/tone gradients and shadowing. The color wheel may be divided into multiple rings with multiple patches; here a separate color ring shows nineteen flesh tones that can be compared by the photographer against the color of the model's hand, for example. Imaging of skin has evolved into a science of its own, as evidenced by the citations given to VISSCHER_2020 (Imaging skin: Past, present and future perspectives Giornale Ital Derm Vener 145:11-28).

Also provided is a small color display 3010, as is useful for displaying glyphoptic codes or for displaying thumbnails of a completed exposure so that the model can decide whether to adjust the pose or not. The display may be touch sensitive to allow the user to zoom in on details as needed in order to check the quality of the RAW image data and associated color correction as calculated by internal circuitry. The display may be used for presenting a QR Code or other optical code to the camera and optionally may be used to present a palette of emissive colors. In one embodiment, the QR Code functions to label a shot of a scene on a movie set in which the color target is presented briefly, but removed before the actors begin their actions, thus substituting for a clapboard. Also included is a spectrophotometer or lightmeter 3020 and a radio 3021.

The handle 3022 may include a fitting concealed behind the disc for fastening the disc 3000 to a pole-mounted support rod so as to be positioned in the frame of the photograph without hand support.

OLED displays are known to fade over extended use, particularly in the blues, but the duty cycle as a color target device 1601, 2500, 3001 is actually quite limited, and remastering procedures may be used to detect early signs of decay in the color fidelity of the OLED output. A discussion of OLED displays as a tool in virtual reality is given in COOPER_2013 (Assessment of OLED Displays for Vision Research J Vision DOI: 10.1167/13.12.16). The backside of handle 3022 (not shown) may include a fitting for fastening the color wheel to a pole-mounted support rod so as to be free-standing.

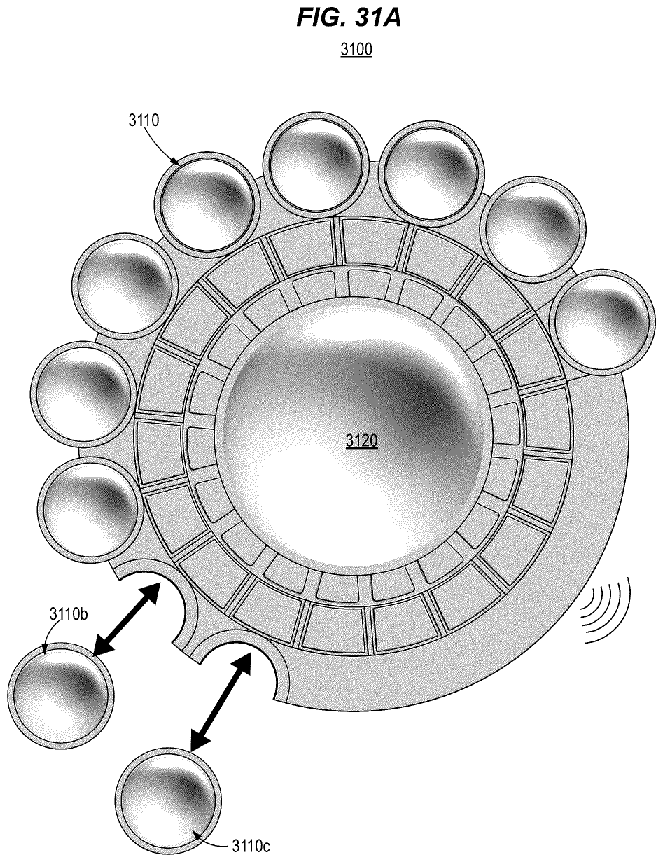

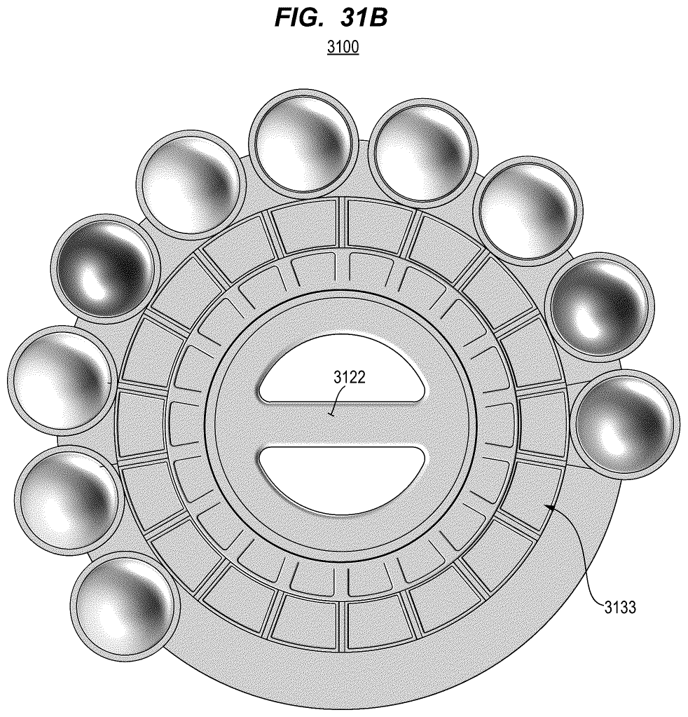

FIGS. 31A and 31B are other embodiments of an electronic color target 3100 and are designed for sophisticated color management of colored shading and contours. A variety of reflective or emissive patches may be displayed on the circumference of the device. Each spheric element 3110 is a different color, and hence the scene-referred illuminant's modelling of the spherics as light and shadow extends to the effects of the contour on a selection of reflected colors detected and analyzed by the camera. Each spheric snaps in and out 3110b, 3110c so that the photographer can pick preferred colors for a shoot. FIG. 31B illustrates the effect of multiple colored balls, and despite the imperfections of the various monitors used to look at this figure, it is clear that shading and highlights add a whole new dimension to color calibration of cameras and monitors.

A larger, hollow, removable white half-spheric 3120 in the center improves the resolution of the shade/highlight intensity data so that software can accurately quantitate the characteristic shading over a known contoured geometry. When using AI, the fixed geometry aids in building and training models of 3D objects as realistically modelled by light and color.

Alternatively, a chrome-mirrored sphere may be substituted for dome 3120. These larger spherics clip on and cover the handle 3122 as shown in FIG. 31B. A variety of reflective or emissive patches may be displayed on the circumference of the device. When the spheric 3120 is removed, two encircling bands of color patches are displayed. The outer band 3133 can be an emissive color target patch selection, for example. Various uses for multiple color target patches are readily apparent. And as before, coloring the live actor's skin tone is part of the calibration process.

Referring to FIG. 31B, ten or more colored spherics may be mounted in this design 3100. Note that the shadows on the spherics will move like a sundial when shooting in directed light or outdoors. Photographers are cautioned to design their shoots so that shadows progress naturally during sequential action clips. A computer program can be set up to automatically monitor this during post-studio storyboarding. Machine learning may be used to make correction if suitably trained on model devices 3100 of this sort.

FIG. 31B shows the center dome 3120 removed and a handhold 3122 in the center. Up to thirty-eight reference colors may be displayed as reflective patches and optionally, some patches may be emissive for studying greyscale, the impact of impossibly bright fuschia colors, and translucency, for example. The device includes internal electronics and battery power supply. The circuitry may do color illumination and reflection calculations from photographs of itself and is supplied with a radio for networking an IDT and identifiers to the camera or to a smartphone.

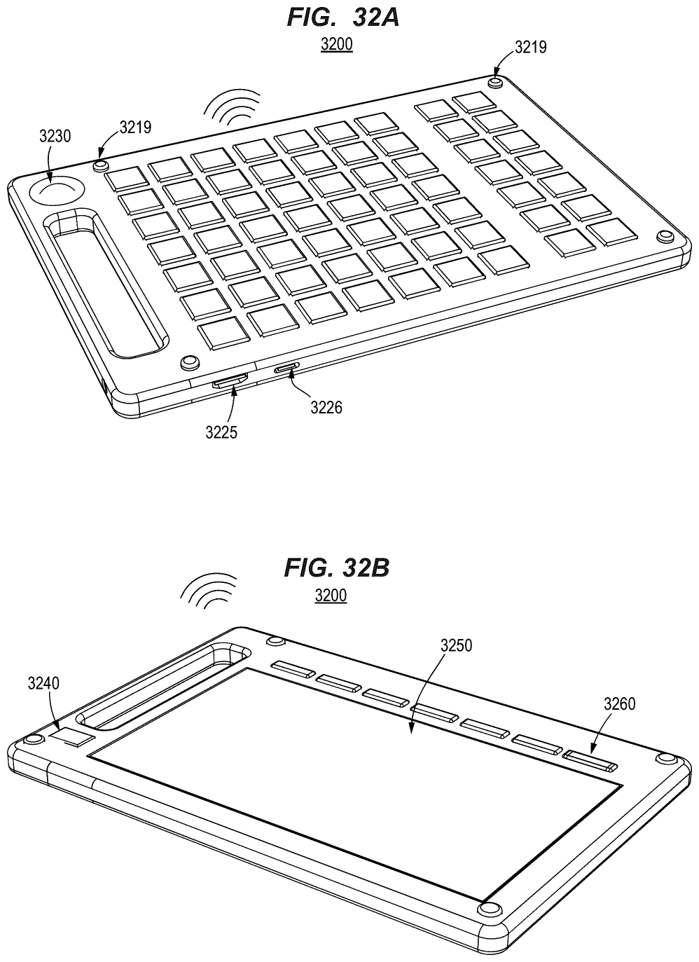

FIGS. 32A through 32B show a simple tablet with internal electronics for use as a color target and color management device. The device is in radio contact with a network that may include a camera, a smartphone, a laptop, a cloud portal, a display, and other radio accessories such as lighting.

The device includes both reflective and emissive color patches; ten emissive patches are dispose on the right edge of the device. Forty-nine reflective color chips are displayed on the left. Standoffs 3219 prevent damage to the surface of the color patches. Also included is a spectrophotometer 3230 and jacks 3225, 3226 for recharging and data sharing. A power switch 3240 is on the reverse side, and is again protected by standoffs.

FIG. 32B shows the reverse side of the color target, which includes an OLED monitor 3250 enabled to display photographs or video taken by a remote camera. This display has a number of uses. An experienced user can judge the quality of the image(s) and can adjust each image to determine whether the image quality is suitable for post-processing. The display also allows the subject of the image, standing in front of the color target's camera, to assess their position in the scene and the artistry of the image while the color target is in use, pointed in the direction of the camera. Camera's offer small displays to the camera operator, but the color target display 3250 provides this service to the photo's subject. When combined with touchscreen sensitivity and the seven function buttons 3260, the display provides a valuable user interface for analyzing, cropping, relighting, formatting, and distributing photographs or video clips.

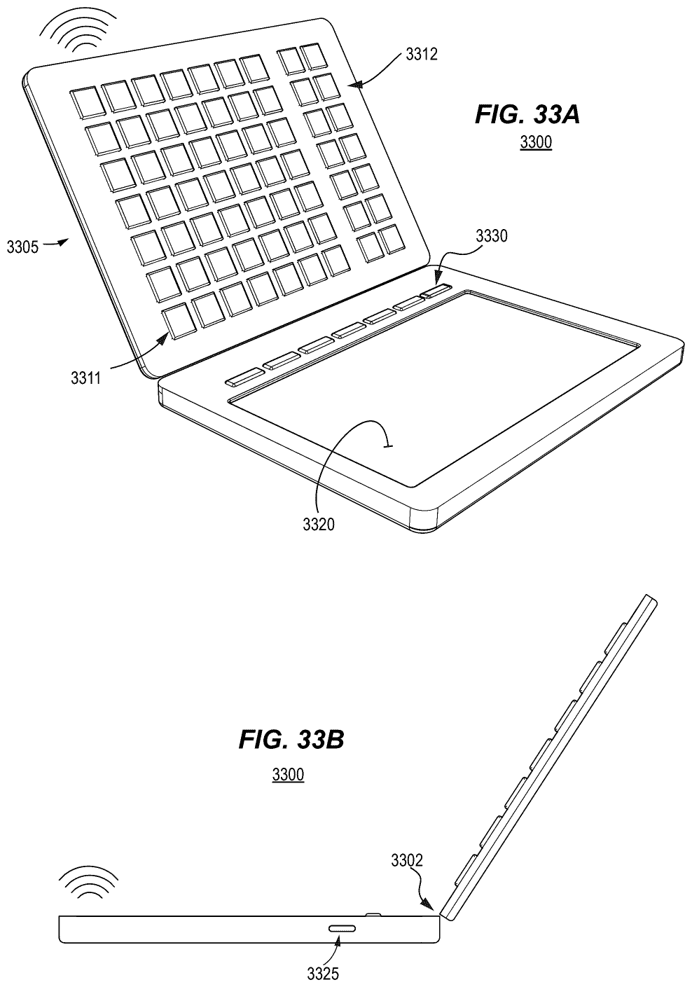

FIG. 33A relate to another exemplary color target device 3300 having a foldable coverplate and larger color display screen 3320. Hinge 3302 may be a single action hinge or a double action hinge. FIGS. 33A and 33B are perspective and elevation views of a color target device with hinged cover. The active color target is protected on an inside surface and a display and user interface are disposed on a second hinged surface. The hinge may be designed so that the two inside faces close together, but alternatively, a double-action hinge allows the display to be positioned so that it is facing away from the color target. FIG. 33B is an elevation view of a single-action hinge axis.

Both sides of the coverplate 3305 may used to display color and/or greyscale patches. In this way, more than fifty color patches may be available for radiometric remastering of a camera in a two-step process. Both reflective 3311 and emissive 3312 patches are provided. Another set of patches, including a greyscale series, may be provided on the outside surface of the coverplate (not shown). Under the coverplate, as shown in FIG. 29A, an OLED color display screen 3320 is accessible for display of images before and after color remastering, and for display of glyphoptic codes and virtual color patches at adjustable brightness. The display screen may be touch sensitive so as to provide added user interface features in addition to the control keypad array 3330.

The device may include at least one USB port 3325 for recharging an internal battery or porting serial data. The hinged cover may also be used to provide shade to the OLED screen. Having two images, one of each color target on both sides of the hinged coverplate, makes possible the integration of the full data set from both color targets into a single radiometric remastering. It is a general rule of thumb that more color patches result in a more accurate color remastering over a broader range of the gamut, up to a point. Optionally, one of the color targets (front or back for example) may be specialized for particular photographic needs, for example a color target optimized for skin tones or indoor shots and another for landscape images.

The device is not a laptop. All the electronics and chipsets have been optimized for digital imaging. The software includes proprietary packages intended for image editing and post-process grading. The unit has a terabyte of memory for storing extended video clips. By adding a microphone and speaker to the camera, the device can be converted to a convenient blogging workstation with wireless connection for uplinking content to a favorite website.

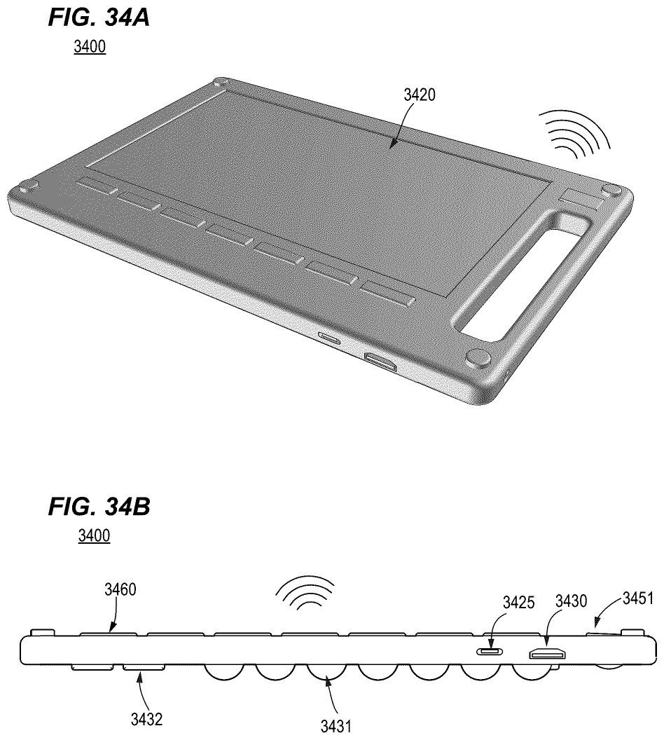

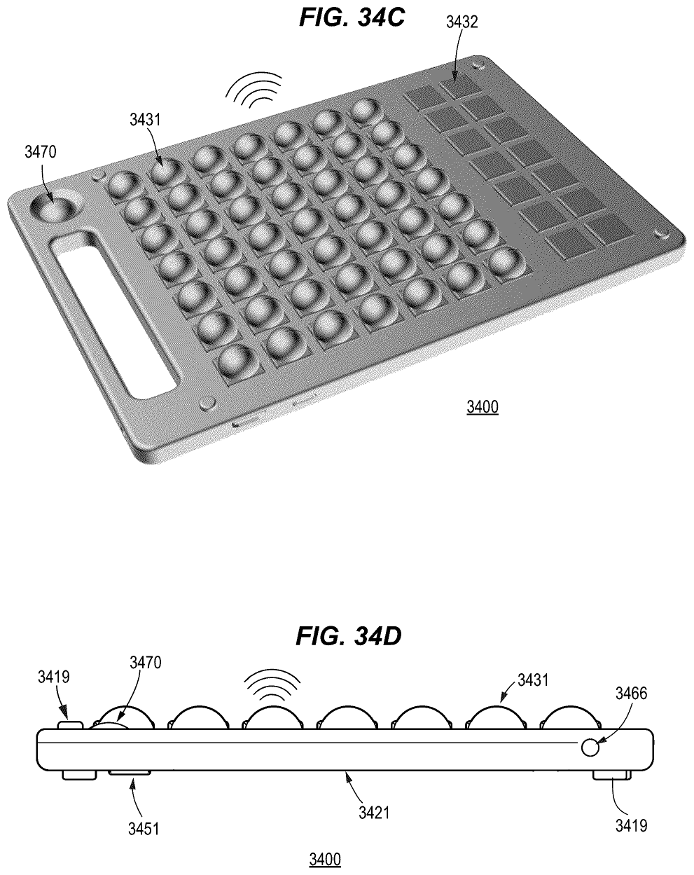

FIGS. 34A, 34B, 34C and 34D add another innovation in color target tablets 3400. In addition the the emissive color patches 3432, each of the reflective “patches” 3431 is modified as a spheric so that R(λ) and I(λ) are dynamic. The more dramatic the angular incidence of light, the more dramatic the shadows on the spherics are. The camera reports the transition for each color of the forty-nine spherics so that any peculiarity in the lighting is noted. This device also jump starts AI training on convoluted surface modelling. This is an ideal teaching set for Gaussian Splat AR. Power and data ports 3425 and 3430 are provided. Switch 3451 is the mains. 3466 is a status light.

As in other tablet models of this type, a large OLED screen 3420 provides a generous working space for doing color editing and grading. The radio link offers a larger range of graphics tools than can be supported in just the tablet alone. The radio link can also report spectrophotometric information to the network; a spectrophotometer 3470 is included on the color target surface.

FIG. 35A is plan view of a machine vision device 3500 with hexagonal body 3501. Color patches are arrayed in concentric circles and include reflective 3502 and emissive paches 3503 (dark outlines). Seven fiducials 3504 are distributed around the periphery of the body. The fiducials may be visual or may be radio centers with triangulation and TOF. A glyphoptic ID 3505 is centered at the top of the body. The spectrophotometer aperture 3510 extends under the cover in the direction of the central handle 3509. Two locations are provided for a logo and serial number.

Turning to FIG. 35B, two paired HDMI ports 3511, 3512 are provided, along with a single USB-C port 3513. The HDMI ports are paired so that the device 3500 can act as a hub. While radio is also provided, some users prefer the privacy that cable provides. FIG. 35C emphasizes the paired HDMI ports. Both ports are bidirectional of course, but can be coupled so that IN or one port is OUT on the other port if desired. Also, two IN signals can be merged, or processed separately, but at the same time. The USB-C port 3501 is also a data port, or for networking with a smartphone, but can also be used for recharging the internal LiPo battery.

In one use case, the first HDMI port can be linked to a video camera, the second HDMI port to a monitor screen. The machine vision device 3500 programs the camera and monitor to synch their color profiles.

FIG. 35C is an exploded view of the clamshell construction. Cover 3520 and base 3522 line up and are keyed to fuse seamlessly. A gasket is provided if needed. Between the top and bottom housing shells is a printed circuit board (PCB, 3521).

FIG. 35D is a perspective view of the full assembly. Fifteen emissive color targets are provided, including a greyscale series suitable for constructing a linear plot of intensity from 20 to 2000 nits. Thirty-four reflective color targets are provided and are scanned so that SPD reference data is available.

FIG. 35E opens the housing shell 3501 more fully and inserts the circuit board into its support cradle in the base of the housing. Assembly of the body parts requires that junctions be mounted on the circuit board 3521 for receiving plug-in pins from the components in the upper housing. Junctions include 3524 and 3525 for receiving the power and data connector pins. Also shown are the board-contacting faces of HDMI 3511, 3512, USB 3512 junctions, and the board contacting face of the spectrophotometer 3510, which plugs directly into the PCB. Note that the HDMI plug body is a dual port unit 3514.

Circuit board logic circuits are not shown. Chips include a VPU 3531, a radio 3532, and an MCU 3533. While not shown, a large amount of flash memory is also provisioned on the board. The large slab battery 3539 is positioned under the board.

Socketed junctions 3551 are also provided for the diffuser circuit boxes 3550. Each of these are pinned junctions so that the emissive color target patches and greyscale patches are under control of the MCU 3533.

The circuit board may also include optional front 3556 and rear cameras and a microphone for giving voice commands to the color target device if convenient.

Magnets may be embedded in studs 3560 to serve as attachment means for mounting the color target on metallic surfaces. Hardware fasteners are not shown. A pole attachment for mounting the rear of the color target to a tripod is also not shown. More complex mounting equipment such as a gimbal for suspending the color target from a drone are also not shown.

FIG. 35F is an open box showing the upper housing 3520, the lower housing 3522 and the PCB 3521. Battery 3539 is more readily envisaged under the PCB at this angle. A 20 Ahr battery is specified for extended use with 10 TB of flash memory. Camera 3556 is embedded in the top housing, and has a standard smartphone lens and device package.

FIG. 36 is a detail view of an OEM spectrophotometer 3510 that plugs into the circuit board and includes a lens that extends through the top cover.

FIG. 37A is a more detailed look at the diffuser box circuits 3550. In this configuration, an LED driver subcircuit is mounted in the hollow box, receives power from the main circuit board via pins through junction ports 3551 and operates a tree of LEDs under control of the MCU 3533 to generate a radiance that exits the box through a diffuser assembly. The diffuser box includes a lens cover with anti-reflective coating and a reflector under the LEDs. The LEDs may be RGB-LEDs configured to produce various colors, or as a more expensive choice, LEDs designed and certified to generate a narrow passband at selected wavelengths. For greyscale remastering, white light is emitted and the intensity of the light is controlled by driving the LEDs more or less depending on the desired “nit” output (λ)w. The size of the diffuser lens is rather large so that the camera image analysis can average a larger area in assigning an intensity (or a color) to the emissive targets.

Per FIGS. 38A and 38B, a second option is chosen. Miniature OLED screens that are commercially available are wrapped around a reflective cylinder 3802 in a reflective diffuser box 3550. The output emission (λ)p is controlled by the MCU via a ribbon bus 3804. Light generated by the LED screen, which may be smaller than 0.4×2 cm, escapes through a diffuser/lens combination 3806. The slab 3810 under the diffuser box 3550 is a heat sink.

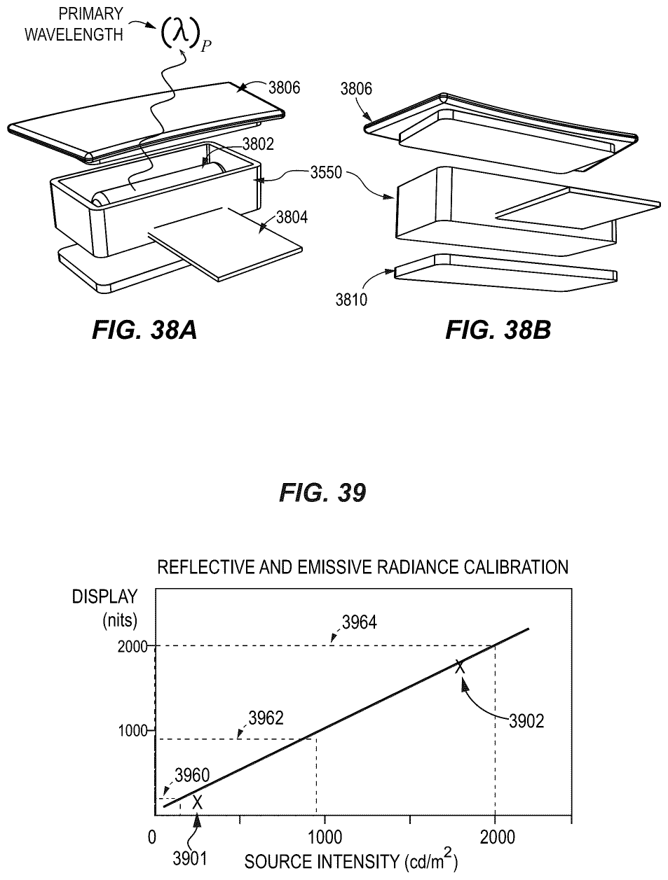

FIG. 39 demonstrates that linearity is achieved from 20 nits to 2000 nits or more, as is needed for modern display screens. A three point remastering of radiance L_{e,λ} is shown for three patch outputs (3960, 3962, 3964). Traditional television output 3901 corresponds to a radiance of 200-250 nits, so there is an urgent need to calibrate for higher exitance. Leading OLED televisions 3902 are currently capable of 2000 nits. While the human eye responds to glare by pupillary constriction at about 800 nits, the object is not merely to satisfy the human eye, but rather to develop a platform that can serve all the requirements of two machine display screens and paired cameras, each machine “looking at each other”. This machine-to-machine interface is expected to become much more common, and the immediate goal is to avoid “clipping” even at higher radiances. OLED displays experience “burn in” when a bright image is left on, but the system can monitor feed and issue a notification if there is concern of damage.

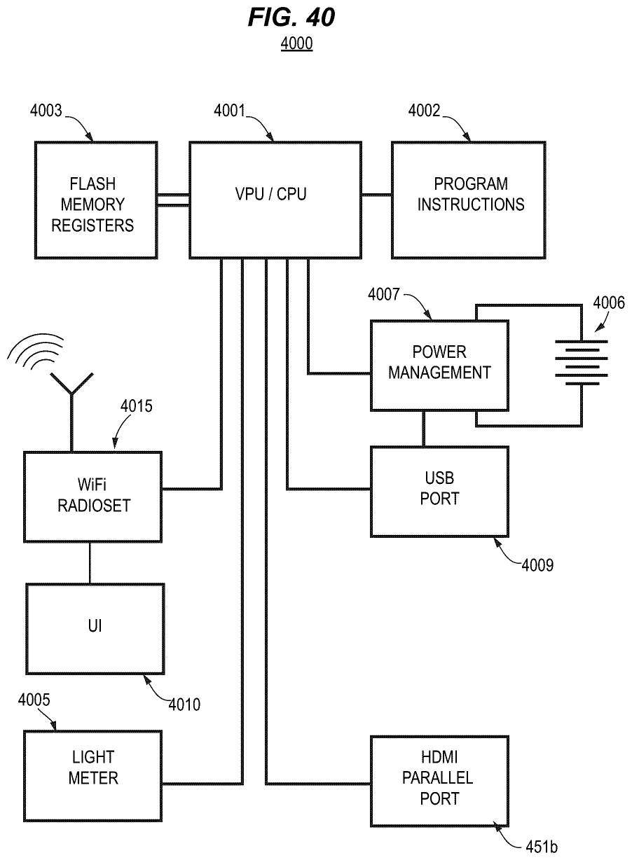

The new OLEDs have also achieved much deeper blacks, so camera remastering must also keep up. FIG. 40 is a schematic of an electronic color target device 4000 with high quality VPU or CPU 4001 and supporting logic circuitry, including provision for storing program instructions and “apps” in memory 4002 and sufficient flash memory 4003 for storing large amounts of video footage and compiling large matrix calculations per frame. Memory capacity may be on the order of 2 TB. The basic algorithm is Eq. 1, and color remastering by color target 4000 requires re-calculation of an IDT each time the illuminant changes or a new camera is added. With radioset 4015, several cameras can be multiplexed at any given time. The IDT in cache is applied frame by frame to generate a live preview or broadcast. The device includes a lightmeter or spectrophotometer 4005 that can provide information to compensate for smaller changes in illuminant and can notify the user if the IDT is deteriorating in its usefulness due to changes in scene lighting.

The device is battery operated and has internal power management circuitry 4007. The battery is rechargeable via USB port 4009. If the device relies on an external display, a battery life of several days is achieved; if the user interface (UI, 4010) includes a tablet-sized display, then daily re-charging may be necessary. Besides processing and optional display, the other current draw is the radio 4015. While in some use cases, a Bluetooth® radio suffices, in most instances this lacks sufficient bandwidth and speed. While more energy demanding, for a good UX, Wi-Fi DIRECT is a preferred radio format. HDMI and USB ports are provided in which the USB-C port is integrated into the power management module, but given the nature of how the product is used, radio is generally the preferred network link for privacy.

The electronics of a system for color profiling may be built around a Broadcom BCM2711B0 quad-core A72 (ARMv8-A) 64-bit @ 1.5 GHz GPU that serves as a graphics processing unit (GPU) and central processing unit (CPU) 4001 with flash memory 4003 and non-volatile memory for storing permanent program instructions 4002. The Broadcom SOC is programmable to do RAW conversion and rendering, for example in Python, starting with conversion to a DNG or a more capable format designed to handle absolute, relative and creative color profiles such as *.VSF containers or a RAW input file received from the digital camera via a wireless link. As practiced, a Wi-Fi connection is established between the camera and the color target device for processing images at 2.5 Gbps. For video, up to 10 Gbps is feasible and supports 4K. The rendered images with color correction may be returned to the camera for storage, may be forwarded to a smartphone for display and storage, or may be uplinking to cloud host if the user has an account. A Cloud Assistant may be provided on trial, or subscribed to for a fee. Post-processing of a RAW or color-corrected image file is also provided as a cloud service, using APIs that allow the user to apply graphics tools from partner software makers in the digital photography space. The user interface (UI, 4010) can include a tablet-sized display, or an external monitor may be used with keyboard and mouse.

Quantitatively, the light incident on the front of the subject (relative to the camera) is measured and may be compared to backlighting and modelling from lateral light sources before adjusting exposure and color. Each light source may be characterized by its SPD in advanced units. By using contoured targets, a 3D SPD contour is modelled.

Optionally the scanning spectrophotometer will detect incident light quality and display the SPD curve and a notification if the light is deficient in some parts of the visual spectrum. A built-in lightmeter is also useful in detecting changes in lighting condition to inform the user that they may want to re-calibrate a new relative camera color profile. U.S. Pat. No. 6,721,044 demonstrates that reflected and incident light can be separately monitored by a lightmeter, but fails to incorporate light components into color remastering devices. U.S. Pat. No. 5,565,990 describes how a lightmeter can be used to measure color temperature as part of exposure adjustment, but does not anticipate that the lightmeter may be integrated into a radio device for remastering color in photography and videography. The device is an advance in the art when combined with 3D contouring and AI training.

The user interface 4010 is designed to optimize the customer experience (UX). This generally turns on the availability of a touch-sensitive OLED screen and sufficient programming to provide sliders for a variety of basic exposure and adjustment settings and optionally an alpha setting for special effects such as AI. While not necessary for the minimal use case, an OLED screen at least 8×12 cm is what the customer is looking for, and that cannot be obtained with smartphone. The user interface may also manage emissive patches so that the device functions as a full reference color target.

In one interesting use case, the device also includes a speaker and microphone, thus becoming a unified blogging appliance with go anywhere capability. These features are considered as part of the UI 4010 but are highly significant in generating customer interest among photographers and cinematographers, particularly when using a pendant as a radio accessory 2500, 2900.

Instructions for operation of the processor(s) may be stored as flash or ROM, firmware, as flash memory 4002, or cache memory closely integrated with the processor(s), for example. Because Wi-Fi is built in, and a Cloud Assistant is accessible, an “over the air” (OTA) upgrade service poses no great burden on the system operator and adds to the customer's appraisal of value. Modern FOTA (firmware over the air) is also no problem.

FIG. 41 is another block diagram that shows a system 4100 with color target, a plurality of cameras, and a cloud host. Smart target device 4102 is described in functional blocks of an image transform workflow plus the hardware useful to receive raw data and output color remastered images. The device may include hardware for display and audio of still images and video. The system 4102 may be linked to multiple cameras 4123, 4124, 4125. The LAN radio interface 4120 handles high speed RAW image transfer from the cameras to the color remastering device circuitry 4102, which may be housed in a pocket sized or button-sized device 4101. The device is likely battery-powered (not shown), but may include power management circuitry and a port for USB active power or battery recharging, for example. The device may require a case so that the optic surfaces can be kept clean when not in use.

Images received by the device are stored or buffered in a flash memory 4122. The size of the flash memory determines the number of images that can be stored without transfer to the cloud and hence may be substantial: hundreds of GB or a few TB. Microprocessor 4121 may also have cache memory for executing instructions and for storing intermediate calculation results. An SoS may be used. All the circuits, including the radio units, are synchronized by a low jitter, high frequency clock with clock divider and pulse locked loop (PLL) capable of generating the GHz baseband for high speed radio.

In order to generate a camera profile based on a scene-referred radiometric color remastering, networking apparatus (e.g., 1601, 3200, 3300) is used. The color targets may be integral to the housing of the device (FIG. 18, 1601; FIG. 33A, 3305), which itself can be photographed by the camera, or may be a hardback color target 40 that can be referenced using a cloud database to decode reference values of the color patches, the geometry of the target card or device, and known color chromaticities and luminances under defined illumination. Patches may include both reflective and emissive patches, but also both flat matte and 3D contoured patches in a variety of interchangeable hues.

The component logic circuitry for generating a camera profile from an image of color target patches may be viewed as a series of subroutines 4125. An image of the color target patches is required, and as already described, is conveyed to the device 4102 from the camera and stored in memory 4122. The color target image is demosaiced in a first subroutine 4124 (although this demosaicing step is not necessary with Foveon or similar type sensors) so that the pixel bitstream is renderable with color and intensity adapted to a two-dimensional spatial frame. Within the frame, the position and orientation of the target device has an expected geometry and the color patches are mapped according to their expected positions. This subroutine 4126 may include steps for identifying fiducials, checking focus, cropping the image of the color target, and optionally sending a status report or an adjustment request to the camera. The adjustment request can include requests to adjust the exposure, or repeat the snapshot, for example. Much of this can be automated with modern cameras.

The layout of the color patches provides essential information. Each known reference color patch is read by the patch identifier and reference color comparator subroutine 4128 according to a guide to the layout that is obtained from the cloud or stored in a local database. The patches may be read much the same way as a QR code is read. Each patch is analyzed for its color and an observed “observed color notation” (for example in XYZ coordinates) is noted and recorded. The numerical format permits the observed color notations to be compared to known reference color and luminance notations for the color targets. All this occurs in subroutine 4128.

In a next subroutine 4130, these two sets of data, measured values versus reference values, are the used in the radiometric remastering of the color profile that is appended to any images captured once the camera is color calibrated. Image pixel color error subroutine 4132 generates a color remastering matrix transform function that, when applied to the image, results in a transformation of the colors of the image as received from the camera to an image with colors as would be displayed under standard daylight lighting conditions. This essentially is an exercise of Eq. 1 using the SPD as IR(λ) and the camera or LMS sensitivity as S(λ).

This relative color correction may be applied to the RAW image directly and “burned in”, or it may be appended to that image and subsequent images with instructions to display devices for rendering a color-corrected image or for doing post-editing 4134.

As shown here, the device 4102 may also include a display 4150 with display driver configured to display color profiled renderings, for example, so that the user can assess the quality and composition of the subsequent images captured by the camera. Color profiled images may also be returned to the camera, which may have its own display driver.

The display on the device, which may be an OLED screen, for example, is also useful in generating glyphoptic code renderings (or printed markings) that the camera can recognize. This optical signaling useful in setting up the LAN radio link and in communicating camera setup settings prior to the initials shoot. In some instances, the entire camera color profile generated by subroutine 4130 may be reduced to a glyphoptic code or codes and sent to the camera before any photograph or video “footage” is taken. A separate subroutine 4140 of the logic circuitry may be operated to generate the needed glyphoptic codes that are displayed on the local monitor or on a companion smartphone, for example.

Also optional is logic circuitry and ports for capturing audio 4142 from an external microphone and embedding those in time with video images captured according to a frame rate set by the camera. Synchronization is essential and is managed by a clock divider and pulse locked loop.

Gateway radio transmission and reception from and to a cloud host 1000 is managed by a WAN radio module 4110, that can be Wi-Fi or can be an LTE or other cellular radioset. This function is essential for accessing the Internet (world-wide web and a backbone of cloud host servers) to download camera profiles associated with a user profile, for downloading camera model characteristics as needed to communicate with and command a camera, and as needed for uploading images for remote storage, archiving, distributing and subsequent editing using APIs and other cloud computing resources. Once images are on the cloud, they are also readily distributed to other users.

In one embodiment, a Wi-Fi DIRECT link may be to a cloud portal. When linked by broadband over multiple channels to a VR/AV engine, simple messages can be superimposed on the images sent to a display, or more complex augmented and virtual reality may be displayed, including audio and a image touching feature, using buffer in the cloud host to synthesize a VR/AV image that is a combination of camera imagery plus computer generated annotations or enhancements, and that VR/AV image is what is returned to a local display via display driver 4150. The Wi-Fi antenna are set up for dual channel full duplex links, but a 4×4 or 4×5 link to the display and Wi-Fi tunnelling direct link setup at 5, 60 or 190 GHz may also be implemented. Wi-Fi 5, Wi-Fi 6 and Wi-Fi 7 operate at lower bands, from 2.4 to 6 GHZ, and these have the advantage that the short range of the signals at higher wavelengths minimizes risk to privacy. Wireless standards developed by the Digital Living Network Alliance (DLNA, Lake Oswego WA) may also be employed to transmit video streaming for color corrected editing by the networking device 4101 or by the cloud host 1000 in support of multiple local cameras and multiple local users in close radio proximity.

FIG. 42 is a first view of a wireless system for distributing image files through a network, the network having computing resources for performing radiographic remastering on image data received from one or more cameras. Device 4201 is termed a “networking accessory” device or apparatus and is both a hub and a color target or image management device. Related devices disclosed here are 1601, 3000, 3100, 3200, 3300, 3400, 3500, 4000, 4101 and 4201, for example.

FIG. 42 demonstrates that these networking devices can service multiple cameras 4221, 4222, 4223 over radio signals 20a. Networkable “cloud services” 1000 may include color remastering and corrections, storage of user profiles, administrative services, camera information, archiving, uplinking to the cloud, and downlinking of updated firmware or “apps” to cameras on demand, for example. Cloud services may also include links by which APIs can be accessed to perform more complex post-processing of images. In addition to archiving, images may be distributed to remote user devices and published for viewing by others. Servers responsible for cloud services may be referred to here as a “cloud host” in a collective sense.

By packaging the electronics for file and container communications functions and some color process functions in the networking accessory device, the device can serve multiple cameras, and can also participate in cloud-sourcing of image transform functions.

FIG. 43 is an alternate view of a wireless system 4300 in which a radio adaptor 4301 is included to enable cameras 4310 not equipped with radio transceivers to send and receive image-related data in conjunction with networking accessory 4301 Radio links 20a and 20b may be Wi-Fi or Bluetooth® links for example. The networking accessory 4301 is provided with both a LAN radio for exchanging data and commands with the cameras 4310, 4325, and a WAN radio for exchanging data and commands with the Internet, here represented as “cloud services” 1000.

While Bluetooth or a variety of radio types would be sufficient for wireless data exchange of still photographs with a network hub, a preferred embodiment is defined by Wi-Fi DIRECT links 20a, 20b. The concerns with radio data linkages are privacy, range and network latency. Wi-Fi DIRECT and its variants are well suited to this application because the higher carrier frequencies have limited range, the range needed between the accessory 4301 and the cameras is generally less than ten or twenty meters, and the network latency can be reduced by increasing the bandwidth or data transfer rate to >1 Gbps.

In a preferred embodiment, the Wi-Fi links 20a, 20b are modeled on LAN protocols of Wi-Fi DIRECT (IEEE 802.11ax, 802.11ac, 802.11n, or 802.11e), Miracast (1080P-compatible ITU-T H.264 Advanced Video Coding for HD and Ultra HD video), WiGig (IEEE 802.11ad or 802.11ay), UltraGig (IEEE 802.15), or future implementations using IEEE 802.11be, for example. Wi-Fi DIRECT has the advantage that no wireless access point or “hotspot” is needed. Wi-Fi Passpoint is based on IEEE 802.11u and is referred to as “Hotspot 2.0” for its mobility. Wi-Fi solutions also may be bootstrapped optically using QR codes (glyphoptic codes in general) for easy connectability and setup if automated radio discovery is not functional in the camera. Tunneling Direct Link Setup (TDLS, based on IEEE 802.11z, is a version of Wi-Fi that allows two devices to share data once a LAN pair link is established. Wireless standards developed by the Digital Living Network Alliance (DLNA, Lake Oswego WA) may also be employed to transmit video streaming for color corrected editing by the color target device or by the cloud host 1000.

The cameras and networking accessory 4301 are generally portable, battery operated devices, but may be mounted on support tripods if needed. In some instances the devices may be powered by cable from a remote power supply. While a cable link between the color target device and the camera is contemplated, it is not generally useful given the need for mobility of both the camera and the networking hub 4301, nor is it necessary given the high speed radio data link. Radio network latency is not generally an issue and the short range used for most work (typically less than 20 m) allows the use of higher frequency radio bands (2.5 to 10.5 GHz) that have limited range and hence are inherently private.

The preferred wireless connection 20a, 20b is a peer-to-peer, single-hop, direct Wi-Fi link between the camera and the networking hub 4301. For backwards compatibility to older cameras, an adaptor (FIG. 19A, 1900) may be supplied that plugs into the more common HDMI connection of the camera and functions as a relay that converts parallel data to serial data before conveying the data wirelessly to the target device, and also functions in reverse when conveying data from the target device to the camera. Adaptors for USB or ethernet links may also be supplied. However, the mobility and portability of a radio link is advantageous to photographers and videographers, and for use in color conversion at high fidelity, 8-bits per channel is not ideal. Bit depths of 10, 12, 14, 16, 30 or 36 bits are preferred. Oversampling ensures that colors and luminance captured in the RAW file output are fully editable with preservation of fine gradient modeling and dynamic range. The target device and adaptor may be engineered to include a fast, low jitter clock, and radio to support >1 Gbps bit rates, even up to 10 Gbps for example in support of 4K and 8K video at reasonable frame rates. The higher data transmission rates are useful particularly for videography and may include a sideband with audio channel from a microphone supplied with the adaptor, or in a separate package. For videography, transmission of frames at 30 fps, each frame having a size of 30 Mb or higher, plus appended metadata and audio, is realized.

Wi-Fi at 5 GHz Wi-Fi supports up to a 1.3 Gbps data rate with older standards. At 2.4 GHz in the more congested ISM band, Wi-Fi (IEEE 802.11ax) supports 1.2 Gbps, 2.4 Gbps, and even 4.8 Gbps using orthogonal frequency domain modulation (ODFM with FFT) with stable data transfer for LAN. The high end data rate may rely on multi-in/multi-out (MIMO) antenna technology, typically with dual antenna. Wi-Fi 6 stations (IEEE 802.11ax) routinely transfer 0.8 to 2.4 Gbps data using paired 2×2 160 MHz 2400 Mbps PHY stations, the lower rate corresponding to an outdoors location and the higher rate to an indoor setting because of the interference nature of MIMO. A summary of bit rates for various wireless networks is given at wikipedia.org/wiki/List_of_interface_bit_rates (accessed 28 Sep. 2022); so for example IEEE 802.11be (Wi-Fi 7), which is in the process of being deployed, is expected to be capable of 50 Gbps. This is of course not as fast as internal databuses of a PCB, but is sufficient for radio links between closely spaced cameras and a smart electronic color target device of the invention (1601, 3000, 3100, 3200, 3300, 3400, 3500, 4000, 4101 and 4201).

Similar considerations apply when adapting a Starlink ground station to share private content with recipients at remote IP Addresses. Starlink hardware is still bulky and requires stability to operate well, but can be used as an antenna in place of a smartphone to relay digital image content from a color target to a remote workstation, for example.

Multi-user, multi-antenna MU-MIMO is currently supported for 6 Gbps bidirectional radio, for example. Beamforming is another approach to increase data transfer rates. For videography at frame rates of 30 fps, a 1.2 Gbps connection is sufficient for upload, and a 2.4 Gbps connection provides full duplex data transfer. These higher bit rates are dependent on orthogonal frequency domain modulation.

To illustrate ODFM by way of example, for multi-channel radio on a 160 MHz baseband: the tones generated in a single signal are formed with a synchronized Fast Fourier Transform (FFT) pattern using radio waves having dual polarity, i.e., the signal waveforms are orthogonal, which increases the symbol rate in direct proportion to the constellation size of the resulting interference signal pattern. For example, the FFT size of an 802.11a signal is a 64 tone synchronized overlay, consisting of 52 active tones with 4 pilot tones, or a total of 48 data tones. Alternatively a 26 tone overlay, with 2 tones for pilot yields 29.4 Mbps with two spatial stream, and with ODFMA, multiple signals may be sent simultaneously, increasing the data rate to up to 1.2 Gbps at 80 MHz even at a relatively low power of +20 dB transmit, as needed for battery powered devices. Using IEEE 802.11ax, at 160 MHz with an FFT of 2048 tone pattern, the transmit data rate can be increased to 2.4 Gbps, and can be increased to 4.8 Gbps with media bridge adapters (not shown).

The use of a media bridge adaptor is merited for videography, where an external power supply is often available to support the two or three antennae that make up the MU-MIMO transceivers. For still photography, it is unlikely that extremely fast continuous radio transmission is needed and that even for bursts of images, buffering can be sufficient to minimize perceptible latency.

The higher data rates is also useful when the networking device 4301 functions as a WAN internet portal or hotspot and encodes the data stream 1c for transmission via an IP packet environment to the cloud host 1000. The data from the camera is buffered in device 4301 and is retransmitted as an IP packet data transmission. This WAN connection is typically bidirectional, and is clocked to minimize network latency. Backhaul can include finished color remastered images. The WAN network may be wired for serial data transmission, or routed on optical fiber, but more commonly is coupled via a network hotspot or direct gateway that is either built into the hub device 4301 or is routed through a smartphone for forwarding via an LTE cellular connection, for example. Local routers and modems may of course also be used to operate a hotspot as a gateway or “access point” to the Internet, and these typically are supplied with AC power.

Digital transfer is typically bidirectional because processed images are returned to the camera for local display and storage on SD cards, and because in some instances commands are transferred from a cloud host or color target device to the camera. By using a higher data rate even for still photography, calculations and color corrections may be returned to the camera for display with no perceptible latency, even when burst still exposures are made.

The cloud host 1000 may be enabled to do extensive image processing, and may provide a platform by which APIs can be accessed by users for image post-processing. The cloud host may also keep a database of user profiles, camera data, smart target device data, and imaging data archives, and may be capable of generating commands to the target smart device and camera. In most instances, any IDT data calculated by the cloud host will be transmitted back to the camera and/or network hub 4301 for use in capturing and processing subsequent images. In some instances, the camera may receive updates to its internal firmware (FOTA) via the LAN or WAN radio of the system 1601, 1700, 2200, 4100, 4200, 4300 for example. Updates to the color profile may be pushed to the camera by the system using FOTA technology to overwrite the firmware of the camera.

However, given the many sources of network latency, a “smart” networking device 4301 may be engineered to complete much of the needed computational load within the local area network (LAN) or on an SoC (2520, 3531, 4000) by performing what is termed “edge computing”. The networking device may include a power supply to operate for at least several hours on battery. These smart color remastering devices 4301 include extra flash memory for buffering an image stream and sufficient processing power to calculate error minimization matrices (IDT, IDT), EOTF, OETF (electro-optic transform functions and opto-electronic transform functions), and so forth, with an on-board multi-threaded processor. A graphics processing unit (GPU or VPU) is superior for this process. In some instances, the networking hub 4301 may also include a display so that the user may check the image composition and exposure, or alternatively the returned image may be displayed on the camera or on a companion smartphone after rendering.

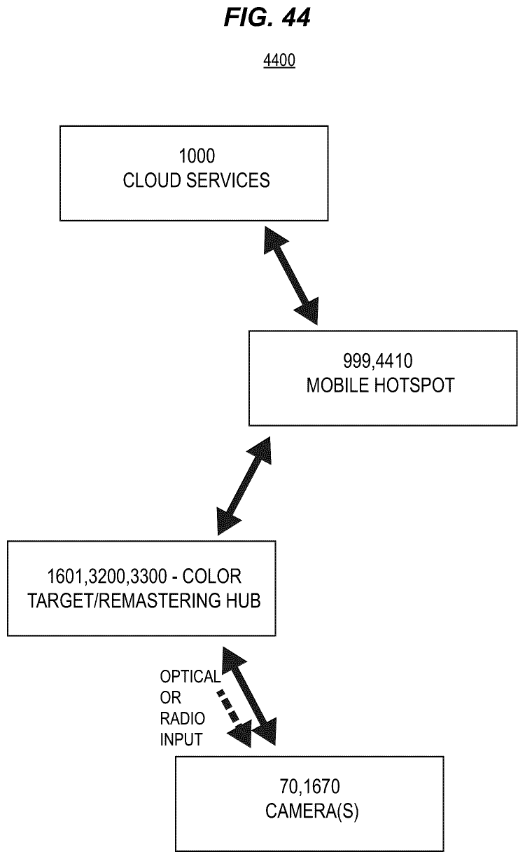

FIG. 44 illustrates that a color target hub (e.g., 1601, 3200, 3300) may operate cooperatively with a mobile hotspot such as a smartphone 999, 4410 in delivering images to the cloud 1000 and receiving back matrix expressions, commands, and color profiled images under control of the cloud host. In this system 4400 the networking device is provided with color patches that may be read by the camera (OPTICAL INPUT) and processed by the system to generate a color profile for that camera 70, 1670.

Alternatively, the networking device may not require an intermediary or relay as a hotspot, as was illustrated in FIG. 17 (1601) in which wireless broadband links are established directly between the networking device 1601 and the cloud host 1000.

The features of the preceding descriptions of FIGS. 3 to 44 may be combined with the descriptions of combinations of figures in ways to create improved embodiments. The features of one figure, or any of the preceding figures, may be combined with any other features indicated in the drawings and written description to create improved embodiments. Text on the drawings is also of value in generating improved embodiments.

### Example I: Plug-In into Photo Editing Software Suite

In a first demonstration, a digital image file was loaded into DaVinci Resolve, a commonly used image editing software. On command, the software routed the image to a plug-in set up to receive images and remaster the image color. The image as received in the plug-in was transformed into floating point notation, preserving color and luminosity. In testing, this image was remastered using reference information measured from patches scanned while exposed to a standardized lighting condition. The equation

$$= {\int }_{λ} R ( λ ) I ( λ ) S ( λ ) d λ = {\int }_{λ} L ( λ ) S ( λ ) d λ \qquad ( Eq . 1 a )$$

was solved for the illuminant and the camera sensitivity (the “observer”) and then, using the software, an illuminant and a new observer can be substituted to “relight” the image for creative intent or to match related images taken with different cameras or under different lighting conditions. The remastered image is exportable from the plug-in and is editable in DaVinci Resolve using the tools available with the program. A user interface is available to adjust the “look” of the image via the plug-in of the relighting plug-in and also using the grading tools available in the Resolve program. The viewer can see the image while the editing is performed.

The software is used with digital images that include a picture of a color target, the color target comprising a device having a housing, the housing with a color target surface disposed on an exposable face thereof, the color target surface comprising an arrangement of a plurality of emissive and reflective patches in which the patches are selected to support chromaticity calibration and tone curve calibration of associable digital image capture devices and digital image display devices in a spectral range of at least 400 to 700 nm and in a tonal range of light intensities of 0.0002 to 2000 nits. In combination, the digital image plus software accessible to a photoediting program allows the remastering process to begin with a solution to Eq. 1a: \grave{c}ᵢ=ƒ_{λ}R(λ)I(λ) S(λ)dλ, starting with a solution for the illuminant I(λ), where \grave{c}ᵢ is non-zero and the equation is solved binwise per channel using at least in part matrix algebra.

### Example II: Mathematical Description of IPT Pipeline for Re-Lighting

In physics, a spectral power distribution (SPD) describes the power (watts) per unit area per unit wavelength of an illumination. We will use the term illuminant and the variable I: [symbol] → [symbol] to refer to the SPD of a light source. The calculations map each wavelength to the corresponding power. We will distinguish I^{cur}, the current illuminant under which the image was taken, and I^{aim}, the aim illuminant that we want to achieve. The spectral reflectance R: [symbol] → [symbol] is the ratio of energy reflected by a surface to the energy incident on the surface as a function of wavelength. The final SPD S: [symbol] → [symbol] , which enters the camera lens aperture, is the product of the illuminant and the physical surface reflectance S=RI, where we refer to the current curves that the target patches produce under the current illuminant as S^{curr}.

We refer to an Observer as O: ( [symbol] → [symbol] )→ [symbol] ^{m} that maps a physical spectrum to an m-dimensional color C∈ [symbol] ^{m}. Examples of known observers are the CIE ‘Standard Observer’ or the channel sensitivities of a camera sensor. The color channel dimension can be m=3 for human color vision, but other values are possible, e.g., for future displays or machine vision.

The color C measured by the observer of an object with spectral reflectance R under illuminant I is then given by

$$C = {\int }_{λ} S ( λ ) O ( λ ) d λ = {\int }_{λ} R ( λ ) I ( λ ) O ( λ ) d λ \qquad ( Eq . 5 )$$

For emissive sources with spectral emission E: [symbol] → [symbol] , the illuminant plays no role and the final color is solely determined by the observer

$$C = {\int }_{λ} S ( λ ) O ( λ ) d λ = {\int }_{λ} E ( λ ) O ( λ ) d λ \qquad ( Eq . 6 )$$

We assume that our color target includes both reflective and emissive patches, each with known spectral reflectances and emissions. Additionally, we know the colors they produce under the current illuminant and observer, which corresponds to the camera's sensor response. Our goal is to determine the spectral reflectances of all objects in the scene. This information allows us to compute their responses under any desired illuminant I^{aim} and observer O^{aim}.

We will now describe an algorithm to derive them using a discretized version of the SPDs via binning. This transforms the integral equations above into sums and finally into matrix multiplications C=SO=EO for emissive and C=SO=RIO for reflective patches respectively.

The algorithm, for example, may be written as follows:
1. For each color channel, estimate the current camera observer O^{cur} from the SPDs E and measured colors C of the emissive patches and linear least squares on the discretized matrix relation C^{cur}-EO^{cu};
2. Estimate the illuminant I^{cur} from that together with the SPDs R of the reflective patches and their corresponding measured colors C using linear least squares on the vectorization of the matrix relation C^{cur}=RI^{cur} O^{cur},
3. Estimate the smooth spectral curves S^{smo} for a discrete set of colors C covering the gamut of all colors from the images in question or a suitable color space using linear least squares on the vectorization of the matrix relation C=S^{smo} O^{cur},
4. Compute the reflectances R^{smo} from the smooth S^{smo} and the illuminant I^{cur} from S^{smo}=R^{smo} I^{cur} using straight component-wise multiplication for each wavelength bin;
   then as desired (for example (a) a user interface may be operated to select a preferred illuminant I^{aim}, or (b) a system routine may generate the illuminant estimate based on an iterative process),
5. Compute their color responses C^{aim} under the desired illuminant I^{aim} and observer O^{aim} using C^{aim}=R^{smo} I^{aim} O^{aim} using straight component-wise multiplication for each wavelength bin;
6. Compute the re-lighted color responses of all colors C^{aim} from the image under the desired illuminant through interpolation between these finite responses, e.g. using piecewise linear or spline interpolation;
7. Output the result in a system-designated file format or as selected by a user.

### Example III: Mathematical Description of IPT Pipeline using Machine Learning

If we have only few color channels (e.g. three) and a trained neural net to estimate the spectral reflectance from the color image, then we will skip step 3 of EXAMPLE II, but instead follow a process written with an exception. By a processor having processor-executable instructions that when executed by the processor, cause a machine to remaster the color of a digital image or video clip as follows:
1. For each color channel, estimate the current camera observer O^{cur} from the SPDs E and measured colors C of the emissive patches and linear least squares on the discretized matrix relation C^{cur}=EO^{cur};
2. Estimate the illuminant I^{cur} from that together with the SPDs R of the reflective patches and their corresponding measured colors C using linear least squares on the vectorization of the matrix relation C^{cur}=R^{cur}O^{cur}.
3. Estimate the spectral radiances Sⁿⁿ for every pixel using the trained neural net;
4. Compute the reflectances R^{smo} from the smooth S^{smo} and the illuminant I_{cur} from S^{smo}=R^{smo} I^{cur} using straight component-wise multiplication for each wavelength bin;
5. Compute their color responses C^{aim} under the desired illuminant I^{aim} and observer O^{aim} using C^{aim}=R^{smo} I^{aim} (aim using straight component-wise multiplication for each wavelength bin;
6. Output the result in a system-designated file format or as selected by a user.

### Example IV: Spectrophotometric Adjustments to IDT

The IDT (“color profile”), as explained, is most valid when the illuminant and camera color and tone sensitivities are equivalent to the conditions when the calibration was performed. A change from sun to clouds, or the onset of the “golden hour” will tend to invalidate the IDT remastering. But by using a spectrophotometer in the scene, as suggested in FIG. 27 or 29, the spectrometry may be measured as a function of time and an adjustment \grave{c}/c (Eq. 1) is made by decimal fraction multiplication per pixel using a binwise recalculation. Scanning spectrophotometers provide the illuminant SPD and can be stored in memory so that changes in the illuminant are detected. As the changes in illumination increase, the system may deliver a notification to the user that the IDT is no longer valid, offering the user a chance to take a shot with a color target back in the scene so as to refresh the IDT.

Also, Δ\grave{c}/c and ∇\grave{c}/c provide a number of logical flags for other system operations.

### Example V: Disinformation Watermarking

Digital image authentication is improved using digital watermarking. In one embodiment, the reference target is integrated within the field of image capture and is designed to cryptographically sign images in real-time during capture. The presence of this target within the captured image serves as a verifiable marker with a traceable ID, ensuring the authenticity and integrity of the image for legal and forensic applications. In one instance, the round code can be generated by an LED or LCD on the reference target, and a variety of information such as timestamp and location can be encoded, much like a clapboard.

In other instances, the reference target may be a virtual reference target visible only in the subpixels by a machine programmed to detect watermarking in an embedded layer according to a defined coding. The watermark may be invisible to the human eye; for example a metameric combination of emitted light will have two versions, one the color generated by the camera, but another the metamer generated by the system. In analyzing an image using machine vision, both versions are visible. Lack of a watermark flags an image. When the system associates the image with disinformation because the watermark is missing or is not credible, the system may share this information with the cloud, or display a notification to the viewer.

### Incorporation by Reference

All of the U.S. patents, U.S. Patent application publications, U.S. patent applications, foreign patents, foreign patent applications and non-patent publications referred to in this specification and related filings are incorporated herein by reference in their entirety for all purposes.

### SCOPE OF THE CLAIMS

The disclosure set forth herein of certain exemplary embodiments, including all text, drawings, annotations, and graphs, is sufficient to enable one of ordinary skill in the art to practice the invention. Various alternatives, modifications and equivalents are possible, as will readily occur to those skilled in the art in practice of the invention. The inventions, examples, and embodiments described herein are not limited to particularly exemplified materials, methods, and/or structures and various changes may be made in the size, shape, type, number and arrangement of parts described herein. All embodiments, alternatives, modifications and equivalents may be combined to provide further embodiments of the present invention without departing from the true spirit and scope of the invention.

In general, in the following claims, the terms used in the written description should not be construed to limit the claims to specific embodiments described herein for illustration, but should be construed to include all possible embodiments, both specific and generic, along with the full scope of equivalents to which such claims are entitled. Accordingly, the claims are not limited in haec verba by the disclosure.

1. (canceled)

2. An apparatus for automatically remastering a digital image in a moving or non-static field of ambient light, which comprises
(a) a video camera with associated spectrophotometer;
(b) a circuit having a processor and processor-executable instructions, memory and logic circuitry that receives a digital image as input from the camera, an input from the spectrophotometer, and is configured to render a dual output;
(c) the dual output having a switchable overlay of the digital image as seeable as if by a human standard observer and the digital image as seeable as if by machine vision having a non-standard observer selectable by logical rules that are assigned a truth value by the input from the spectrophotometer.

3. The apparatus of claim 2, which comprises a supplemental logic layer for generating notifications according to logical rules that are assigned a truth value according to a difference or differences between the digital image as seeable by a standard human observer and the digital image as seeable by machine vision having a non-standard observer selectable by logical rules that are assigned a truth value by the input from the spectrophotometer.

4. The apparatus of claim 2, which comprises a supplemental logic layer for executing commands to a machine according to logical rules that are assigned a truth value according to a difference or differences between the digital image as seeable by a standard human observer and the digital image as seeable by machine vision having a non-standard observer selectable by logical rules that are assigned a truth value by the input from the spectrophotometer.

5. The apparatus of claim 2, wherein the non-standard observer is selected to analyze the digital image for material properties associated with identifiable objects or surfaces.

6. The apparatus of claim 2, wherein the digital image is received from a camera mounted on a vehicle, and the switchable overlay is operated as a component of a self-driving vehicle controller.

7. The apparatus of claim 2, wherein the camera is a hyperspectral camera having an optical scanning range selected for differentiating dry road conditions from wet or icy road conditions.

8. The apparatus of claim 2, wherein the switchable overlay is an augmented reality overlay configured to draw attention by color or by tone value to a particular feature or features within the digital image, and wherein the machine vision having a non-standard observer is configured such that the non-standard observer is selected by a predictive model based on machine learning.

9. The apparatus of claim 8, wherein the switchable overlay is configured to be projected as a visible image onto a front windshield.

10. The apparatus of claim 8, wherein the dual output is configured to be integrated as a dual input into a machine controller.

11. An apparatus for automatically remastering a digital image in a moving or non-static field of ambient light, which comprises
(a) a camera with associated spectrophotometer;
(b) a circuit having a processor and processor-executable instructions,
memory and logic circuitry that receives a digital image as input from the camera, an input from the spectrophotometer, and is configured to render a dual output;
(c) the dual output having an overlay of the digital image as seeable by a standard human observer switchably displayable with one or more outputs of the digital image as seeable by machine vision having one or more non-standard observers selectable by an operator of the apparatus.

12. The apparatus of claim 11, further comprising a user interface operatively connected to the circuit, the user interface having a control surface for selecting the non-standard observer.

13. The apparatus of claim 11, further comprising a display operatively connected to the circuit, wherein the display is operatively connected to the user interface for switchingly rendering the digital image according to the one or more non-standard observer selected.

14. The apparatus of claim 11, wherein the one or more non-standard observers are selected for creative rendering of the digital image.

15. The apparatus of claim 11, wherein the one or more non-standard observers are selected to analyze the digital image for material properties associated with identifiable objects or surfaces.

16. The apparatus of claim 11, wherein the one or more non-standard observers are selected to analyze the digital image for color surfaces that match a reference color or colors.

17. The apparatus of claim 11, wherein the one or more non-standard observers are selected to analyze the digital image for metamerism of color surfaces.

18. The apparatus of claim 17, wherein the digital image is configured to coordinate design of painted surfaces under one or more illumination conditions by integration with an architectural design suite of software.

19. The apparatus of claim 17, wherein the dual output is configured to be projected onto an associated display screen or projector using EITHER/OR and AND selections on the user interface.

20-45. (canceled)

46. An apparatus for remastering a digital image, comprising a device having a housing, the housing with a color target surface disposed on an exposable face thereof, the color target surface comprising an arrangement of a plurality of emissive and reflective patches in which the patches are selected to support chromaticity calibration and tone curve calibration of associable digital image capture devices and digital image display devices in a spectral range of at least 400 to 700 nm and in a tonal range of light intensities of 0.0002 to 2000 nits; and further wherein the reflective patches are contoured in a geometrically regular way such that each reflective patch on the surface displays a highlighted surface and a shadowed surface when directionally lit by an illuminant.

47. The apparatus of claim 46, wherein the reflective patches are contoured as truncated spheres, flattened at a point of attachment to the housing, each truncated sphere is uniformly colored at manufacture, and each reflective patch is scanned for its reflected spectrum under a standard illuminant, and for a gradient of color and tonal spectra as the standard illuminant is positioned at a defined angle relative to the truncated sphere.

48. (canceled)

49. The apparatus of claim 46, further comprising a mirrored truncated sphere.

50. The apparatus of claim 46, further comprising one metrological component selected from a scanning spectrophotometer, a multichannel spectroradiometer able to measure light at any instant by wavelength and intensity per wavelength passband, or a colorimeter, wherein the metrological component is configured to detect a change in ambient illumination around the device.

51-102. (canceled)

103. The apparatus of claim 2, wherein the non-standard observer is used for underwater imaging, enhancing the visibility and detail of marine life and underwater structures by processing images with spectral data beyond the human visible range.

104-105. (canceled)

106. The apparatus of claim 2, adapted for use in the cosmetic industry for skin analysis, wherein the machine vision system uses spectral imaging to assess skin conditions, matching skin tones for cosmetics, or evaluating the effectiveness of skincare products.

107-125. (canceled)
